(19) United States
(12) Patent Application Publication
(10) Pub. No.: US 2026/0267120 A1
(43) Pub. Date: Sep. 10, 2026

(54) OPTICAL SYSTEM AND CAMERA MODULE

(71) Applicant: LG INNOTEK CO., LTD., Seoul (KR)

(72) Inventors: Duk Keun KWON, Seoul (KR); Doo Shik SIN, Seoul (KR)

(21) Appl. No.: 19/478,963

(22) PCT Filed: Apr. 25, 2024
(86) PCT No.: PCT/KR2024/005618

§ 371 Date: Oct. 27, 2025

(30) Foreign Application Priority Data
Apr. 25, 2023 (KR) 10-2023-0054367

(51) Int. Cl. G02B 13/00; G02B 7/02; G02B 15/14; H04N 23/55

(52) U.S. Cl. CPC G02B 13/009; G02B 7/028; G02B 13/0045; G02B 15/143503; H04N 23/55

(57) ABSTRACT

An optical system according to an embodiment of the present invention includes first to third lens groups arranged along the optical axis, wherein the first lens group has negative (−) refractive power, the second lens group has positive (+) refractive power, the third lens group has negative (−) refractive power, an aperture is arranged between the first lens group and the second lens group, and at least one of the two lenses positioned closest to the aperture is made of glass.

### TECHNICAL FIELD

The present invention relates to an optical system for enhanced optical performance and a camera module including the same.

### BACKGROUND ART

The camera module performs the function of photographing an object and storing it as an image or video and is installed in various applications. In particular, the camera module is manufactured to be ultra-small and is applied to portable devices such as smartphones, tablet PCs, and laptops as well as drones and vehicles to provide various functions.

For example, the optical system of a camera module may include an imaging lens that forms an image, and an image sensor that converts the formed image into an electrical signal. At this time, the camera module may perform an autofocus (AF) function that automatically adjusts the distance between the image sensor and the imaging lens to align the focal length of the lens, and may perform a zooming function of zooming up or zooming out to increase or decrease the magnification of a distant object to take a picture through a zoom lens. In addition, the camera module adopts an image stabilization (IS) technology to correct or prevent shaking of the image caused by movement of the camera due to an unstable fixing device or movement of the user.

The most crucial element for these camera modules to photograph images is the imaging lens that forms the image. Recently, interest in high-performance features, such as high definition and resolution, has been increasing, and research is underway on optical systems that incorporate multiple lenses to implement these goals.

For example, research is underway to implement high-performance optical systems using multiple imaging lenses with positive (+) or negative (−) refractive power. However, the inclusion of multiple lenses can increase the overall optical system size, making it difficult to derive superior optical and aberration characteristics.

In addition, an optical system comprising multiple lenses can be relatively tall. For example, as the number of lenses increases, the distance between the image sensor and the object plane of the adjacent lens may increase. Consequently, the overall thickness and length of a device, such as a smartphone, in which the optical system is disposed may increase, making miniaturization difficult.

In addition, there is a problem that it is difficult to enhance optical performance through lenses.

### DETAILED DESCRIPTION OF THE INVENTION

### Technical Subject

The embodiment is intended to provide a zoom optical system and camera module with enhanced optical characteristics.

The embodiment is intended to provide an optical system and camera module having excellent optical performance in low-temperature to high-temperature environments.

The embodiment is intended to provide an optical system and camera module capable of preventing or minimizing changes in optical characteristics over a wide temperature range.

### Technical Solution

In order to solve the above technical problem, an optical system according to an embodiment of the present invention comprises: first to third lens groups being disposed along an optical axis, wherein the first lens group has negative (−) refractive power, the second lens group has positive (+) refractive power, and the third lens group has negative (−) refractive power, an aperture is disposed between the first lens group and the second lens group, and at least one of the two lenses being disposed closest to the aperture is made of glass.

One of the two lenses being disposed closest to the aperture may have the largest Abbe number.

The signs of the refractive powers of the two lenses being disposed closest to the aperture may be different.

The absolute value of the difference in Abbe numbers of the two lenses being disposed closest to the aperture may be 25 or more and 35 or less.

The first lens group may include first to third lenses, the second lens group includes a fourth lens having positive (+) refractive power and a fifth lens having negative (−) refractive power, and the third lens group may include a sixth lens having positive (+) refractive power and a seventh lens having negative (−) refractive power.

The first lens group may be a fixed group, and the second lens group and the third lens group may be moving groups.

The following Conditional expression can be satisfied. <Conditional expression>15<TTL<20 (In the above Conditional expression, TTL is the optical axis distance from the vertex of the object-side surface of the lens being disposed closest to the object side to the upper surface of the image sensor.)

The following Conditional expression can be satisfied. <Conditional expression>0.5<f_tele/f_wide<1 (In the above Conditional expression, the f_tele is the total focal length of the optical system at the end of telephoto, and the f_wide is the total focal length of the optical system at the end of wide-angle.)

The following Conditional expression can be satisfied. <Conditional expression>1<BFL_wide<3 (In the above Conditional expression, BFL_wide is the distance along the optical axis from the end of a light source to the center of the sensor side surface of the last lens at the image sensor.)

The following Conditional expression can be satisfied. <Conditional expression>3<TTL/ImgH<5 (In the above Conditional expression, TTL is the optical axis distance from the vertex of the object-side surface of the lens being disposed closest to the object side to the upper surface of the image sensor, and ImgH is the maximum diagonal length of the image sensor.)

In order to solve the above technical problem, an optical system according to the present embodiment comprises first to seventh lenses being disposed along an optical axis, wherein the second lens has positive (+) refractive power, the third lens has negative (−) refractive power, the fourth lens has positive (+) refractive power, the fifth lens has negative (−) refractive power, the sixth lens has positive (+) refractive power, and the seventh lens has negative (−) refractive power, wherein the first to third lenses are a first lens group having negative (−) refractive power, wherein the fourth and fifth lenses are a second lens group having positive (+) refractive power, wherein the sixth and seventh lenses are a third lens group having negative (−) refractive power, wherein an aperture is disposed between the first lens group and the second lens group, and wherein at least one of the two lenses being disposed closest to the aperture may be made of glass.

The first lens group is a fixed group, and the second lens group and the third lens group may be moving groups.

One of the two lenses being disposed closest to the aperture may have the largest Abbe number.

The signs of the refractive powers of the two lenses being disposed closest to the aperture above may be different.

The following Conditional expression can be satisfied. <Conditional expression>3<TTL/ImgH<5 (In the above Conditional expression, TTL is the optical axis distance from the vertex of the object-side surface of the lens being disposed closest to the object side to the upper surface of the image sensor, and ImgH is the maximum diagonal length of the image sensor.)

In order to solve the above technical problem, an optical system according to an embodiment of the present invention includes first to third lens groups being disposed along an optical axis, wherein the first lens group has negative (−) refractive power, the second lens group has positive (+) refractive power, wherein the third lens group has negative (−) refractive power, wherein in the first lens group, the lens being disposed closest to the sensor side may have a concave shape on both sides, and wherein in the second lens group, the lens being disposed closest to the object side may have a convex shape on both sides.

The first lens group is a fixed group, and the second lens group and the third lens group may be moving groups.

When zooming from the wide-angle end to the telephoto end, the distance between the first lens group and the second lens group on the optical axis decreases, and the distance between the second lens group and the third lens group on the optical axis may decrease.

At the wide-angle end, the distance between the first lens group and the second lens group on the optical axis may be greater than the distance between the second lens group and the third lens group, and at the telephoto end, the distance between the first lens group and the second lens group on the optical axis may be smaller than the distance between the second lens group and the third lens group.

The first lens group includes a first lens having positive (+) refractive power and a second lens having negative (−) refractive power, wherein the second lens group includes a third lens having positive (+) refractive power and a fourth lens having negative (−) refractive power, and wherein the third lens group may include a sixth lens having negative (−) refractive power and a second lens having negative (−) refractive power.

Among the distances between adjacent lenses of the first to sixth lenses on the optical axis, the distance between the first lens and the second lens may be the largest. A first optical member may be disposed in an ineffective area of the sensor side surface of the first lens and the object side surface of the second lens.

A second optical member may be disposed to connect the first lens and the second lens and have a pattern being formed on one surface facing the optical axis.

The following Conditional expression can be satisfied. <Conditional expression>1.5<f_tele/f_wide<2 (In the above Conditional expression, f_tele is the total focal length of the optical system at the telephoto end, and f_wide is the total focal length of the optical system at the wide-angle end.)

The following Conditional expression can be satisfied. <Conditional expression>0.1<ΣCT/TTL<1 (In the above Conditional expression, ΣCT is the sum of the center thicknesses of the lenses, and the TTL is the distance along the optical axis from the vertex of the object-side surface of the lens being disposed closest to the object side, to an upper surface of an image sensor.)

In order to solve the above technical problem, an optical system according to an embodiment of the present invention includes first to sixth lenses being disposed along an optical axis, wherein the first lens has positive (+) refractive power, the second lens has negative (−) refractive power, the third lens has positive (+) refractive power, the fourth lens has negative (−) refractive power, the fifth lens has negative (−) or positive (+) refractive power, and the sixth lens has negative (−) refractive power, wherein the first and second lenses are a first lens group having negative (−) refractive power, the third and fourth lenses are a second lens group having positive (+) refractive power, and the fifth and sixth lenses are a third lens group having negative (−) refractive power, wherein among the gaps between adjacent lenses of the first to sixth lenses on the optical axis, the gap between the first lens and the second lens is the largest, and wherein an optical member may be disposed on at least one of a sensor side surface of the first lens and an object side surface of the second lens.

The first lens group is a fixed group, and the second lens group and the third lens group may be moving groups.

At the wide-angle end, the distance between the first lens group and the second lens group on the optical axis is greater than the distance between the second lens group and the third lens group, and at the telephoto end, the distance between the first lens group and the second lens group on the optical axis may be smaller than the distance between the second lens group and the third lens group.

Among the first to sixth lenses, the effective diameter of the first lens is the largest, and among the first to sixth lenses, the effective diameter of the second lens may be the smallest.

The following Conditional expression can be satisfied. <Conditional expression>3<TTL/ImgH<5 (In the above Conditional expression, TTL is the optical axis distance from the vertex of the object side surface of the first lens to the upper surface of the image sensor, and ImgH is the maximum diagonal length of the image sensor.)

### Advantageous Effects

The optical system and camera module according to an embodiment have various magnifications and can exhibit excellent optical characteristics when providing various magnifications. Specifically, the embodiment can control a lens group having a set number of lenses, a set refractive power, a plurality of lenses having a set shape and focal length, and the like, a moving distance of a moving lens group, and the like to have various magnifications and can provide an autofocus (AF) function for the subject.

In addition, in an optical system and a camera module according to an embodiment, each of multiple lens groups compensate for aberration characteristics or may mutually compensate for aberration characteristics being changed due to movement. Accordingly, the optical system according to an embodiment can minimize or prevent changes in chromatic aberration and aberration characteristics being occurred when magnification changes.

In addition, an optical system and a camera module according to an embodiment can control the effective focal length (EFL) by moving only some of the plurality of lens groups, thereby minimizing the moving distance of the lens groups being moved. Accordingly, the embodiment can significantly reduce the moving distance of the lens groups when the magnification changes, and can minimize the power consumption required when moving the lens groups.

In addition, an optical system and a camera module according to the embodiment can adjust the magnification by moving a lens group other than the first lens group adjacent to the subject among the plurality of lens groups. Accordingly, the optical system can maintain a constant TTL value even when the lens group moves according to the change in magnification. Accordingly, the optical system and the camera module including the same can be provided with a slimmer structure.

### BRIEF DESCRIPTION OF DRAWINGS

FIG. 1 is a schematic diagram of an optical system according to a first embodiment operating in a first mode.

FIG. 2 is a schematic diagram of an optical system according to a first embodiment operating in a second mode.

FIG. 3 is a table showing aspherical coefficients of lenses in an optical system according to a first embodiment.

FIG. 4 is a graph showing data on the diffraction MTF (Modulation Transfer Function) at room temperature of an optical system according to a first embodiment operating in a first mode.

FIG. 5 is a graph showing data on the aberration characteristics of an optical system according to a first embodiment operating in a first mode.

FIG. 6 is a graph showing data on the diffraction MTF (Modulation Transfer Function) at room temperature of an optical system according to a first embodiment operating in a second mode.

FIG. 7 is a graph showing data on the aberration characteristics of an optical system according to a first embodiment operating in a second mode.

FIG. 8 is a schematic diagram of an optical system according to a second embodiment operating in a first mode.

FIG. 9 is a schematic diagram of an optical system according to a second embodiment operating in the second mode.

FIG. 10 is a table showing the aspherical coefficients of lenses in an optical system according to the second embodiment.

FIG. 11 is a graph showing data on the diffraction MTF (Modulation Transfer Function) at room temperature of an optical system operating in a first mode according to a second embodiment.

FIG. 12 is a graph showing data on the aberration characteristics of an optical system operating in a first mode according to a second embodiment.

FIG. 13 is a graph showing data on a diffraction MTF (Modulation Transfer Function) at room temperature of an optical system operating in a second mode according to a second embodiment.

FIG. 14 is a graph showing data on aberration characteristics of an optical system operating in a second mode according to a second embodiment.

FIG. 15 is a diagram showing a configuration of an optical system operating in a first mode according to a third embodiment.

FIG. 16 is a diagram showing the configuration of an optical system operating in a second mode according to a third embodiment.

FIG. 17 is a table showing aspherical coefficients of lenses in an optical system operating in a third embodiment.

FIG. 18 is a graph showing data on the diffraction MTF (Modulation Transfer Function) at room temperature of an optical system according to a third embodiment operating in a first mode.

FIG. 19 is a graph showing data on aberration characteristics of an optical system according to a third embodiment operating in a first mode.

FIG. 20 is a graph showing data on diffraction MTF (Modulation Transfer Function) at room temperature of an optical system according to a third embodiment operating in a second mode.

FIG. 21 is a graph showing data on aberration characteristics of an optical system according to a third embodiment operating in a second mode.

FIG. 22 is a diagram showing a configuration of an optical system according to a fourth embodiment operating in a first mode.

FIG. 23 is a diagram showing a configuration of an optical system according to a fourth embodiment operating in a second mode.

FIG. 24 is a diagram showing a configuration of an optical system according to a fourth embodiment operating in a third mode.

FIG. 25 is a table showing aspherical coefficients of lenses in an optical system according to a fourth embodiment.

FIG. 26 is a graph showing data on diffraction MTF (Modulation Transfer Function) at room temperature of an optical system according to a fourth embodiment operating in a first mode.

FIG. 27 is a graph showing data on aberration characteristics of an optical system according to a fourth embodiment operating in a first mode.

FIG. 28 is a graph showing data on diffraction MTF (Modulation Transfer Function) at room temperature of an optical system according to a fourth embodiment operating in a second mode.

FIG. 29 is a graph showing data on aberration characteristics of an optical system according to a fourth embodiment operating in a second mode.

FIG. 30 is a graph showing data on diffraction MTF (Modulation Transfer Function) at room temperature of an optical system according to a fourth embodiment operating in a third mode.

FIG. 31 is a graph showing data on aberration characteristics of an optical system according to a fourth embodiment operating in a third mode.

FIG. 32 is a graph showing data on relative illumination versus relative field of an optical system according to a fourth embodiment.

FIG. 33 is a diagram showing a configuration of an optical system according to a fifth embodiment operating in a first mode.

FIG. 34 is a diagram showing a configuration of an optical system according to a fifth embodiment operating in a second mode.

FIG. 35 is a diagram showing a configuration of an optical system according to a fifth embodiment operating in a third mode.

FIG. 36 is a table showing aspherical coefficients of lenses in an optical system according to a fifth embodiment.

FIG. 37 is a graph showing data on diffraction MTF (Modulation Transfer Function) at room temperature of an optical system according to a fifth embodiment operating in a first mode.

FIG. 38 is a graph showing data on aberration characteristics of an optical system according to a fifth embodiment operating in a first mode.

FIG. 39 is a graph showing data on diffraction MTF (Modulation Transfer Function) at room temperature of an optical system according to a fifth embodiment operating in a second mode.

FIG. 40 is a graph showing data on aberration characteristics of an optical system according to a fifth embodiment operating in a second mode.

FIG. 41 is a graph showing data on diffraction MTF (Modulation Transfer Function) at room temperature of an optical system according to a fifth embodiment operating in a third mode.

FIG. 42 is a graph showing data on aberration characteristics of an optical system according to a fifth embodiment operating in a third mode.

FIG. 43 is a graph showing data on relative illumination versus relative field of an optical system according to a fifth embodiment operating in a fifth mode.

FIG. 44 is a diagram showing a configuration of an optical system according to a sixth embodiment operating in a first mode.

FIG. 45 is a diagram showing a configuration of an optical system according to a sixth embodiment operating in a second mode.

FIG. 46 is a diagram showing a configuration of an optical system according to a sixth embodiment operating in a third mode.

FIG. 47 is a table showing aspherical coefficients of lenses in an optical system according to a sixth embodiment.

FIG. 48 is a graph showing data on diffraction MTF (Modulation Transfer Function) at room temperature of an optical system according to a sixth embodiment operating in a first mode.

FIG. 49 is a graph showing data on aberration characteristics of an optical system according to a sixth embodiment operating in a first mode.

FIG. 50 is a graph showing data on diffraction MTF (Modulation Transfer Function) at room temperature of an optical system according to a sixth embodiment operating in the second mode.

FIG. 51 is a graph showing data on aberration characteristics of an optical system according to a sixth embodiment operating in a second mode.

FIG. 52 is a graph showing data on diffraction MTF (Modulation Transfer Function) at room temperature of an optical system according to a sixth embodiment operating in a third mode.

FIG. 53 is a graph showing data on aberration characteristics of an optical system according to a sixth embodiment operating in a third mode.

FIG. 54 is a graph showing data on relative illumination versus relative field of an optical system according to a sixth embodiment.

FIGS. 55(a) to (c) are drawings illustrating a lens to which a D-cut technique is applied according to the present embodiment.

FIGS. 56(a) to (c) are drawings illustrating an optical member being disposed in a lens according to the present embodiment.

FIG. 57 is an exploded perspective view of a camera module according to the present embodiment.

FIG. 58 is an example of a vehicle having an optical system according to the present embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

In the description of the invention, the “object side surface” may mean a surface of a lens facing the object side with respect to an optical axis (OA), and the “sensor side surface” may mean a surface of a lens facing the imaging surface (image sensor) with respect to the optical axis. The “object side surface” may be the “object side surface”, and the “sensor side surface” may be the “image side surface”. A convex surface of a lens may mean a convex shape in an optical axis or a paraxial region, and a concave surface of a lens may mean a concave shape in an optical axis or a paraxial region. The radius of curvature, the center thickness, and the optical axis gap between lenses described in the table for lens data may mean values (unit: mm) on the optical axis. The vertical direction may mean a direction perpendicular to the optical axis, and the end of a lens or lens surface may mean the end of an effective area of a lens through which incident light passes. The size of the effective diameter of the lens surface may have a measurement error of up to +0.4 mm depending on the measurement method, and the like. The above-mentioned Paraxial region refers to a very narrow region near the optical axis, and is a region where the distance that a light ray falls from the optical axis (OA) is almost 0. Hereinafter, the meaning of the optical axis may include the center of each lens or a very narrow region near the optical axis.

The optical systems 1000, 1100, and 1200 according to the first to third embodiments may include a plurality of lens groups. In detail, the optical systems 1000, 1100, and 1200 may include a plurality of lens groups each including at least one lens. For example, the optical systems 1000, 1100, and 1200 may include a first lens group G1, a second lens group G2, a third lens group G3, and an image sensor 700 being sequentially disposed along the optical axis OA from the object side toward the sensor.

Each of the first to third lens groups G1, G2, and G3 can have positive (+) or negative (−) refractive power. In detail, the first lens group G1 and the second lens group G2 can have opposite refractive powers. For example, the first lens group G1 can have negative (−) refractive power, and the second lens group G2 can have positive (+) refractive power. In addition, the second lens group G2 and the third lens group G4 can have opposite refractive powers. For example, the second lens group G3 can have positive (+) refractive power, and the third lens group G3 can have negative (−) refractive power.

The first lens group G1 and the second lens group G2 may have different focal lengths. Specifically, since the first and second lens groups G1 and G2 have opposite refractive powers, the focal length of the second lens group G2 may have a sign (+, −) opposite to the focal length of the first lens group G1. In addition, the second lens group G2 and the third lens group G3 may have different focal lengths. Specifically, since the second and third lens groups G2 and G3 have opposite refractive powers, the focal length of the second lens group G2 may have a sign (+, −) opposite to the focal length of the third lens group G3.

At least one among the first to third lens groups G1, G2, and G3 may be provided to be movable in an optical axis direction OA. In detail, at least two among the plurality of lens groups G1, G2, and G3 may be provided to be movable, and the remaining lens groups may be fixed. For example, the first lens group G1 may be disposed at a fixed position, and the second lens group G2 and the third lens group G3 may be provided to be movable in an optical axis direction OA.

The first lens group G1 may include multiple lenses. Specifically, the first lens group G1 may include one or more lenses having opposite refractive powers. For example, the first lens group G1 may include three lenses.

The plurality of lenses included in the first lens group G1 may have a set gap. In detail, the gap between the plurality of lenses included in the first lens group G1 may be constant without changing in the operation mode described later. For example, the gap between the first lenses 101, 201, and 301 and the second lenses 102, 202, and 302 and the gap between the second lenses 102, 202, and 302 and the third lenses 103, 203, and 303 may be constant without changing in the operation mode described later. Here, the gap between the plurality of lenses may mean the gap on the optical axis direction of adjacent lenses on the optical axis.

The second lens group G2 may include a plurality of lenses. Specifically, the second lens group G2 may include two or more lenses having opposite refractive powers. The number of lenses included in the second lens group G2 may be less than the number of lenses included in the first lens group G1. For example, the second lens group G2 may include two lenses.

The plurality of lenses included in the second lens group G2 may have a set gap. Specifically, the gap between the plurality of lenses included in the second lens group G2 may be constant and not change in the operation mode described later. For example, the gap between the fourth lenses 104, 204, and 304 and the fifth lenses 105, 205, and 305 may be constant and not change in the operation mode described later.

The third lens group G3 may include a plurality of lenses. Specifically, the third lens group G3 may include two or more lenses having opposite refractive powers. The number of lenses included in the third lens group G3 may be less than the number of lenses included in the first lens group G1. For example, the third lens group G3 may include two lenses.

The plurality of lenses included in the third lens group G3 may have a set gap. Specifically, the gap between the plurality of lenses included in the third lens group G3 may be constant and not change in the operation mode described later. For example, the gap between the sixth lenses 106, 206, and 306 and the seventh lenses 107, 207, and 307 may be constant and not change in the operation mode described later.

That is, the optical systems 1000, 1100, and 1200 may include a plurality of lens groups G1, G2, and G3 and an image sensor 700 being sequentially disposed from the object side toward the sensor side. In addition, the optical systems 1000, 1100, and 1200 may include a plurality of lenses included in the lens groups G1, G2, and G3, for example, first lenses 101, 201, and 301, second lenses 102, 202, and 302, third lenses 103, 203, and 303, fourth lenses 104, 204, and 304, fifth lenses 105, 205, and 305, sixth lenses 106, 206, and 306, and seventh lenses 107, 207, and 307. In this case, the first lens group G1 may include the first and third lenses 101 to 103, 201 to 203, and 301 to 303, and the second lens group G2 may include the fourth and fifth lenses 104 to 105, 204 to 205, and 304 to 305. In addition, the third lens group G3 may include the sixth and seventh lenses 106 to 107, 206 to 207, and 306 to 307. The first to sixth lenses 101 to 107, 201 to 207, and 301 to 307 and the image sensor 700 may be sequentially disposed along the optical axis OA of the optical systems 1000, 1100, and 1200.

Each of the plurality of lenses 100 may include an effective area and an ineffective area. The effective area may be an area through which light incident on each of the first to seventh lenses 101 to 107, 201 to 207, and 301 to 307 passes. In other words, the effective area may be an area in which the incident light is refracted to implement optical characteristics.

The ineffective area may be located around the effective area. The ineffective area may be an area where no light is incident. In other words, the ineffective area may be an area unrelated to optical characteristics. In addition, the ineffective area may be an area fixed to a barrel (not shown) that accommodates the lens.

The image sensor 700 can detect light. The image sensor 700 can detect light that has sequentially passed through a plurality of lenses, for example, the first to seventh lenses 101 to 107, 201 to 207, and 301 to 307. The image sensor 700 may include a CCD (Charge Coupled Device) or a CMOS (Complementary Metal Oxide Semiconductor).

In addition, the optical systems 1000, 1100, and 1200 may further include a filter 800. The filter 800 may be disposed between a plurality of lenses and the image sensor 700. The filter 800 may be disposed between the image sensor 700 and the third lens group G3 that is closest to the image sensor 700 among the plurality of lens groups G1, G2, and G3. For example, the filter 800 may be disposed between the last lens of the third lens group G3 that is closest to the image sensor 700 among the plurality of lenses and the image sensor 700.

The filter 800 may include at least one optical filter, such as an infrared filter or a cover glass. The filter 800 may allow light of a set wavelength band to pass through and filter out light of a different wavelength band. When the filter 800 includes an infrared filter, it may block radiant heat being emitted from external light from being transmitted to the image sensor 700. In addition, the filter 800 may allow visible light to pass through and reflect infrared light.

The optical systems 1000, 1100, and 1200 may include an aperture (not shown). The aperture can control the amount of light incident on the optical systems 1000, 1100, and 1200.

The aperture may be disposed in front of the first lenses 101, 201, and 301 or may be disposed between two lenses selected from the first to seventh lenses 101 to 107, 201 to 207, and 301 to 307. For example, the aperture may be disposed between the third lenses 103, 203, and 303 and the fourth lenses 104, 204, and 304. In addition, at least one lens from the first to seventh lenses 101 to 107, 201 to 207, and 301 to 307 may function as an aperture. For example, an object-side surface or a sensor-side surface of one lens being selected from the first to seventh lenses 101 to 107, 201 to 207, and 301 to 307 may function as an aperture for controlling the amount of light. For example, at least one lens surface among the sensor side surface (sixth surface S6) of the third lenses 103, 203, and 303 and the object side surface (seventh surface S7) of the fourth lenses 104, 204, and 304 can function as an aperture.

An optical system according to a first embodiment of the invention will be described.

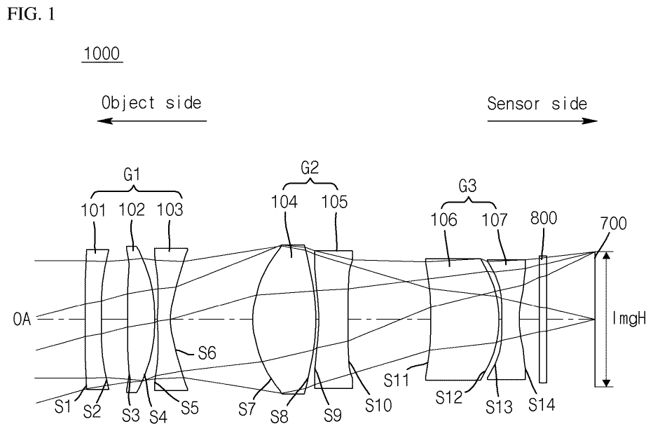

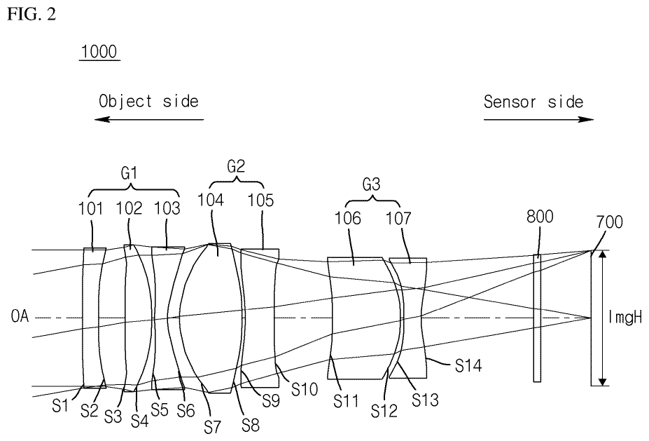

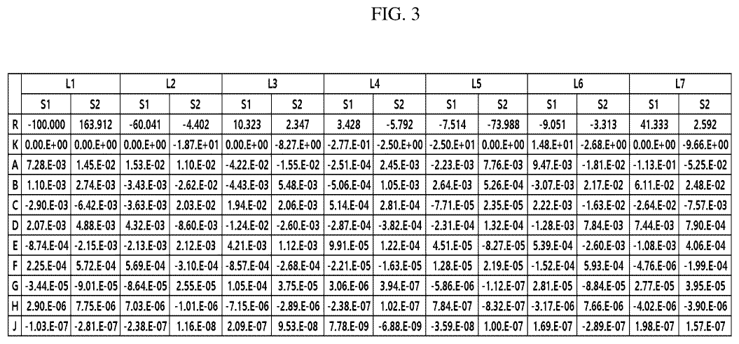

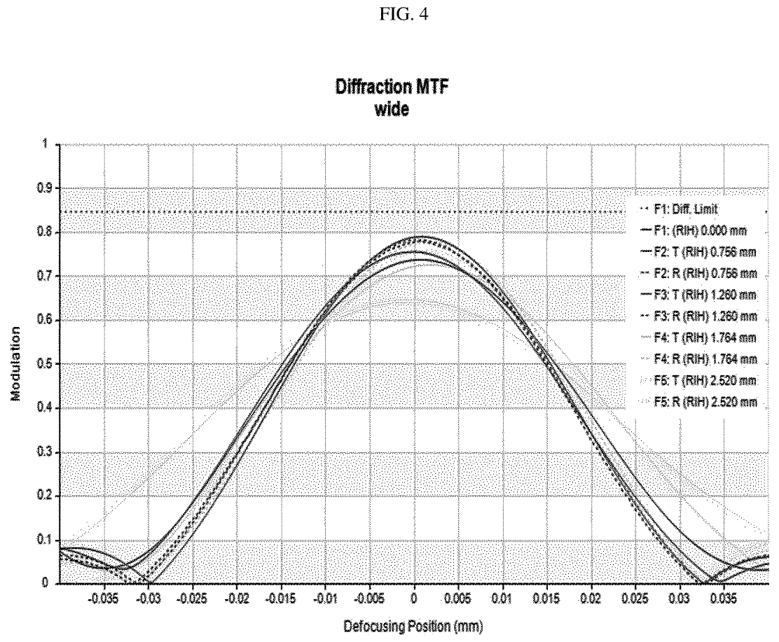

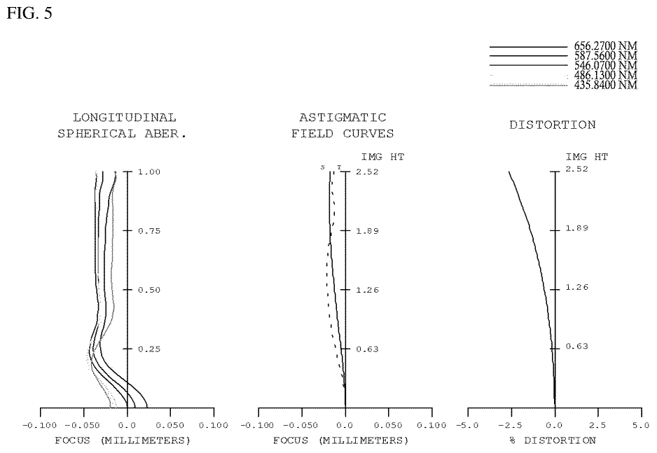

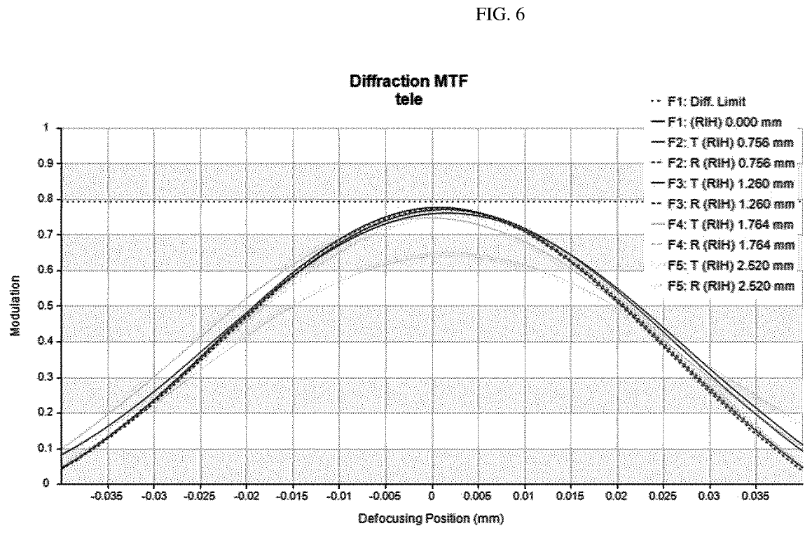

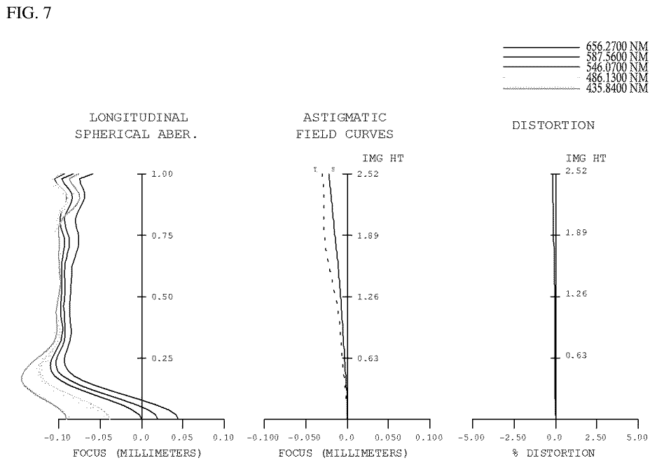

FIG. 1 is a schematic diagram of an optical system according to a first embodiment operating in a first mode; FIG. 2 is a schematic diagram of an optical system according to a first embodiment operating in a second mode; FIG. 3 is a table showing aspherical coefficients of lenses in an optical system according to a first embodiment; FIG. 4 is a graph showing data on the diffraction MTF (Modulation Transfer Function) at room temperature of an optical system according to a first embodiment operating in a first mode; FIG. 5 is a graph showing data on the aberration characteristics of an optical system according to a first embodiment operating in a first mode; FIG. 6 is a graph showing data on the diffraction MTF (Modulation Transfer Function) at room temperature of an optical system according to a first embodiment operating in a second mode; and FIG. 7 is a graph showing data on the aberration characteristics of an optical system according to a first embodiment operating in a second mode.

Referring to FIGS. 1 and 2, an optical system 1000 includes a lens unit, and the lens unit may include a first lens 101 to a seventh lens 107. The first to seventh lenses 101-107 may be sequentially disposed along the optical axis OA of the optical system 1000. Light corresponding to information on an object may pass through the first to seventh lenses 101-107 and a filter 800 and be incident on the image sensor 700.

The first lens 101 may be disposed closest to the object side. The first lens 101 may be disposed furthest from the sensor side. The first lens 101 may have negative (−) refractive power on the optical axis OA. The first lens 101 may include a plastic material or a glass material, and may be, for example, a plastic material.

The object-side first surface S1 of the first lens 101 is concave with respect to the optical axis, and the sensor-side second surface S2 may be concave. The first lens 101 may have a concave shape on both sides. The first lens 101 may be made of a plastic material and may have an aspherical surface.

The refractive index (n1) of the first lens 101 can satisfy the condition of n1>1.5, preferably n1>1.55. If the refractive index (n1) of the first lens 101 is less than the condition, the lens surface must be formed sharply concave or convex in order to increase the refractive power of the first and second lenses 101 and 102. In this case, lens manufacturing is not easy, the lens defect rate increases, and it may cause a decrease in yield.

The second lens 102 may be disposed second from the object side. The second lens 102 may be disposed sixth from the sensor side. The second lens 102 may be disposed between the first lens 101 and the third lens 103. The second lens 102 may have positive refractive power on the optical axis OA. The second lens 102 may have different refractive power from the first lens 101 on the optical axis OA. The second lens 102 may include a plastic or glass material. For example, the second lens 102 may be provided as a plastic material.

The third surface S3 on the object side of the second lens 102 may be concave with respect to the optical axis OA, and the fourth surface S4 on the sensor side may be convex. The second lens 102 may have a concave meniscus shape toward the object side. The second lens 102 may have a convex meniscus shape toward the sensor side. The second lens 102 may be made of a plastic material and may have an aspherical surface. The aspherical coefficients of the third and fourth surfaces S3 and S4 may be provided as L2S1 and L2S2 of FIG. 2.

The third lens 103 may be disposed third from the object side. The third lens 103 may be disposed fifth from the sensor side. The third lens 103 may be disposed between the second lens 102 and the fourth lens 104. The third lens 103 may have negative (−) refractive power on the optical axis OA. The third lens 103 may include a plastic or glass material. For example, the third lens 103 may be provided as a glass material.

The fifth surface S5 on the object side of the third lens 103 with respect to the optical axis may be convex, and the sixth surface S6 on the sensor side may be concave. The third lens 103 may have a convex meniscus shape toward the object side. The third lens 103 may have a concave meniscus shape toward the sensor side. The third lens 103 is made of glass and may have an aspherical surface. The third lens 103 may be made of a glass mold (GM) material. The aspherical coefficients of the fifth and sixth surfaces S5 and S6 may be provided as L3S1 and L3S2 of FIG. 3.

The aperture (STOP) may be disposed around the periphery of the sensor-side sixth surface S6 of the third lens 103. The aperture (STOP) may be disposed around the object-side seventh surface S7 of the fourth lens 103. The aperture can reduce the TTL within the field of view range, and miniaturization of the optical system is possible. Accordingly, a decrease in the yield by weight of the optical system can be prevented, and production efficiency can be improved. In addition, the optical system can be miniaturized by reducing the TTL within the diagonal field of view (FOV_D) of 20 to 40 degrees.

The lens closest to the aperture (STOP) may be made of glass. The third lens 103 closest to the object side of the aperture (STOP) and the fourth lens 104 closest to the sensor side of the aperture (STOP) may be made of glass. Since the lens closest to the aperture (STOP) is a sensitive lens that affects the entire optical system, a lens made of glass may be disposed to minimize the effect of temperature changes. The two lenses closest to the aperture (STOP) may have different refractive powers. The third lens 103 may have positive (+) refractive power, and the fourth lens 104 may have negative (−) refractive power.

In the entire optical system 1000, the focal length of the lens made of glass may be the shortest. In the entire optical system 1000, the refractive power of the lens made of glass may be the greatest. The fourth lens 104 made of glass may have the shortest focal length. The fourth lens 104 made of glass may have the greatest refractive power. The difference in Abbe numbers between the two lenses closest to the aperture (STOP) may be greater than 25 and less than 35. One of the lenses closest to the aperture (STOP) may have the largest Abbe number in the optical system 1000. By arranging the two lenses with a large Abbe number difference adjacent to the aperture (STOP), the occurrence of chromatic aberration noise may be reduced.

The fourth lens 104 may be disposed fourth from the object side. The fourth lens 104 may be disposed fourth from the sensor side. The fourth lens 104 may be disposed between the third lens 103 and the fifth lens 105. The fourth lens 104 may have positive (+) refractive power. The fourth lens 104 may include a plastic or glass material. For example, the fourth lens 104 may be provided as a glass material.

The object-side seventh surface S7 of the fourth lens 104 with respect to the optical axis may be convex, and the sensor-side eighth surface S8 may be convex. The fourth lens 104 may have a convex shape on both sides. The fourth lens 104 may be made of glass and may have an aspherical surface. The fourth lens 104 may be made of glass mold (GM) material. The aspherical coefficients of the seventh and eighth surfaces S7 and S8 may be provided as L4S1 and L4S2 of FIG. 3.

The fifth lens 105 may be disposed as the fifth lens from the object side. The fifth lens 105 may be disposed as the third lens from the sensor side. The fifth lens 105 may be disposed between the fourth lens 104 and the sixth lens 106. The fifth lens 105 may have positive (+) or negative (−) refractive power on the optical axis OA. The fifth lens 105 may have negative (−) refractive power. The fifth lens 105 may include a plastic or glass material. For example, the fifth lens 105 may be provided as a plastic material.

With respect to the optical axis OA, the ninth surface S9 on the object side of the fifth lens 105 may be concave, and the tenth surface S10 on the sensor side may be convex. The fifth lens 105 may have a convex meniscus shape toward the sensor side. The fifth lens 105 may have a concave meniscus shape toward the object side. The fifth lens 105 is made of a plastic material and may have an aspherical surface. The aspherical coefficients of the ninth and tenth surfaces S9 and S10 may be provided as L5S1 and L5S2 of FIG. 3.

The sixth lens 106 may be disposed as the sixth lens from the object side. The sixth lens 106 may be disposed as the second lens from the sensor side. The sixth lens 106 may have positive (+) refractive power. The sixth lens 106 may include a plastic or glass material. For example, the sixth lens 106 may be provided as a plastic material.

With respect to the optical axis OA, the eleventh surface S11 on the object side of the sixth lens 106 may be concave, and the twelfth surface S12 on the sensor side may be convex. The sixth lens 106 may have a concave meniscus shape toward the object side. The sixth lens 106 may have a convex meniscus shape toward the sensor side. At least one or both of the eleventh surface S11 and the twelfth surface S12 may be aspherical. The aspherical coefficients of the eleventh and twelfth surfaces S11 and S12 may be provided as L6S1 and L6S2 of FIG. 3.

The seventh lens 107 may be disposed closest to the sensor side. The seventh lens 107 may be disposed furthest from the object side. The seventh lens 107 may have negative (−) refractive power. The seventh lens 107 may include a plastic or glass material. For example, the seventh lens 107 may be provided as a plastic material.

With respect to the optical axis OA, the thirteenth surface S13 on the object side of the seventh lens 107 may be convex, and the 1fourth surface S14 on the sensor side may be concave. The seventh lens 107 may have a meniscus shape that is convex on the object side. At least one or both of the thirteenth surface S13 and the 1fourth surface S14 may be aspherical. The aspherical coefficients of the thirteenth and 1fourth surfaces S13 and S14 may be provided as L7S1 and L7S2 of FIG. 3.

TABLE 1

| | | | | | | Semi | Focal |
|---|---|---|---|---|---|---|---|
| Lens | Surface | Radius | Thickness | nd | vd | Aperture | length |
| 1 | S1 | −100.000 | 0.534 | 1.615 | 25.960 | 2.320 | −100.000 |
| | S2 | 163.912 | 0.894 | | | 2.295 | |
| 2 | S3 | −60.041 | 0.871 | 1.661 | 20.357 | 2.386 | 7.056 |
| | S4 | −4.402 | 0.100 | | | 2.445 | |
| 3 | S5 | 10.323 | 0.426 | 1.689 | 31.161 | 2.363 | −4.474 |
| | S6(STOP) | 2.347 | Variable(D1) | | | 2.314 | |
| 4 | S7 | 3.428 | 2.077 | 1.589 | 61.251 | 2.480 | 3.974 |
| | S8 | −5.792 | 0.100 | | | 2.426 | |
| 5 | S9 | −7.514 | 0.951 | 1.671 | 19.246 | 2.321 | −12.379 |
| | S10 | −73.988 | Variable(D2) | | | 2.034 | |
| 6 | S11 | −9.051 | 2.247 | 1.671 | 19.246 | 2.044 | 6.639 |
| | S12 | −3.313 | 0.100 | | | 2.159 | |
| 7 | S13 | 41.333 | 0.585 | 1.615 | 25.960 | 2.082 | −4.482 |
| | S14 | 2.592 | Variable(D3) | | | 2.196 | |
| Filter | | Infinity | 0.210 | | | 2.342 | |
| | | Infinity | 1.649 | | | 2.355 | |
| Image | | Infinity | | | | 2.520 | |

Table 1 shows the surface number (Surface), radius of curvature (Radius), center thickness of each lens or distance between lens surfaces (Thickness), refractive index (Index,nd), Abbe number (Abbe,vd), effective radius (Semi Aperture), and focal length (Focal length) of the lens according to a first embodiment of the present invention. At this time, the unit of the radius of curvature and thickness or distance may be mm.

TABLE 2

| | wide | middle | tele |
|---|---|---|---|
| D1 | 2.747 | 1.725 | 0.400 |
| D2 | 2.768 | 2.074 | 1.965 |
| D3 | 0.675 | 2.486 | 3.761 |

Table 2 shows the gaps D1, D2, and D3 between lenses that are variable when the optical system according to a first embodiment of the present invention operates in any one of the wide, (middle), and telephoto modes. Here, the wide-angle end may refer to the first mode, and the telephoto end may refer to the second mode. The wide-angle end may be referred to as a wide angle, and the telephoto end may be referred to as a telephoto.

In the optical system according to a first embodiment of the present invention, the distance between adjacent lens groups may change during the process of changing the magnification from the wide-angle end to the intermediate end and then to the telephoto end. The first lens group G1 is fixed, and only the second and third lens groups G2 and G3 can move. The first lens group G1 may be a fixed group, and the second and third lens groups G2 and G3 may be movable groups.

When operating from the wide-angle end to the intermediate end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the intermediate end to the telephoto end, the distance D1 between the first lens group G1 and the second lens group G2 becomes smaller, the distance D2 between the second lens group G2 and the third lens group G3 becomes smaller, and the distance D3 between the third lens group G3 and the filter 800 may become larger.

When operating from the wide-angle end to the telephoto end, the distance D1 between the first lens group G1 and the second lens group G2 becomes smaller, the distance D2 between the second lens group G2 and the third lens group G3 becomes smaller, and the distance D3 between the third lens group G3 and the filter 800 may become larger.

The stroke length of the second lens group G2 can satisfy 2 mm to 3 mm, and preferably can satisfy about 2.358 mm. The stroke length of the third lens group G3 can satisfy 2.5 mm to 3.5 mm, and preferably can satisfy about 3.095 mm. The stroke length of the second lens group G2 can be smaller than the stroke length of the third lens group G3. The second lens group G2 and the third lens group G3 can have different moving speeds. The moving speed of the third lens group G3 can be greater than the moving speed of the second lens group G2.

By moving the second lens group G2 and the third lens group G3, the magnification of the zoom optical system can be continuously adjusted from about 3 times to about 5 times. Here, the magnification may refer to the ratio of the focal lengths of the optical system according to the embodiment of the present invention to the reference optical system being disposed together with the moving terminal. In the first embodiment, the magnifications of the wide-angle end and the telephoto end can satisfy a range of 1 times to 2 times, and can satisfy a magnification of about 1.7 times.

TABLE 3

| | | | |
|---|---|---|---|
| EFL(f)_wide | 8.410 | EFL(f)_tele | 13.540 |
| FOV_wide | 34.3000 | FOV_tele | 21.3000 |
| EPD_wide | 3.9017 | EPD_tele | 4.5755 |
| BFL_wide | 2.5000 | BFL_tele | 5.6500 |
| TD_wide | 14.4000 | TD_tele | 11.2500 |
| SD_wide | 11.5750 | SD_tele | 8.4248 |
| Fno_wide | 2.155 | Fno_tele | 2.959 |
| ET1 | 0.6907 | f_G1 | −12.281 |
| ET2 | 0.4032 | f_G2 | 5.269 |
| ET3 | 0.9380 | f_G3 | −12.734 |
| ET4 | 0.7477 | G2_stroke | 2.347 |
| ET5 | 1.2762 | G3_stroke | 3.150 |
| ET6 | 1.7548 | TTL | 16.900 |
| ET7 | 1.3476 | ImgH | 5.040 |
| ΣIndex | 11.512 | CA_Max | 4.960 |
| ΣAbbe | 203.181 | CA_Min | 4.068 |
| ΣCT | 7.691 | CA_Aver | 4.552 |
| ΣCG | 7.384 | L_CT_max | 2.247 |
| | | L_CT_min | 0.426 |
| | | L_CT_aver | 1.099 |
| | | Air_max | 2.768 |

Table 3 shows the items of the mathematical formulas described above in the optical system 1000 of the first embodiment, including the effective focal length (F) (mm), BFL (Back Focal Length) (mm), EPD (mm), SD (mm), Fno, FOV (degree) which is the optical axis distance from the aperture (STOP) to the twelfth surface S12 at each of the wide-angle end (wide) and the telephoto end (tele) of the optical system 1000, and the focal lengths (f1 to f7) (mm), edge thicknesses (ET1 to ET7) of the first to seventh lenses 101 to 107, the focal lengths (f_G1, f_G2, and f_G3) (mm) of the first to third lens groups G1, G2, and G3, the stroke length (G2_stroke) of the second lens group G2, the stroke length (G3_stroke) of the third lens group G3, and the entire optical axis of the optical system 1000. These are for the distance (TTL) (mm), ImgH (mm), maximum effective diameter (CA_Max), minimum effective diameter (CA_Min), average effective diameter (CA_Aver), maximum center thickness (L_CT_max), minimum center thickness (L_CT_min), average center thickness (L_CT_aver) among the first to seventh lenses 101 to 107, and maximum value among adjacent lens gaps (Air_max).

The center thicknesses of the first to seventh lenses 101 to 107 are represented by CT1 to CT7, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. The BFL (Back focal length) is the optical axis distance from the image sensor 700 to the center of the last lens. The TTL is the optical axis distance from the center of the first surface S1 of the first lens 101 to the upper surface of the image sensor 700.

When comparing the absolute values of the curvature radius of each lens, the curvature radius of the first surface S1 of the first lens 101 on the optical axis OA may be the largest among the lenses, and the curvature radius of the sixth surface S6 of the third lens 103 may be the smallest among the lenses. The difference between the maximum and minimum curvature radius may be 40 times or more, for example, 45 to 55 times. The absolute value of the curvature radius of the first surface S1 of the first lens 101 may be smaller than the absolute value of the curvature radius of the second surface S2. The absolute value of the curvature radius of the third surface S3 of the second lens 102 may be larger than the absolute value of the curvature radius of the fourth surface S4. The absolute value of the radius of curvature of the fifth surface S5 of the third lens 103 may be greater than the absolute value of the radius of curvature of the sixth surface S6. The absolute value of the curvature radius of the seventh surface S7 of the fourth lens 104 may be smaller than the absolute value of the curvature radius of the eighth surface S8. The absolute value of the curvature radius of the ninth surface S9 of the fifth lens 105 may be smaller than the absolute value of the curvature radius of the tenth surface S10. The absolute value of the curvature radius of the eleventh surface S11 of the sixth lens 106 may be larger than the absolute value of the curvature radius of the twelfth surface S12. The absolute value of the curvature radius of the thirteenth surface S13 of the seventh lens 107 may be larger than the absolute value of the curvature radius of the fourteenth surface S14.

The ratio of the radius of curvature of each lens can satisfy the following conditions.

$$0.5 < \vert L 1 R 1 / L 1 R 2 \vert < 1 \qquad Condition 1$$

$$10 < \vert L 2 R 1 / L 2 R 2 \vert < 15 \qquad Condition 2$$

$$3 < \vert L 3 R 1 / L 3 R 2 \vert < 5 \qquad Condition 3$$

$$0.3 < \vert L 4 R 1 / L 4 R 2 \vert < 0.8 \qquad Condition 4$$

$$0.1 < \vert L 5 R 1 / L 5 R 2 \vert < 0.3 \qquad Condition 5$$

$$2 < \vert L 6 R 1 / L 6 R 2 \vert < 4 \qquad Condition 6$$

$$13 < \vert L 7 R 1 / L 7 R 2 \vert < 17 \qquad Condition 7$$

When describing the center thickness of the lenses with respect to the optical axis, the center thickness CT6 of the sixth lens 106 is the largest among the lenses, and the center thickness CT3 of the third lens 103 is the smallest among the lenses. The difference between the maximum and minimum center thicknesses among the lenses may be in the range of 1.5 mm or more and 3 mm or less.

The center thickness of each lens can satisfy any one among the conditions below.

$$CT 2 , CT 4 , CT 5 , CT 6 , CT 7 > CT 1 , CT 3 \qquad Condition 1$$

$$CT 4 , CT 5 , CT 6 > CT 2 > CT 1 , CT 3 , CT 7 \qquad Condition 2$$

$$CT 1 , CT 2 , CT 4 , CT 5 , CT 6 , CT 7 > CT 3 \qquad Condition 3$$

$$CT 6 > CT 4 > CT 1 , CT 2 , CT 3 , CT 5 , CT 7 \qquad Condition 4$$

$$CT 4 , CT 6 > CT 5 > CT 1 , CT 2 , CT 3 , CT 7 \qquad Condition 5$$

$$CT 6 > CT 1 , CT 2 , CT 3 , CT 4 , CT 5 , CT 7 \qquad Condition 6$$

$$CT 2 , CT 4 , CT 5 , CT 6 > CT 7 > CT 1 , CT 3 \qquad Condition 7$$

When zooming, the gap CG1 between the first lens 101 and the second lens 102, the gap CG2 between the second lens 102 and the third lens 103, the gap CG4 between the fourth lens 104 and the fifth lens 105, and the gap G6 between the sixth lens 106 and the seventh lens 107 do not change, while the gap CG3 between the third lens 103 and the fourth lens 104 and the gap CG5 between the fifth lens 105 and the sixth lens 106 may change. Among the center gaps between the unchanging lenses, the center gap CG1 between the first lens 101 and the second lens 102 may be the maximum, and the center gap CG3 between the second and third lenses 102 and 103, the center gap CG4 between the fourth lens 104 and the fifth lens 105, and the center gap CG6 between the sixth lens 106 and the seventh lens 107 may be the minimum. The difference between the maximum and minimum center gaps among the lens gaps being spaced apart may be 2.5 mm or more, for example, in the range of 2.6 mm to 3 mm.

The center gap between each lens may satisfy the following condition.

$$CG 1 > CG 2 = CG 4 = CG 6 \qquad Condition 1$$

When explaining the effective diameter, the lens having the maximum effective diameter may be the fourth lens 104. Here, the effective diameter is the average of the effective diameters of the object-side surface and the sensor-side surface of each lens. The lens surface having the maximum effective diameter may be the seventh surface S7 of the fourth lens 104. The lens having the minimum effective diameter may be the sixth lens 106. The lens surface having the minimum effective diameter may be the tenth surface S10 of the fifth lens 105.

The average effective diameter of the first to seventh lenses 101 to 107 may be smaller than the diagonal length of the image sensor 700. Accordingly, light incident through a plurality of lenses aligned along the optical axis can be guided to the image sensor 700.

The effective diameter of each lens can satisfy any one among the conditions below.

$$CA\_L2 , CA\_L3 , CA\_L4 > CA\_L1 > CA\_L5 , CA\_L6 , CA\_L7 \qquad Condition 1$$

$$CA\_L4 > CA\_L2 > CA\_L1 , CA\_L3 , CA\_L5 , CA\_L6 , CA\_L7 \qquad Condition 2$$

$$CA\_L2 , CA\_L4 > CA\_L3 > CA\_L1 , CA\_L5 , CA\_L6 , CA\_L7 \qquad Condition 3$$

$$CA\_L4 > CA\_L1 , CA\_L2 , CA\_L3 , CA\_L5 , CA\_L6 , CA\_L7 \qquad Condition 4$$

$$CA\_L1 , CA\_L2 , CA\_L3 , CA\_L4 > CA\_L5 > CA\_L6 , CA\_L7 \qquad Condition 5$$

$$CA\_L1 , CA\_L2 , CA\_L3 , CA\_L4 , CA\_L5 , CA\_L7 > CA\_L6 \qquad Condition 6$$

$$CA\_L1 , CA\_L2 , CA\_L3 , CA\_L4 , CA\_L5 > CA\_L7 , CA\_L6 \qquad Condition 7$$

When explaining the refractive index, the refractive index of the third lens 103 may be the highest among the lenses and may be greater than 1.6, for example, greater than 1.65. The fourth lens 104 may have the lowest refractive index among the lenses. For example, the refractive index of the fourth lens 104 may be less than 1.6, for example, less than 1.59. The difference between the maximum refractive index and the minimum refractive index may be 0.1 or more.

The refractive index of each lens can satisfy any one of the conditions below.

$$n 2 , n 3 , n 5 , n 6 > n 1 = n 7 > n 4 \qquad Condition 1$$

$$n 3 , n 5 , n 6 > n 2 > n 1 , n 4 , n 7 \qquad Condition 2$$

$$n 3 > n 1 , n 2 , n 4 , n 5 , n 6 , n 7 \qquad Condition 3$$

$$n 1 , n 2 , n 3 , n 5 , n 6 , n 7 > n 4 \qquad Condition 4$$

$$n 3 > n 5 = n 6 > n 1 , n 2 , n 4 , n 7 \qquad Condition 5$$

Comparing the Abbe numbers, the Abbe number of the fourth lens 104 is the largest among the lenses and may be 60 or greater. The Abbe number of at least one of the fifth lens 105 and the sixth lens 106 is the smallest among the lenses and may be 20 or less. The difference between the maximum refractive index and the minimum Abbe number may be 40 or greater.

The Abbe number of each lens can satisfy any one among the conditions below.

$$v 3 , v 4 > v 1 = v 7 > v 2 , v 5 , v 6 \qquad Condition 1$$

$$v 1 , v 3 , v 4 , v 7 > v 2 > v 5 , v 6 \qquad Condition 2$$

$$v 4 > v 3 > v 1 , v 2 , v 5 , v 6 , v 7 \qquad Condition 3$$

$$v 4 > v 1 , v 2 , v 3 , v 5 , v 6 , v 7 \qquad Condition 4$$

$$v 1 , v 2 , v 3 , v 4 , v 7 > v 5 = v 6 \qquad Condition 5$$

The focal lengths F2, F4, and F6 of the second, fourth, and sixth lenses 102, 104, and 106 may have positive (+) signs. The second, fourth, and sixth lenses 102, 104, and 106 may have positive (+) refractive power. The focal lengths F1, F3, and F5 of the first, third, and fifth lenses 101, 103, and 105 may have negative (−) signs. The first, third, and fifth lenses 101, 103, and 105 may have negative (−) refractive power

When comparing the focal lengths in absolute values, the focal length of the first lens 101 is the largest among the lenses, and may be 90 or more and 110 or less. The focal length of the fourth lens 104 is the smallest among the lenses, and the absolute value of the focal length of the fourth lens 104 may be 3 or more and 5 or less.

The absolute value of the focal length of each lens can satisfy any one among the conditions below.

$$\vert f 1 \vert > \vert f 2 \vert , \vert f 3 \vert , \vert f 4 \vert , \vert f 5 \vert , \vert f 6 \vert , \vert f 7 \vert \qquad Condition 1$$

$$\vert f 1 \vert , \vert f 5 \vert > \vert f 2 \vert > \vert f 3 \vert , \vert f 4 \vert , \vert f 6 \vert , \vert f 7 \vert \qquad Condition 2$$

$$\vert f 1 \vert , \vert f 2 \vert , \vert f 5 \vert , \vert f 6 \vert , \vert f 7 \vert > \vert f 3 \vert > \vert f 4 \vert \qquad Condition 3$$

$$\vert f 1 \vert , \vert f 2 \vert , \vert f 3 \vert , \vert f 5 \vert , \vert f 6 \vert , \vert f 7 \vert > \vert f 4 \vert \qquad Condition 4$$

$$\vert f 1 \vert > \vert f 5 \vert > \vert f 2 \vert , \vert f 3 \vert , \vert f 4 \vert , \vert f 6 \vert , \vert f 7 \vert \qquad Condition 5$$

$$\vert f 1 \vert , \vert f 2 \vert , \vert f 5 \vert > \vert f 6 \vert > \vert f 3 \vert , \vert f 4 \vert , \vert f 7 \vert \qquad Condition 6$$

$$\vert f 1 \vert , \vert f 2 \vert , \vert f 5 \vert , \vert f 6 \vert > \vert f 7 \vert > \vert f 3 \vert , \vert f 4 \vert \qquad Condition 7$$

The composite focal length (f_G1) of the first lens group G1 may have a negative (−) sign. The first lens group G1 may have negative (−) composite refractive power. The composite focal length (f_G2) of the second lens group G2 may have a positive (+) sign. The second lens group G2 may have positive (+) composite refractive power. The composite focal length (f_G3) of the third lens group G3 may have a negative (−) sign. The third lens group G3 may have negative (−) composite refractive power. Through this, light incident from the object side can move away from the optical axis direction and then gather back on the optical axis direction, thereby forming a stable optical path.

When comparing the absolute values of the composite focal lengths of the first to third lens groups G1, G2, and G3, the composite focal length of the third lens group G3 may be the largest, and the composite focal length of the second lens group G2 may be the smallest. The relationship between the composite focal lengths of the first to third lens groups G1, G2, and G3 may satisfy |f_G3|>|f_G1|>|f_G2|.

The thickness T1 of the first lens 101 may have a difference of at least 1 time between the maximum thickness and the minimum thickness, for example, in the range of 1 to 1.3 times, and the center thickness CT1 may be a minimum and the edge thickness ET1 may be a maximum. The thickness T2 of the second lens 102 may have a maximum thickness in the range of 2 to 2.5 times the minimum thickness. The second lens 102 may be a minimum in the center thickness (CT2) and a maximum in the edge thickness (ET2). The thickness T3 of the third lens 103 may be a minimum in the center and a maximum in the edge, and the maximum thickness is in the range of 2.5 to 3 times the minimum thickness. The thickness T4 of the fourth lens 104 may be a maximum in the center and a minimum in the edge, and the maximum thickness is in the range of 1 to 1.5 times the minimum thickness. The thickness T5 of the fifth lens 105 may be minimum at the center and maximum at the edge and the maximum thickness is in the range of 1 to 1.5 times the minimum thickness. The thickness T6 of the sixth lens 106 may be maximum at the center and minimum at the edge and the maximum thickness is in the range of 1 to 1.5 times the minimum thickness. The thickness T7 of the seventh lens 107 may be minimum at the center and maximum at the edge and the maximum thickness is in the range of 2 to 2.5 times the minimum thickness.

The thickness of each lens can satisfy any one among the conditions below.

$$0.5 < CT 1 / ET 1 < 1 , 1 < ET 1 / CT 1 < 1.3 \qquad Condition 1$$

$$2 < CT 2 / ET 2 < 2.5 , 0.1 < ET 2 / CT 2 < 0.5 \qquad Condition 2$$

$$0.1 < CT 3 / ET 3 < 0.5 , 2 < ET 3 / CT 3 < 2.5 \qquad Condition 3$$

$$2.5 < CT 4 / ET 4 < 3 , 0.1 < ET 4 / CT 4 < 0.5 \qquad Condition 4$$

$$0.5 < CT 5 / ET 5 < 1 , 1 < ET 5 / CT 5 < 1.5 \qquad Condition 5$$

$$1 < CT 6 / ET 6 < 1.5 , 0.5 < ET 6 / CT 6 < 1 \qquad Condition 6$$

$$0.1 < CT 7 / ET 7 < 0.5 , 2 < ET 7 / CT 7 < 2.5 \qquad Condition 7$$

$$1 < Σ CT / Σ ET < 1.5 , 0.5 < Σ ET / Σ CT < 1 \qquad Condition 8$$

Among the gaps G1 to G6 between the lenses, the gap G1 between the first and second lenses 101 and 102 may have a maximum in the center and a minimum in the edge. The gap G2 between the second and third lenses 102 and 103 may have a maximum in the edge and a minimum in the center. The gap G3 between the third and fourth lenses 103 and 104 may have a maximum in the edge and a minimum in the center. The gap G4 between the fourth and fifth lenses 104 and 105 may have a maximum in the edge and a minimum in the center. The fifth gap G5 between the fifth and sixth lenses 105 and 106 may have a maximum in the center and a minimum in the edge. The sixth gap G6 between the sixth and seventh lenses 106 and 107 may have a minimum in the center and a maximum in the edge.

FIGS. 4 and 6 are graphs showing the diffraction MTF (Modulation Transfer Function) at the wide-angle end (wide) and the telephoto end (tele) in the optical systems of FIGS. 1 and 2, and are graphs showing the luminance ratio (modulation) according to the spatial frequency. As shown in FIGS. 4 and 6, the deviation of the MTF of the wide-angle end (wide) and the telephoto end (tele) at room temperature in the first embodiment of the invention may be less than 10%, that is, 7% or less.

FIGS. 5 and 7 are graphs showing aberration characteristics at the wide-angle end (wide) and the telephoto end (tele) in the optical systems of FIGS. 1 and 2. In the aberration graphs of FIGS. 5 and 7, spherical aberration (longitudinal spherical aberration), astigmatic field curves, and distortion are measured from left to right. In FIGS. 5 and 7, the X-axis may represent the focal length (mm) and the (degree) of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 5 and 7, the closer the curves at the wide-angle end (wide) and the telephoto end (tele) are to the Y-axis, the better the aberration correction function can be interpreted, so it can be seen that the optical system 1000 according to the first embodiment has measured values close to the Y-axis in almost all areas. That is, the optical system 1000 according to the first embodiment has enhanced resolution and can have good optical performance not only at the center of the field of view (FOV) but also at the peripheral portion.

An optical system according to a second embodiment of the invention will be described.

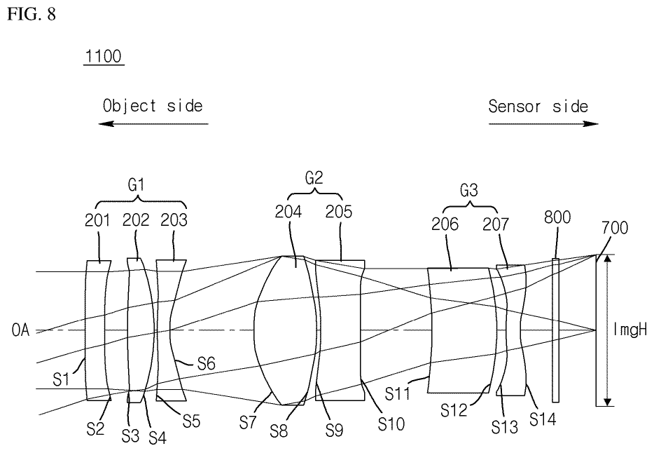

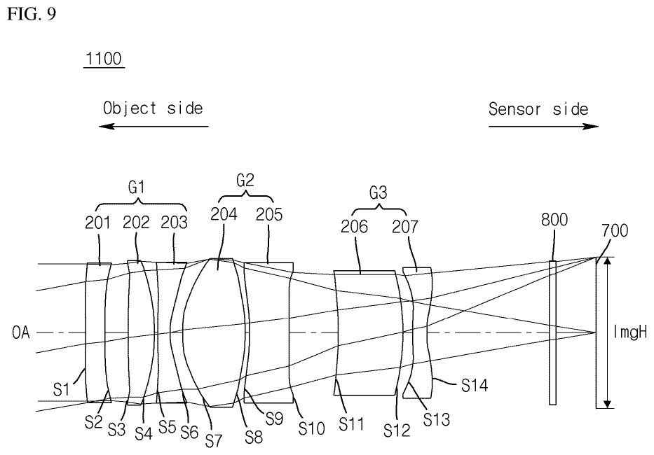

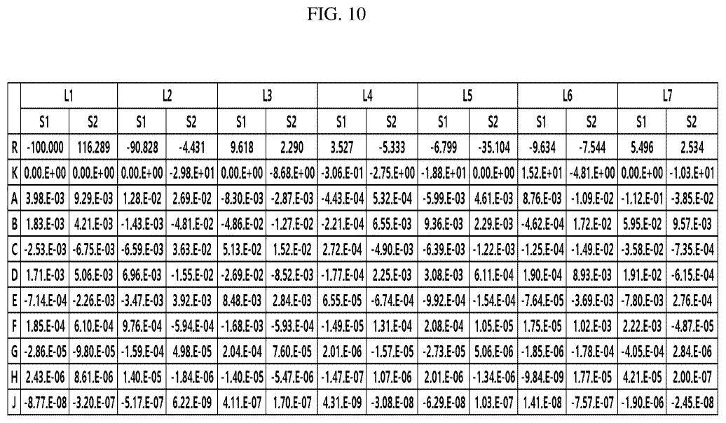

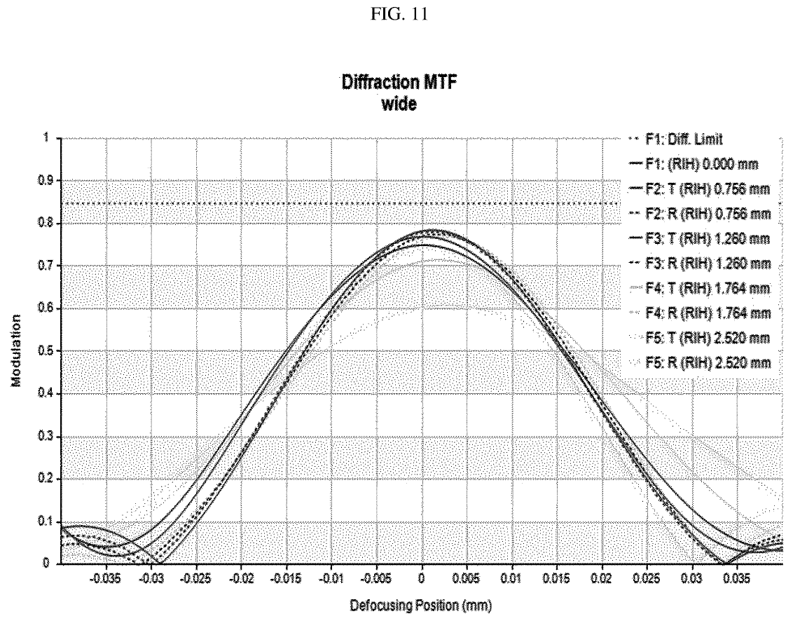

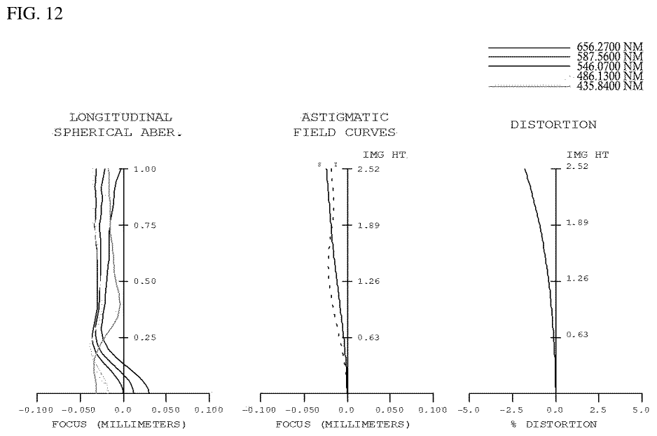

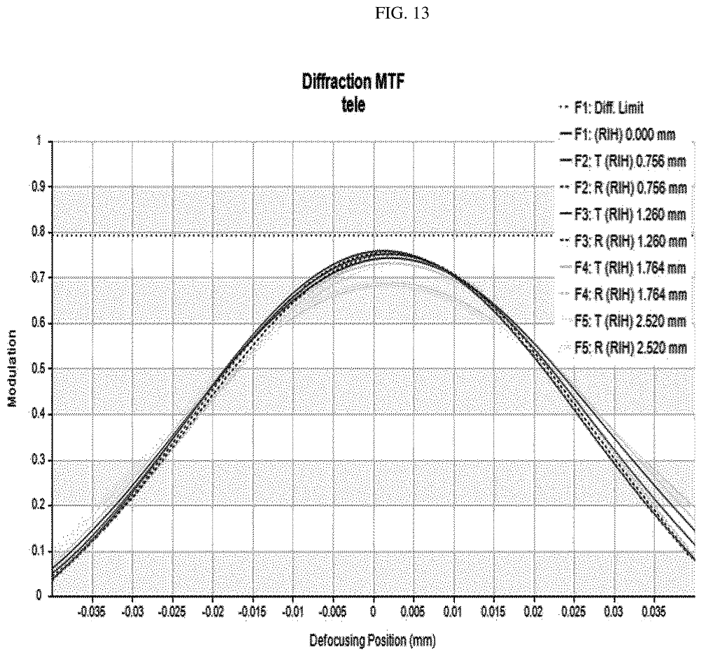

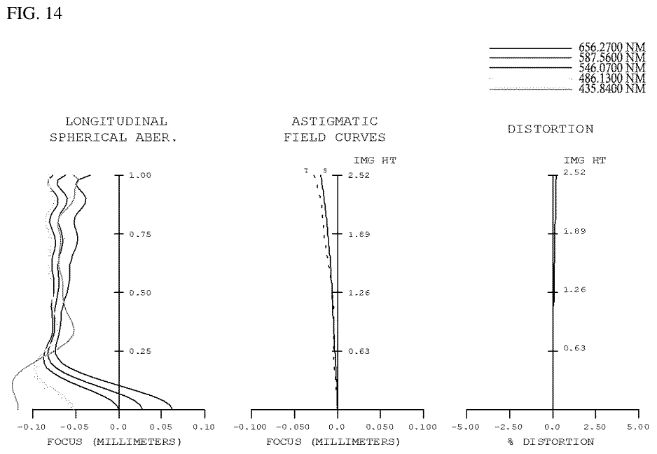

FIG. 8 is a schematic diagram of an optical system according to a second embodiment operating in a first mode; FIG. 9 is a schematic diagram of an optical system according to a second embodiment operating in the second mode; FIG. 10 is a table showing the aspherical coefficients of lenses in an optical system according to the second embodiment; FIG. 11 is a graph showing data on the diffraction MTF (Modulation Transfer Function) at room temperature of an optical system operating in a first mode according to a second embodiment; FIG. 12 is a graph showing data on the aberration characteristics of an optical system operating in a first mode according to a second embodiment; FIG. 13 is a graph showing data on a diffraction MTF (Modulation Transfer Function) at room temperature of an optical system operating in a second mode according to a second embodiment; and FIG. 14 is a graph showing data on aberration characteristics of an optical system operating in a second mode according to a second embodiment.

Referring to FIGS. 8 and 9, the optical system 1000 includes a lens unit, and the lens unit may include a first lens 201 to a seventh lens 207. The first to seventh lenses 201 to 207 may be sequentially disposed along the optical axis OA of the optical system 1000. Light corresponding to information on an object may pass through the first to seventh lenses 201 to 207 and the filter 800 and be incident on the image sensor 700.

The first lens 201 may be disposed closest to the object side. The first lens 201 may be disposed furthest from the sensor side. The first lens 201 may have negative (−) refractive power on the optical axis OA. The first lens 201 may include a plastic material or a glass material, and may be, for example, a plastic material.

The object-side first surface S1 of the first lens 201 is concave with respect to the optical axis, and the sensor-side second surface S2 may be concave. The first lens 201 may have a concave shape on both sides. The first lens 201 is made of a plastic material and may have an aspherical surface. The aspherical coefficients of the first and second surfaces S1 and S2 may be provided as L1S1, L1S2 of FIG. 10.

The refractive index (n1) of the first lens 201 can satisfy the condition of n1>1.5, preferably n1>1.55. If the refractive index (n1) of the first lens 201 is less than the condition, the lens surface must be formed sharply concave or convex in order to increase the refractive power of the first and second lenses 201 and 202. In this case, lens manufacturing is not easy, the lens defect rate increases, and it may cause a decrease in yield.

The second lens 202 may be disposed second from the object side. The second lens 202 may be disposed sixth from the sensor side. The second lens 202 may be disposed between the first lens 201 and the third lens 203. The second lens 202 may have positive refractive power on the optical axis OA. The second lens 202 may have different refractive power from the first lens 201 on the optical axis OA. The second lens 202 may include a plastic or glass material. For example, the second lens 202 may be provided as a plastic material.

The third surface S3 on the object side of the second lens 202 may be concave with respect to the optical axis OA, and the fourth surface S4 on the sensor side may be convex. The second lens 202 may have a concave meniscus shape toward the object side. The second lens 202 may have a convex meniscus shape toward the sensor side. The second lens 202 may be made of a plastic material and may have an aspherical surface. The aspherical coefficients of the third and fourth surfaces S3 and S4 may be provided as L2S1 and L2S2 of FIG. 10.

The third lens 203 may be disposed third from the object side. The third lens 203 may be disposed fifth from the sensor side. The third lens 203 may be disposed between the second lens 202 and the fourth lens 204. The third lens 203 may have negative (−) refractive power on the optical axis OA. The third lens 203 may include a plastic or glass material. For example, the third lens 203 may be provided as a glass material.

The fifth surface S5 on the object side of the third lens 203 with respect to the optical axis may be convex, and the sixth surface S6 on the sensor side may be concave. The third lens 203 may have a convex meniscus shape toward the object side. The third lens 203 may have a concave meniscus shape toward the sensor side. The third lens 203 is made of glass and may have an aspherical surface. The third lens 203 may be made of a glass mold (GM) material. The aspherical coefficients of the fifth and sixth surfaces S5 and S6 may be provided as L3S1 and L3S2 of FIG. 10.

The aperture (STOP) may be disposed around the sensor-side sixth surface S6 of the third lens 203. The aperture (STOP) may be disposed around the object-side seventh surface S7 of the fourth lens 203. The aperture can reduce the TTL within the field of view range, enabling miniaturization of the optical system. Accordingly, a decrease in the yield by weight of the optical system can be prevented, and production efficiency can be improved. In addition, the optical system can be miniaturized by reducing the TTL within the diagonal field of view (FOV_D) of 20 to 40 degrees.

The lens closest to the aperture (STOP) may be made of glass. The third lens 203 closest to the object side of the aperture (STOP) and the fourth lens 204 closest to the sensor side of the aperture (STOP) may be made of glass. Since the lens closest to the aperture (STOP) is a sensitive lens that affects the entire optical system, a lens made of glass may be disposed to minimize the effect of temperature changes. The two lenses closest to the aperture (STOP) may have different refractive powers. The third lens 203 may have positive (+) refractive power, and the fourth lens 204 may have negative (−) refractive power.

In the entire optical system 1100, the focal length of the lens made of glass may be the shortest. In the entire optical system 1100, the refractive power of the lens made of glass may be the greatest. The fourth lens 204 made of glass may have the shortest focal length. The fourth lens 204 made of glass may have the greatest refractive power. The difference in Abbe numbers between the two lenses being closest to the aperture (STOP) may be greater than 25 and less than 35. One of the lenses being closest to the aperture (STOP) may have the largest Abbe number in the optical system 1100. By disposing the two lenses having a large Abbe number difference adjacent to the aperture (STOP), the occurrence of chromatic aberration noise may be reduced.

The fourth lens 204 may be disposed fourth from the object side. The fourth lens 204 may be disposed fourth from the sensor side. The fourth lens 204 may be disposed between the third lens 203 and the fifth lens 205. The fourth lens 204 may have positive (+) refractive power. The fourth lens 204 may include a plastic or glass material. For example, the fourth lens 204 may be provided as a glass material.

The object-side seventh surface S7 of the fourth lens 204 with respect to the optical axis may be convex, and the sensor-side eighth surface S8 may be convex. The fourth lens 204 may have a convex shape on both sides. The fourth lens 204 may be made of glass and may have an aspherical surface. The fourth lens 204 may be made of glass mold (GM) material. The aspherical coefficients of the seventh and eighth surfaces S7 and S8 may be provided as L4S1 and L4S2 of FIG. 10.

The fifth lens 205 may be disposed as the fifth lens from the object side. The fifth lens 205 may be disposed as the third lens from the sensor side. The fifth lens 205 may be disposed between the fourth lens 204 and the sixth lens 206. The fifth lens 205 may have positive (+) or negative (−) refractive power on the optical axis OA. The fifth lens 205 may have negative (−) refractive power. The fifth lens 205 may include a plastic or glass material. For example, the fifth lens 205 may be provided as a plastic material.

With respect to the optical axis OA, the ninth surface S9 on the object side of the fifth lens 205 may be concave, and the tenth surface S10 on the sensor side may be convex. The fifth lens 205 may have a convex meniscus shape toward the sensor side. The fifth lens 205 may have a concave meniscus shape toward the object side. The fifth lens 205 is made of a plastic material and may have an aspherical surface. The aspherical coefficients of the ninth and tenth surfaces S9 and S10 may be provided as L5S1 and L5S2 of FIG. 10.

The sixth lens 206 may be disposed as the sixth lens from the object side. The sixth lens 206 may be disposed as the second lens from the sensor side. The sixth lens 206 may have positive (+) refractive power. The sixth lens 206 may include a plastic or glass material. For example, the sixth lens 206 may be provided as a plastic material.

With respect to the optical axis OA, the eleventh surface S11 on the object side of the sixth lens 206 may be concave, and the twelfth surface S12 on the sensor side may be convex. The sixth lens 206 may have a concave meniscus shape toward the object side. The sixth lens 206 may have a convex meniscus shape toward the sensor side. At least one or both of the eleventh surface S11 and the twelfth surface S12 may be aspherical. The aspherical coefficients of the eleventh and twelfth surfaces S11 and S12 may be provided as L6S1 and L6S2 of FIG. 10.

The seventh lens 207 may be disposed closest to the sensor side. The seventh lens 207 may be disposed furthest from the object side. The seventh lens 207 may have negative (−) refractive power. The seventh lens 207 may include a plastic or glass material. For example, the seventh lens 207 may be provided as a plastic material.

With respect to the optical axis OA, the thirteenth surface S13 on the object side of the seventh lens 207 may be convex, and the fourteenth surface S14 on the sensor side may be concave. The seventh lens 207 may have a meniscus shape that is convex on the object side. At least one or both of the thirteenth surface S13 and the fourteenth surface S14 may be aspherical. The aspherical coefficients of the thirteenth and fourteenth surfaces S13 and S14 may be provided as L7S1 and L7S2 of FIG. 10.

TABLE 4

| | | | | | | Semi | Focal |
|---|---|---|---|---|---|---|---|
| Lens | Surface | Radius | Thickness | nd | vd | Aperture | length |
| 1 | S1 | −100.000 | 0.639 | 1.535 | 55.709 | 2.320 | −100.000 |
| | S2 | 116.289 | 0.789 | | | 2.286 | |
| 2 | S3 | −90.828 | 0.850 | 1.661 | 20.357 | 2.332 | 6.937 |
| | S4 | −4.431 | 0.108 | | | 2.394 | |
| 3 | S5 | 9.618 | 0.408 | 1.689 | 31.161 | 2.340 | −4.431 |
| | S6(STOP) | 2.290 | Variable(D1) | | | 2.306 | |
| 4 | S7 | 3.527 | 2.072 | 1.589 | 61.251 | 2.480 | 3.931 |
| | S8 | −5.333 | 0.151 | | | 2.447 | |
| 5 | S9 | −6.799 | 1.319 | 1.671 | 19.246 | 2.341 | −12.647 |
| | S10 | −35.104 | Variable(D2) | | | 2.043 | |
| 6 | S11 | −9.634 | 2.130 | 1.671 | 19.246 | 2.027 | 36.237 |
| | S12 | −7.544 | 0.307 | | | 2.070 | |
| 7 | S13 | 5.496 | 0.477 | 1.535 | 55.709 | 2.046 | −9.277 |
| | S14 | 2.534 | Variable(D3) | | | 2.179 | |
| Filter | | Infinity | 0.210 | | | 2.377 | |
| | | Infinity | 1.237 | | | 2.390 | |
| Image | | Infinity | | | | 2.520 | |

Table 4 shows the surface number (Surface), radius of curvature (Radius), center thickness of each lens or distance between lens surfaces (Thickness), refractive index (Index,nd), Abbe number (Abbe,vd), effective radius (Semi Aperture), and focal length (Focal length) of the lens according to the second embodiment of the present invention. At this time, the unit of the radius of curvature and thickness or distance may be mm.

TABLE 5

| | wide | middle | tele |
|---|---|---|---|
| D1 | 2.787 | 1.666 | 0.430 |
| D2 | 2.362 | 1.718 | 1.625 |
| D3 | 1.082 | 2.842 | 4.101 |

Table 5 shows the gaps D1, D2, and D3 between lenses that are variable when the optical system according to the second embodiment of the present invention operates in any one among the wide-angle end (wide), intermediate end (middle), and telephoto end (tele) modes. Here, the wide-angle end (wide) may refer to the first mode, and the telephoto end (tele) may refer to the second mode. The wide-angle end may be referred to as (wide) angle, and the telephoto end may be referred to as telephoto.

In the optical system according to the second embodiment of the present invention, the distance between adjacent lens groups can change during the process of changing the magnification from the wide-angle end to the intermediate end and then to the telephoto end. The first lens group G1 is fixed, and only the second and third lens groups G2 and G3 can move. The first lens group G1 may be a fixed group, and the second and third lens groups G2 and G3 may be movable groups.

When operating from the wide-angle end to the intermediate end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the intermediate end to the telephoto end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the wide-angle end to the telephoto end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

The stroke length of the second lens group G2 can satisfy 2 mm to 3 mm, and preferably can satisfy about 2.358 mm. The stroke length of the third lens group G3 can satisfy 2.5 mm to 3.5 mm, and preferably can satisfy about 3.095 mm. The stroke length of the second lens group G2 can be smaller than the stroke length of the third lens group G3. The second lens group G2 and the third lens group G3 can have different moving speeds. The moving speed of the third lens group G3 can be greater than the moving speed of the second lens group G2.

By moving the second lens group G2 and the third lens group G3, the magnification of the zoom optical system can be continuously adjusted from about 3 times to about 5 times. Here, the magnification may refer to the ratio of the focal lengths of the optical system according to the embodiment of the present invention to the reference optical system disposed together with the moving terminal. In the second embodiment, the magnifications of the wide-angle end and the telephoto end can satisfy a range of 1 times to 2 times, and can satisfy a magnification of about 1.7 times.

TABLE 6

| | | | |
|---|---|---|---|
| EFL(f)_wide | 8.410 | EFL(f)_tele | 13.540 |
| FOV_wide | 34.3400 | FOV_tele | 21.2400 |
| EPD_wide | 3.9017 | EPD_tele | 4.5755 |
| BFL_wide | 2.5000 | BFL_tele | 5.6887 |
| TD_wide | 14.4000 | TD_tele | 11.2114 |
| SD_wide | 11.5750 | SD_tele | 8.3864 |
| Fno_wide | 2.155 | Fno_tele | 2.959 |
| ET1 | 0.6237 | f_G1 | −12.628 |
| ET2 | 0.3178 | f_G2 | 5.141 |
| ET3 | 0.9256 | f_G3 | −12.238 |
| ET4 | 0.7526 | G2_stroke | 2.374 |
| ET5 | 1.2431 | G3_stroke | 3.189 |
| ET6 | 2.0544 | TTL | 16.900 |
| ET7 | 1.2268 | ImgH | 5.040 |
| ΣIndex | 11.352 | CA_Max | 4.960 |
| ΣAbbe | 262.679 | CA_Min | 4.054 |
| ΣCT | 7.895 | CA_Aver | 4.516 |
| ΣCG | 7.586 | L_CT_max | 2.130 |
| | | L_CT_min | 0.408 |
| | | L_CT_aver | 1.128 |
| | | Air_max | 2.787 |

Table 6 shows the items of Mathematical expression described above in the optical system 1100 of the second embodiment, including the effective focal length (F) (mm), BFL (Back Focal Length) (mm), EPD (mm), SD (mm), Fno, FOV (degree), which is the optical axis distance from the aperture (STOP) to the twelfth surface S12, and the focal lengths (f1 to f7) (mm), edge thicknesses (ET1 to ET7) of the first to seventh lenses 201 to 207, the focal lengths (f_G1, f_G2, and f_G3) (mm) of the first to third lens groups G1, G2, and G3, the stroke length (G2_stroke) of the second lens group G2, the stroke length (G3_stroke) of the third lens group G3, and the entire optical axis of the optical system 1100. These are for the distance (TTL) (mm), ImgH (mm), maximum effective diameter (CA_Max), minimum effective diameter (CA_Min), average effective diameter (CA_Aver), maximum center thickness (L_CT_max), minimum center thickness (L_CT_min), average center thickness (L_CT_aver) among the first to seventh lenses 201 to 207, and maximum value among adjacent lens gaps (Air_max).

The center thicknesses of the first to seventh lenses 201 to 207 are represented by CT1 to CT7, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. The BFL (Back focal length) is the optical axis distance from the image sensor 700 to the center of the last lens. The TTL is the optical axis distance from the center of the first surface S1 of the first lens 201 to the upper surface of the image sensor 700.

When comparing the absolute values of the curvature radius of each lens, the curvature radius of the second surface S2 of the first lens 201 on the optical axis OA may be the largest among the lenses, and the curvature radius of the sixth surface S6 of the third lens 203 may be the smallest among the lenses. The difference between the maximum and minimum curvature radius may be 40 times or more, for example, 45 to 60 times. The absolute value of the curvature radius of the first surface S1 of the first lens 201 may be smaller than the absolute value of the curvature radius of the second surface S2. The absolute value of the curvature radius of the third surface S3 of the second lens 202 may be larger than the absolute value of the curvature radius of the fourth surface S4. The absolute value of the curvature radius of the fifth surface S5 of the third lens 203 may be larger than the absolute value of the curvature radius of the sixth surface S6. The absolute value of the curvature radius of the seventh surface S7 of the fourth lens 204 may be smaller than the absolute value of the curvature radius of the eighth surface S8. The absolute value of the curvature radius of the ninth surface S9 of the fifth lens 205 may be smaller than the absolute value of the curvature radius of the tenth surface S10. The absolute value of the curvature radius of the eleventh surface S11 of the sixth lens 206 may be larger than the absolute value of the curvature radius of the twelfth surface S12. The absolute value of the curvature radius of the thirteenth surface S13 of the seventh lens 207 may be larger than the absolute value of the curvature radius of the fourteenth surface S14.

The ratio of the radius of curvature of each lens can satisfy the following conditions.

$$0.5 < \vert L 1 R 1 / L 1 R 2 \vert < 1 \qquad Condition 1$$

$$15 < \vert L 2 R 1 / L 2 R 2 \vert < 25 \qquad Condition 2$$

$$3 < \vert L 3 R 1 / L 3 R 2 \vert < 5 \qquad Condition 3$$

$$0.5 < \vert L 4 R 1 / L 4 R 2 \vert < 1 \qquad Condition 4$$

$$0.1 < \vert L 5 R 1 / L 5 R 2 \vert < 0.3 \qquad Condition 5$$

$$1 < L 6 R 1 / L 6 R 2 < 1.5 \qquad Condition 6$$

$$1 < L 7 R 1 / L 7 R 2 < 3 \qquad Condition 7$$

When describing the center thickness of the lenses with respect to the optical axis, the center thickness CT6 of the sixth lens 206 is the largest among the lenses, and the center thickness CT3 of the third lens 203 is the smallest among the lenses. The difference between the maximum and minimum center thicknesses among the lenses may be in the range of 1.5 mm or more and 3 mm or less.

The center thickness of each lens can satisfy any one among the conditions below.

$$CT 2 , CT 4 , CT 5 , CT 6 > CT 1 > CT 3 , CT 7 \qquad Condition 1$$

$$CT 4 , CT 5 , CT 6 > CT 2 > CT 1 , CT 3 , CT 7 \qquad Condition 2$$

$$CT 1 , CT 2 , CT 4 , CT 5 , CT 6 , CT 7 > CT 3 \qquad Condition 3$$

$$CT 6 > CT 4 > CT 1 , CT 2 , CT 3 , CT 5 , CT 7 \qquad Condition 4$$

$$CT 4 , CT 6 > CT 5 > CT 1 , CT 2 , CT 3 , CT 7 \qquad Condition 5$$

$$CT 6 > CT 1 , CT 2 , CT 3 , CT 4 , CT 5 , CT 7 \qquad Condition 6$$

$$CT 1 , CT 2 , CT 4 , CT 5 , CT 6 > CT 7 > CT 3 \qquad Condition 7$$

When zooming, the gap CG1 between the first lens 201 and the second lens 202, the gap CG2 between the second lens 202 and the third lens 203, the gap CG4 between the fourth lens 204 and the fifth lens 205, and the gap CG6 between the sixth lens 206 and the sixth lens 207 do not change, while the gap CG2 between the second lens 202 and the third lens 203 and the gap CG5 between the fifth lens 205 and the sixth lens 206 can change. Among the center gaps between the lenses that do not change, the center gap CG1 between the first lens 201 and the second lens 202 can be the maximum, and the center gap CG2 between the second lens 202 and the third lens 203 can be the minimum. The difference between the maximum center gap and the minimum center gap among the separated lens gaps may be 2.5 mm or more, for example, in the range of 2.6 mm to 3 mm.

The center gap between each lens may satisfy the following conditions.

$$CG 1 > CG 2 , CG 4 , CG 6 \qquad Condition 1$$

$$CG 1 , CG 4 , CG 6 > CG 2 \qquad Condition 2$$

$$CG 1 , CG 6 > CG 4 > CG 2 \qquad Condition 3$$

$$CG 1 > CG 6 > CG 2 , CG 4 \qquad Condition 4$$

When explaining the effective diameter, the lens having the maximum effective diameter may be the fourth lens 204. Here, the effective diameter is the average of the effective diameters of the object-side surface and the sensor-side surface of each lens. The lens surface having the maximum effective diameter may be the seventh surface S7 of the fourth lens 204. The lens having the minimum effective diameter may be the sixth lens 206. The lens surface having the minimum effective diameter may be the tenth surface S10 of the fifth lens 205.

The average effective diameter of the first to seventh lenses 201 to 207 may be smaller than the diagonal length of the image sensor 700. Accordingly, light incident through a plurality of lenses aligned along the optical axis can be guided to the image sensor 700.

The effective diameter of each lens can satisfy any one among the conditions below.

$$CA\_L2 , CA\_L3 , CA\_L4 > CA\_L1 > CA\_L5 , CA\_L6 , CA\_L7 \qquad Condition 1$$

$$CA\_L4 > CA\_L2 > CA\_L1 , CA\_L3 , CA\_L5 , CA\_L6 , CA\_L7 \qquad Condition 2$$

$$CA\_L2 , CA\_L4 > CA\_L3 > CA\_L1 , CA\_L5 , CA\_L6 , CA\_L7 \qquad Condition 3$$

$$CA\_L4 > CA\_L1 , CA\_L2 , CA\_L3 , CA\_L5 , CA\_L6 , CA\_L7 \qquad Condition 4$$

$$CA\_L1 , CA\_L2 , CA\_L3 , CA\_L4 > CA\_L5 > CA\_L6 , CA\_L7 \qquad Condition 5$$

$$CA\_L1 , CA\_L2 , CA\_L3 , CA\_L4 , CA\_L5 , CA\_L7 > CA\_L6 \qquad Condition 6$$

$$CA\_L1 , CA\_L2 , CA\_L3 , CA\_L4 , CA\_L5 > CA\_L7 , CA\_L6 \qquad Condition 7$$

When explaining the refractive index, the refractive index of the third lens 203 may be the highest among the lenses and may be greater than 1.6, for example, greater than 1.65. The fourth lens 204 may have the lowest refractive index among the lenses. For example, the refractive index of the fourth lens 204 may be less than 1.6, for example, less than 1.55. The difference between the maximum refractive index and the minimum refractive index may be 0.1 or more.

The refractive index of each lens can satisfy any one of the conditions below.

$$n 2 , n 3 , n 4 , n 5 , n 6 > n 1 = n 7 \qquad Condition 1$$

$$n 3 , n 5 , n 6 > n 2 > n 1 , n 4 , n 7 \qquad Condition 2$$

$$n 3 > n 1 , n 2 , n 4 , n 5 , n 6 , n 7 \qquad Condition 3$$

$$n 2 , n 3 , n 5 , n 6 > n 4 > n 1 , n 7 \qquad Condition 4$$

$$n 3 > n 5 = n 6 > n 1 , n 2 , n 4 , n 7 \qquad Condition 5$$

Comparing the Abbe numbers, the Abbe number of the fourth lens 204 is the largest among the lenses and may be 60 or greater. The Abbe number of at least one of the fifth lens 205 and the sixth lens 206 is the smallest among the lenses and may be 20 or less. The difference between the maximum refractive index and the minimum Abbe number may be 40 or greater.

The Abbe number of each lens can satisfy any one among the conditions below.

$$v 3 , v 4 > v 1 = v 7 > v 2 , v 5 , v 6 \qquad Condition 1$$

$$v 1 , v 3 , v 4 , v 7 > v 2 > v 5 , v 6 \qquad Condition 2$$

$$v 4 > v 3 > v 1 , v 2 , v 5 , v 6 , v 7 \qquad Condition 3$$

$$v 4 > v 1 , v 2 , v 3 , v 5 , v 6 , v 7 \qquad Condition 4$$

$$v 1 , v 2 , v3 , v 4 , v7 > v 5 = v 6 \qquad Condition 5$$

The focal lengths F2, F4, and F6 of the second, fourth, and sixth lenses 202, 204, and 206 may have positive (+) signs. The second, fourth, and sixth lenses 202, 204, and 206 may have positive (+) refractive power. The focal lengths F1, F3, and F5 of the first, third, and fifth lenses 201, 203, and 205 may have negative (−) signs. The first, third, and fifth lenses 201, 203, and 205 may have negative (−) refractive power.

When comparing the focal lengths in absolute values, the focal length of the first lens 201 is the largest among the lenses, and may be 90 or more and 110 or less. The focal length of the fourth lens 204 is the smallest among the lenses, and the absolute value of the focal length of the fourth lens 204 may be 3 or more and 5 or less.

The absolute value of the focal length of each lens can satisfy any one among the conditions below.

$$\vert f \vert > \vert f 2 \vert , \vert f 3 \vert , \vert f 4 \vert , \vert f 5 \vert , \vert f 6 \vert , \vert f 7 \vert \qquad Condition 1$$

$$\vert f 1 \vert , \vert f 5 \vert , \vert f 6 \vert , \vert f 7 \vert > \vert f 2 \vert > \vert f 3 \vert , \vert f 4 \vert \qquad Condition 2$$

$$\vert f 1 \vert , \vert f 2 \vert , \vert f 5 \vert , \vert f 6 \vert , \vert f 7 \vert > \vert f 3 \vert > \vert f 4 \vert \qquad Condition 3$$

$$\vert f 1 \vert , \vert f 2 \vert , \vert f 3 \vert , \vert f 5 \vert , \vert f 6 \vert , \vert f 7 \vert > \vert f 4 \vert \qquad Condition 4$$

$$\vert f 1 \vert , \vert f 6 \vert > \vert f 5 \vert > \vert f 2 \vert , \vert f 3 \vert , \vert f 4 \vert , \vert f 7 \vert \qquad Condition 5$$

$$\vert f 1 \vert > \vert f 6 \vert > \vert f 2 \vert , \vert f 3 \vert , \vert f 4 \vert , \vert f 5 \vert , \vert f 7 \vert \qquad Condition 6$$

$$\vert f 1 \vert , \vert f 5 \vert , \vert f 6 \vert > \vert f7 \vert > \vert f 2 \vert , \vert f 3 \vert , \vert f 4 \vert \qquad Condition 7$$

The composite focal length (f_G1) of the first lens group G1 may have a negative (−) sign. The first lens group G1 may have negative (−) composite refractive power. The composite focal length (f_G2) of the second lens group G2 may have a positive (+) sign. The second lens group G2 may have positive (+) composite refractive power. The composite focal length (f_G3) of the third lens group G3 may have a negative (−) sign. The third lens group G3 may have negative (−) composite refractive power. Through this, light incident from the object side can move away from the optical axis direction and then gather back on the optical axis direction, thereby forming a stable optical path.

When comparing the absolute values of the composite focal lengths of the first to third lens groups G1, G2, and G3, the composite focal length of the first lens group G1 may be the largest, and the composite focal length of the second lens group G2 may be the smallest. The relationship between the composite focal lengths of the first to third lens groups G1, G2, and G3 may satisfy |f_G1|>|f_G3|>|f_G2|.

The difference between the maximum thickness and the minimum thickness of the first lens 201 may be one time or more, for example, in the range of 1 to 1.3 times, and the center thickness CT1 may be a minimum and the edge thickness ET1 may be a maximum. The maximum thickness of the second lens 202 may be in the range of 2 to 2.5 times the minimum thickness. The second lens 202 may have a minimum center thickness CT2 and a maximum edge thickness ET2. The thickness T3 of the third lens 203 may be a minimum at the center and a maximum at the edge, with the maximum thickness being in the range of 2.5 to 3 times the minimum thickness. The thickness T4 of the fourth lens 204 may be a maximum at the center and a minimum at the edge, with the maximum thickness being in the range of 1 to 1.5 times the minimum thickness. The thickness T5 of the fifth lens 205 may be a minimum at the center and a maximum at the edge, with the maximum thickness being in the range of 1 to 1.5 times the minimum thickness. The thickness T6 of the sixth lens 206 may be a maximum at the center and a minimum at the edge, with the maximum thickness being in the range of 1 to 1.5 times the minimum thickness. The thickness T7 of the seventh lens 207 may be a minimum at the center and a maximum at the edge, with the maximum thickness being in the range of 1.5 to 2 times the minimum thickness.

The thickness of each lens can satisfy any one among the conditions below.

$$0.5 < CT 1 / ET 1 < 1 , 1 < ET 1 / CT 1 < 1.3 \qquad Condition 1$$

$$2 < CT 2 / ET 2 < 2.5 , 0.1 < ET 2 / CT 2 < 0.5 \qquad Condition 2$$

$$0.1 < CT 3 / ET 3 < 0.5 , 2 < ET 3 / CT 3 < 2.5 \qquad Condition 3$$

$$2.5 < CT 4 / ET 4 < 3 , 0.1 < ET 4 / CT 4 < 0.5 \qquad Condition 4$$

$$0.5 < CT 5 / ET 5 < 1 , 1 < ET 5 / CT 5 < 1.5 \qquad Condition 5$$

$$1 < CT 6 / ET 6 < 1.5 , 0.5 < ET 6 / CT 6 < 1 \qquad Condition 6$$

$$0.3 < CT 7 / ET 7 < 0.7 , 1.5 < ET 7 / CT 7 < 2 \qquad Condition 7$$

$$1 < Σ CT / Σ ET < 1.5 , 0.5 < Σ ET / Σ CT < 1 \qquad Condition 8$$

Among the gaps G1 to G6 between the lenses, the gap G1 between the first and second lenses 201 and 202 may have a maximum in the center and a minimum in the edge. The gap G2 between the second and third lenses 202 and 203 may have a maximum in the edge and a minimum in the center. The gap G3 between the third and fourth lenses 203 and 204 may have a maximum in the edge and a minimum in the center. The gap G4 between the fourth and fifth lenses 204 and 205 may have a maximum in the edge and a minimum in the center. The fifth gap G5 between the fifth and sixth lenses 205 and 206 may have a maximum in the center and a minimum in the edge. The sixth gap G6 between the sixth and seventh lenses 206 and 207 may have a minimum in the center and a maximum in the edge.

FIG. 11 and FIG. 13 are graphs showing the diffraction MTF (Modulation Transfer Function) at the wide-angle end (wide) and the telephoto end (tele) in the optical system of FIG. 8 and FIG. 9, and are graphs showing the luminance ratio (modulation) according to the spatial frequency. As shown in FIG. 11 and FIG. 13, the deviation of the MTF of the wide-angle end (wide) and the telephoto end (tele) at room temperature in the second embodiment of the invention may be less than 10%, that is, 7% or less.

FIG. 12 and FIG. 14 are graphs showing aberration characteristics at the wide-angle end (wide) and the telephoto end (tele) in the optical systems of FIG. 8 and FIG. 9. In the aberration graphs of FIG. 12 and FIG. 14, spherical aberration (longitudinal spherical aberration), astigmatic field curves, and distortion are measured from left to right. In FIG. 12 and FIG. 14, the X-axis may represent the focal length (mm) and the (degree) of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graph for astigmatism and distortion is a graph for light in wavelength bands of about 546 nm. In the aberration diagrams of FIGS. 12 and 14, the closer the curves at the wide-angle end (wide) and the telephoto end (tele) are to the Y-axis, the better the aberration correction function can be interpreted, so it can be seen that the optical system 1100 according to the second embodiment has measured values close to the Y-axis in almost all areas. That is, the optical system 1100 according to the second embodiment has improved resolution and can have good optical performance not only in the central portion of the field of view (FOV) but also in the peripheral portion.

An optical system according to a third embodiment of the invention will be described.

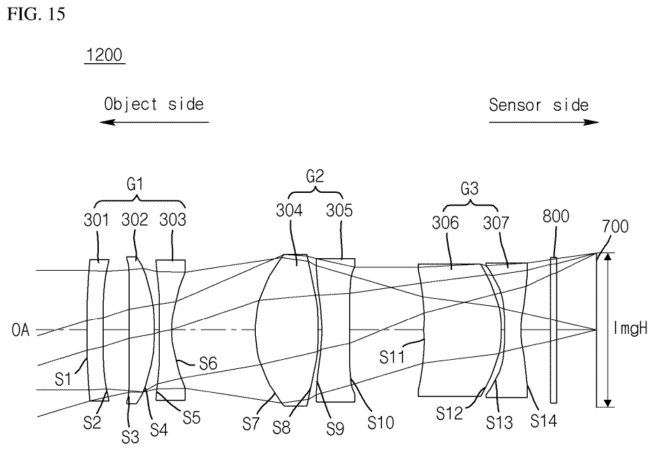

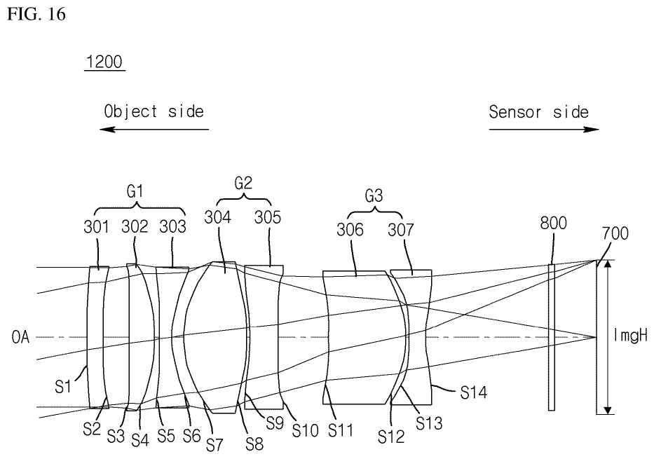

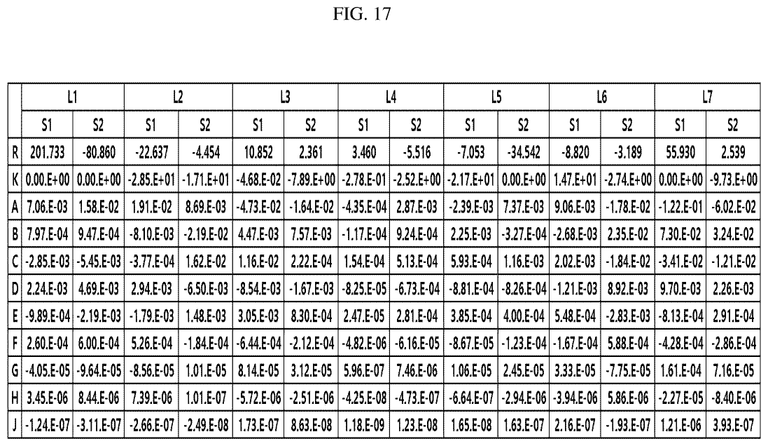

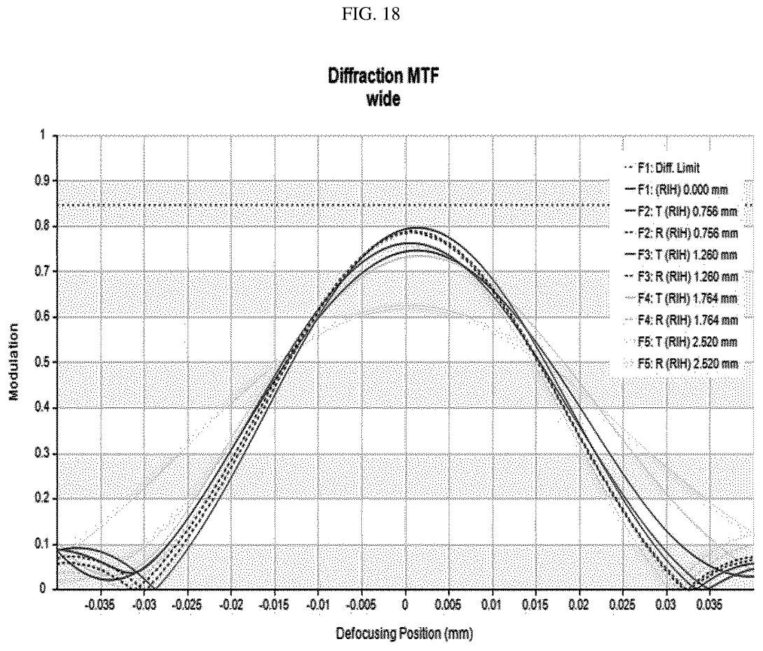

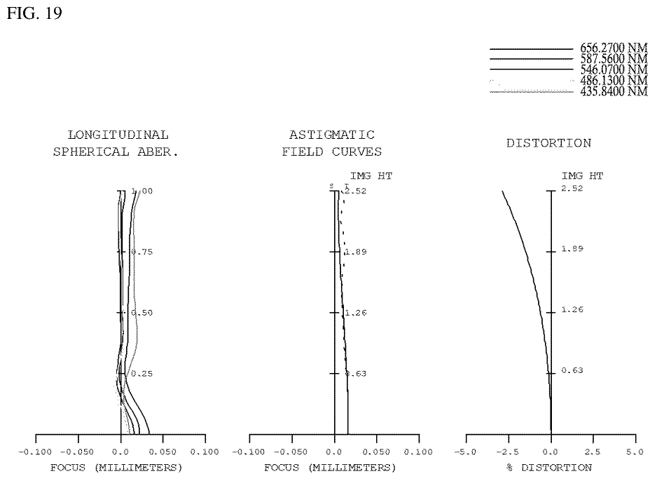

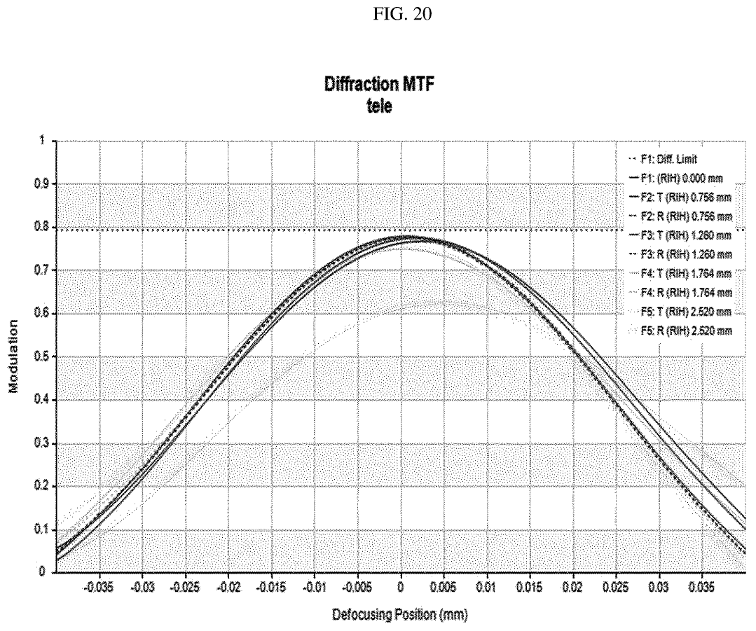

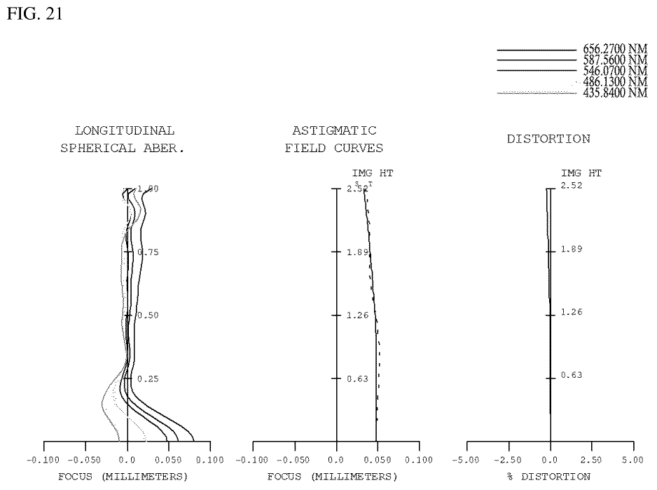

FIG. 15 is a diagram showing a configuration of an optical system operating in a first mode according to a third embodiment; FIG. 16 is a diagram showing the configuration of an optical system operating in a second mode according to a third embodiment; FIG. 17 is a table showing aspherical coefficients of lenses in an optical system operating in a third embodiment; FIG. 18 is a graph showing data on the diffraction MTF (Modulation Transfer Function) at room temperature of an optical system according to a third embodiment operating in a first mode; FIG. 19 is a graph showing data on aberration characteristics of an optical system according to a third embodiment operating in a first mode; FIG. 20 is a graph showing data on diffraction MTF (Modulation Transfer Function) at room temperature of an optical system according to a third embodiment operating in a second mode; and FIG. 21 is a graph showing data on aberration characteristics of an optical system according to a third embodiment operating in a second mode.

Referring to FIGS. 15 and 16, the optical system 1200 includes a lens unit, and the lens unit may include a first lens 301 to a seventh lens 307. The first to seventh lenses 301 to 307 may be sequentially disposed along the optical axis OA of the optical system 1200. Light corresponding to information about an object may pass through the first to seventh lenses 301 to 307 and the filter 800 and be incident on the image sensor 700.

The first lens 301 may be disposed closest to the object side. The first lens 301 may be disposed furthest from the sensor side. The first lens 301 may have positive refractive power on the optical axis OA. The first lens 301 may include a plastic material or a glass material, and may be, for example, a plastic material.

The object-side first surface S1 of the first lens 301 may be convex with respect to the optical axis, and the sensor-side second surface S2 may be convex. The first lens 301 may have a convex shape on both sides. The first lens 301 may be made of a plastic material and may have an aspherical surface. The aspherical coefficients of the first and second surfaces S1 and S2 may be provided as L1S1, L1S2 of FIG. 17.

The refractive index (n1) of the first lens 301 can satisfy the condition of n1>1.5, preferably n1>1.55. If the refractive index (n1) of the first lens 301 is less than the condition, the lens surface must be formed sharply concave or convex in order to increase the refractive power of the first and second lenses 301 and 302. In this case, lens manufacturing is not easy, the lens defect rate increases, and it may cause a decrease in yield.

The second lens 302 may be disposed second from the object side. The second lens 302 may be disposed sixth from the sensor side. The second lens 302 may be disposed between the first lens 301 and the third lens 303. The second lens 302 may have positive refractive power on the optical axis OA. The second lens 302 may have different refractive power from the first lens 301 on the optical axis OA. The second lens 302 may include a plastic or glass material. For example, the second lens 302 may be provided as a plastic material.

The third surface S3 on the object side of the second lens 302 may be concave with respect to the optical axis OA, and the fourth surface S4 on the sensor side may be convex. The second lens 302 may have a concave meniscus shape toward the object side. The second lens 302 may have a convex meniscus shape toward the sensor side. The second lens 302 may be made of a plastic material and may have an aspherical surface. The aspherical coefficients of the third and fourth surfaces S3 and S4 may be provided as L2S1 and L2S2 of FIG. 17.

The third lens 303 may be disposed third from the object side. The third lens 303 may be disposed fifth from the sensor side. The third lens 303 may be disposed between the second lens 302 and the fourth lens 304. The third lens 303 may have negative (−) refractive power on the optical axis OA. The third lens 303 may include a plastic or glass material. For example, the third lens 303 may be provided as a glass material.

The fifth surface S5 on the object side of the third lens 303 with respect to the optical axis may be convex, and the sixth surface S6 on the sensor side may be concave. The third lens 303 may have a convex meniscus shape toward the object side. The third lens 303 may have a concave meniscus shape toward the sensor side. The third lens 303 is made of glass and may have an aspherical surface. The third lens 303 may be made of a glass mold (GM) material. The aspherical coefficients of the fifth and sixth surfaces S5 and S6 may be provided as L3S1 and L3S2 of FIG. 17.

The aperture (STOP) may be disposed around the sensor-side sixth surface S6 of the third lens 303. The aperture (STOP) may be disposed around the object-side seventh surface S7 of the fourth lens 303. The aperture can reduce the TTL within the field of view range, and miniaturization of the optical system is possible. Accordingly, a decrease in the yield by weight of the optical system can be prevented, and production efficiency can be improved. In addition, the optical system can be miniaturized by reducing the TTL within the diagonal field of view (FOV_D) of 20 to 40 degrees.

The lens closest to the aperture (STOP) may be made of glass. The third lens 303 closest to the object side of the aperture (STOP) and the fourth lens 304 closest to the sensor side of the aperture (STOP) may be made of glass. Since the lens closest to the aperture (STOP) is a sensitive lens that affects the entire optical system, a lens made of glass may be disposed to minimize the effect of temperature changes. The two lenses closest to the aperture (STOP) may have different refractive powers. The third lens 303 may have positive (+) refractive power, and the fourth lens 304 may have negative (−) refractive power.

In the entire optical system 1200, the focal length of the lens made of glass may be the shortest. In the entire optical system 1200, the refractive power of the lens made of glass may be the greatest. The fourth lens 304 made of glass may have the shortest focal length. The fourth lens 304 made of glass may have the greatest refractive power. The difference in Abbe numbers between the two lenses closest to the aperture (STOP) may be greater than 25 and less than 35. One of the lenses closest to the aperture (STOP) may have the largest Abbe number in the optical system 1200. By arranging the two lenses with a large Abbe number difference adjacent to the aperture (STOP), the occurrence of chromatic aberration noise may be reduced.

The fourth lens 304 may be disposed fourth from the object side. The fourth lens 304 may be disposed fourth from the sensor side. The fourth lens 304 may be disposed between the third lens 303 and the fifth lens 305. The fourth lens 304 may have positive (+) refractive power. The fourth lens 304 may include a plastic or glass material. For example, the fourth lens 304 may be provided as a glass material.

The object-side seventh surface S7 of the fourth lens 304 with respect to the optical axis may be convex, and the sensor-side eighth surface S8 may be convex. The fourth lens 304 may have a convex shape on both sides. The fourth lens 304 may be made of glass and may have an aspherical surface. The fourth lens 304 may be made of glass mold (GM) material. The aspherical coefficients of the seventh and eighth surfaces S7 and S8 may be provided as L4S1 and L4S2 of FIG. 17.

The fifth lens 305 may be disposed as the fifth lens from the object side. The fifth lens 305 may be disposed as the third lens from the sensor side. The fifth lens 305 may be disposed between the fourth lens 304 and the sixth lens 306. The fifth lens 305 may have positive (+) or negative (−) refractive power on the optical axis OA. The fifth lens 305 may have negative (−) refractive power. The fifth lens 305 may include a plastic or glass material. For example, the fifth lens 305 may be provided as a plastic material.

With respect to the optical axis OA, the ninth surface S9 on the object side of the fifth lens 305 may be concave, and the tenth surface S10 on the sensor side may be convex. The fifth lens 305 may have a convex meniscus shape toward the sensor side. The fifth lens 305 may have a concave meniscus shape toward the object side. The fifth lens 305 is made of a plastic material and may have an aspherical surface. The aspherical coefficients of the ninth and tenth surfaces S9 and S10 may be provided as L5S1 and L5S2 of FIG. 17.

The sixth lens 306 may be disposed as the sixth lens from the object side. The sixth lens 306 may be disposed as the second lens from the sensor side. The sixth lens 306 may have positive (+) refractive power. The sixth lens 306 may include a plastic or glass material. For example, the sixth lens 306 may be provided as a plastic material.

With respect to the optical axis OA, the eleventh surface S11 on the object side of the sixth lens 306 may be concave, and the twelfth surface S12 on the sensor side may be convex. The sixth lens 306 may have a concave meniscus shape toward the object side. The sixth lens 306 may have a convex meniscus shape toward the sensor side. At least one or both of the eleventh surface S11 and the twelfth surface S12 may be aspherical. The aspherical coefficients of the eleventh and twelfth surfaces S11 and S12 may be provided as L6S1 and L6S2 of FIG. 17.

The seventh lens 307 may be disposed closest to the sensor side. The seventh lens 307 may be disposed furthest from the object side. The seventh lens 307 may have negative refractive power. The seventh lens 307 may include a plastic or glass material. For example, the seventh lens 307 may be provided as a plastic material.

With respect to the optical axis OA, the thirteenth surface S13 on the object side of the seventh lens 307 may be convex, and the fourteenth surface S14 on the sensor side may be concave. The seventh lens 307 may have a meniscus shape that is convex on the object side. At least one or both of the thirteenth surface S13 and the fourteenth surface S14 may be aspherical. The aspherical coefficients of the thirteenth and fourteenth surfaces S13 and S14 may be provided as L7S1 and L7S2 of FIG. 17.

TABLE 7

| | | | | | | Semi | Focal |
|---|---|---|---|---|---|---|---|
| Lens | Surface | Radius | Thickness | nd | vd | Aperture | length |
| 1 | S1 | 201.733 | 0.550 | 1.615 | 25.960 | 2.320 | 93.080 |
| | S2 | −80.860 | 0.874 | | | 2.291 | |
| 2 | S3 | −22.637 | 0.818 | 1.661 | 20.357 | 2.343 | 8.142 |
| | S4 | −4.454 | 0.163 | | | 2.400 | |
| 3 | S5 | 10.852 | 0.420 | 1.689 | 31.161 | 2.293 | −4.437 |
| | S6(STOP) | 2.361 | Variable(D1) | | | 1.887 | |
| 4 | S7 | 3.460 | 2.093 | 1.589 | 61.251 | 2.480 | 3.937 |
| | S8 | −5.516 | 0.100 | | | 2.437 | |
| 5 | S9 | −7.053 | 0.941 | 1.671 | 19.246 | 2.332 | −13.226 |
| | S10 | −34.542 | Variable(D2) | | | 2.059 | |
| 6 | S11 | −8.820 | 2.561 | 1.671 | 19.246 | 2.043 | 6.208 |
| | S12 | −3.189 | 0.100 | | | 2.174 | |
| 7 | S13 | 55.930 | 0.542 | 1.615 | 25.960 | 2.096 | −4.303 |
| | S14 | 2.539 | Variable(D3) | | | 2.208 | |
| Filter | | Infinity | 0.210 | | | 2.380 | |
| | | Infinity | 1.327 | | | 2.392 | |
| Image | | Infinity | | | | 2.520 | |

Table 7 shows the surface number (Surface), radius of curvature (Radius), center thickness of each lens or distance between lens surfaces (Thickness), refractive index (Index,nd), Abbe number (Abbe,vd), effective radius (Semi Aperture), and focal length (Focal length) of the lens according to the third embodiment of the present invention. At this time, the unit of the radius of curvature and thickness or distance may be mm.

TABLE 8

| | wide | middle | tele |
|---|---|---|---|
| D1 | 2.774 | 1.682 | 0.400 |
| D2 | 2.464 | 1.778 | 1.650 |
| D3 | 0.979 | 2.782 | 4.077 |

Table 8 shows the gaps D1, D2, and D3 between lenses that are variable when the optical system according to a third embodiment of the present invention operates in any one among the wide-angle end (wide), intermediate end (middle), and telephoto end (tele) modes. Here, the wide-angle end (wide) may refer to the first mode, and the telephoto end (tele) may refer to the second mode. The wide-angle end may be referred to as wide angle, and the telephoto end may be referred to as telephoto.

In the optical system according to a third embodiment of the present invention, the distance between adjacent lens groups may change during the process of changing the magnification from the wide-angle end to the intermediate end and then to the telephoto end. The first lens group G1 is fixed, and only the second and third lens groups G2 and G3 can move. The first lens group G1 may be a fixed group, and the second and third lens groups G2 and G3 may be movable groups.

When operating from the wide-angle end to the intermediate end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the intermediate end to the telephoto end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the wide-angle end to the telephoto end, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

The stroke length of the second lens group G2 can satisfy 2 mm to 3 mm, and preferably can satisfy about 2.374 mm. The stroke length of the third lens group G3 can satisfy 2.5 mm to 3.5 mm, and preferably can satisfy about 3.189 mm. The stroke length of the second lens group G2 can be smaller than the stroke length of the third lens group G3. The second lens group G2 and the third lens group G3 can have different moving speeds. The moving speed of the third lens group G3 can be greater than the moving speed of the second lens group G2.

By moving the second lens group G2 and the third lens group G3, the magnification of the zoom optical system can be continuously adjusted from about 3 times to about 5 times. Here, the magnification can mean the ratio of the focal lengths of the optical system according to the embodiment in the moving terminal to the being disposed reference optical system. In the first embodiment, the magnifications of the wide-angle end and the telephoto end can satisfy a range of 1 times to 2 times, and can satisfy a magnification of about 1.7 times.

TABLE 9

| | | | |
|---|---|---|---|
| EFL(f)_wide | 8.410 | EFL(f)_tele | 13.540 |
| FOV_wide | 34.3400 | FOV_tele | 21.2400 |
| EPD_wide | 3.9017 | EPD_tele | 4.5755 |
| BFL_wide | 2.5000 | BFL_tele | 5.6887 |
| TD_wide | 14.4000 | TD_tele | 11.2114 |
| SD_wide | 11.5750 | SD_tele | 8.3864 |
| Fno_wide | 2.155 | Fno_tele | 2.959 |
| ET1 | 0.6237 | f_G1 | −12.628 |
| ET2 | 0.3178 | f_G2 | 5.141 |
| ET3 | 0.9256 | f_G3 | −12.238 |
| ET4 | 0.7526 | G2_stroke | 2.374 |
| ET5 | 1.2431 | G3_stroke | 3.189 |
| ET6 | 2.0544 | TTL | 16.900 |
| ET7 | 1.2268 | ImgH | 5.040 |
| ΣIndex | 11.512 | CA_Max | 4.960 |
| ΣAbbe | 203.181 | CA_Min | 3.774 |
| ΣCT | 7.924 | CA_Aver | 4.480 |
| ΣCG | 7.455 | L_CT_max | 2.561 |
| | | L_CT_min | 0.420 |
| | | L_CT_aver | 1.132 |
| | | Air_max | 2.774 |

Table 9 shows the items of the Mathematical expressions described above in the optical system 1200 of the third embodiment, including the effective focal length (F) (mm), BFL (Back Focal Length) (mm), EPD (mm), SD (mm), Fno, FOV (degree) which is the optical axis distance from the aperture (STOP) to the twelfth surface S12 at each of the wide-angle end (wide) and the telephoto end (tele) of the optical system 1200, and the focal lengths (f1 to f6) (mm), edge thicknesses ET1 to ET6 of the first to seventh lenses 301 to 307, the focal lengths (f_G1, f_G2, and f_G3) (mm) of the first to third lens groups G1, G2, and G3, the stroke length (G2_stroke) of the second lens group G2, the stroke length (G3_stroke) of the third lens group G3, and the entire optical system 1200. This is for the optical axis distance TTL (mm), ImgH (mm), maximum effective diameter (CA_Max), minimum effective diameter (CA_Min), average effective diameter (CA_Aver), maximum center thickness (L_CT_max), minimum center thickness (L_CT_min), average center thickness (L_CT_aver) among the first to seventh lenses 301 to 307, and maximum value among adjacent lens gaps (Air_max).

The center thicknesses of the first to seventh lenses 301 to 307 are represented by CT1 to CT7, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. The BFL (Back focal length) is the optical axis distance from the image sensor 700 to the center of the last lens. The TTL is the optical axis distance from the center of the first surface S1 of the first lens 301 to the upper surface of the image sensor 700.

When comparing the absolute values of the curvature radius of each lens, the curvature radius of the first surface S1 of the first lens 301 on the optical axis OA may be the largest among the lenses, and the curvature radius of the sixth surface S6 of the third lens 303 may be the smallest among the lenses. The difference between the maximum and minimum curvature radius may be 80 times or more, for example, in the range of 90 to 120 times. The absolute value of the curvature radius of the first surface S1 of the first lens 301 may be larger than the absolute value of the curvature radius of the second surface S2. The absolute value of the curvature radius of the third surface S3 of the second lens 302 may be larger than the absolute value of the curvature radius of the fourth surface S4. The absolute value of the curvature radius of the fifth surface S5 of the third lens 303 may be larger than the absolute value of the curvature radius of the sixth surface S6. The absolute value of the curvature radius of the seventh surface S7 of the fourth lens 304 may be smaller than the absolute value of the curvature radius of the eighth surface S8. The absolute value of the curvature radius of the ninth surface S9 of the fifth lens 305 may be smaller than the absolute value of the curvature radius of the tenth surface S10. The absolute value of the curvature radius of the eleventh surface S11 of the sixth lens 306 may be larger than the absolute value of the curvature radius of the twelfth surface S12. The absolute value of the curvature radius of the thirteenth surface S13 of the seventh lens 307 may be larger than the absolute value of the curvature radius of the fourteenth surface S14.

The ratio of the radius of curvature of each lens can satisfy the following conditions.

$$2 < \vert L 1 R 1 / L 1 R 2 \vert < 3 \qquad Condition 1$$

$$3 < \vert L 2 R 1 / L 2 R 2 \vert < 7 \qquad Condition 2$$

$$3 < \vert L 3 R 1 / L 3 R 2 \vert < 5 \qquad Condition 3$$

$$0.3 < \vert L 4 R 1 / L 4 R 2 \vert < 0.8 \qquad Condition 4$$

$$0.1 < \vert L 5 R 1 / L 5 R 2 \vert < 0.3 \qquad Condition 5$$

$$1 < L 6 R 1 / L 6 R 2 < 5 \qquad Condition 6$$

$$20 < L 7 R 1 / L 7 R 2 < 25 \qquad Condition 7$$

When describing the center thickness of the lenses based on the optical axis, the center thickness CT6 of the sixth lens 306 is the largest among the lenses, and the center thickness CT3 of the third lens 303 is the smallest among the lenses. The difference between the maximum and minimum center thicknesses among the lenses may be in the range of 1.5 mm or more and 3 mm or less.

The center thickness of each lens can satisfy any one among the conditions below.

$$CT 2 , CT 4 , CT 5 , CT 6 > CT 1 > CT 3 , CT 7 \qquad Condition 1$$

$$CT 4 , CT 5 , CT 6 > CT 2 > CT 1 , CT 3 , CT 7 \qquad Condition 2$$

$$CT 1 , CT 2 , CT 4 , CT 5 , CT 6 , CT 7 > CT 3 \qquad Condition 3$$

$$CT 6 > CT 4 > CT 1 , CT 2 , CT 3 , CT 5 , CT 7 \qquad Condition 4$$

$$CT 4 , CT 6 > CT 5 > CT 1 , CT 2 , CT 3 , CT 7 \qquad Condition 5$$

$$CT 6 > CT 1 , CT 2 , CT 3 , CT 4 , CT 5 , CT 7 \qquad Condition 6$$

$$CT 1 , CT 2 , CT 4 , CT 5 , CT 6 > CT 7 > CT 3 \qquad Condition 7$$

When zooming, the gap CG1 between the first lens 301 and the second lens 302, the gap CG2 between the second lens 302 and the third lens 303, the gap CG4 between the fourth lens 304 and the fifth lens 305, and the gap G6 between the sixth lens 306 and the sixth lens 307 do not change, while the gap CG3 between the third lens 303 and the fourth lens 304 and the gap CG5 between the fifth lens 305 and the sixth lens 306 may change. Among the center gaps between the unchanging lenses, the center gap CG1 between the first lens 301 and the second lens 302 may be the maximum, and the center gap CG5 between the fourth lens 304 and the fifth lens 305 and the center gap CG6 between the sixth lens 306 and the seventh lens 307 may be the minimum. The difference between the maximum center gap and the minimum center gap among the spaced lens gaps may be 2.5 mm or more, for example, in the range of 2.6 mm to 3 mm.

The center gap between each lens may satisfy the following condition.

$$CG 1 > CG 2 > CG 4 = CG 6 \qquad Condition 1$$

When explaining the effective diameter, the lens having the maximum effective diameter may be the fourth lens 304. Here, the effective diameter is the average of the effective diameters of the object-side surface and the sensor-side surface of each lens. The lens surface having the maximum effective diameter may be the seventh surface S7 of the fourth lens 304. The lens having the minimum effective diameter may be the third lens 303. The lens surface having the minimum effective diameter may be the sixth surface S6 of the third lens 303.

The average effective diameter of the first to seventh lenses 301 to 307 may be smaller than the diagonal length of the image sensor 700. Accordingly, light incident through a plurality of lenses aligned along the optical axis can be guided to the image sensor 700.

The effective diameter of each lens can satisfy any one among the conditions below.

$$CA\_L2 , CA\_L4 > CA\_L1 > CA\_L3 , CA\_L5 , CA\_L6 , CA\_L7 \qquad Condition 1$$

$$CA\_L4 > CA\_L2 > CA\_L1 , CA\_L3 , CA\_L5 , CA\_L6 , CA\_L7 \qquad Condition 2$$

$$CA\_L1 , CA\_L2 , CA\_L4 , CA\_L5 , CA\_L6 , CA\_L7 > CA\_L3 \qquad Condition 3$$

$$CA\_L4 > CA\_L1 , CA\_L2 , CA\_L3 , CA\_L5 , CA\_L6 , CA\_L7 \qquad Condition 4$$

$$CA\_L1 , CA\_L2 , CA\_L4 > CA\_L5 > CA\_L3 , CA\_L6 , CA\_L7 \qquad Condition 5$$

$$CA\_L1 , CA\_L2 , CA\_L4 , CA\_L5 , CA\_L7 > CA\_L6 > CA\_L3 \qquad Condition 6$$

$$CA\_L1 , CA\_L2 , CA\_L4 , CA\_L5 > CA\_L7 > CA\_L3 , CA\_L6 \qquad Condition 7$$

When explaining the refractive index, the refractive index of the third lens 203 may be the highest among the lenses and may be greater than 1.6, for example, greater than 1.65. The fourth lens 204 may have the lowest refractive index among the lenses. For example, the refractive index of the fourth lens 204 may be less than 1.6, for example, less than 1.55. The difference between the maximum refractive index and the minimum refractive index may be 0.1 or more.

The refractive index of each lens can satisfy any one of the conditions below.

$$n 2 , n 3 , n 5 , n 6 > n 1 = n 7 > n 4 \qquad Condition 1$$

$$n 3 , n 5 , n 6 > n 2 > n 1 , n 4 , n 7 \qquad Condition 2$$

$$n 3 > n 1 , n 2 , n 4 , n 5 , n 6 , n 7 \qquad Condition 3$$

$$n 1 , n 2 , n 3 , n 5 , n 6 , n 7 > n 4 \qquad Condition 4$$

$$n 3 > n 5 = n 6 > n 1 , n 2 , n 4 , n 7 \qquad Condition 5$$

Comparing the Abbe numbers, the Abbe number of the fourth lens 304 is the largest among the lenses and may be 60 or greater. The Abbe number of at least one of the fifth lens 305 and the sixth lens 306 is the smallest among the lenses and may be 20 or less. The difference between the maximum refractive index and the minimum Abbe number may be 40 or greater.

The Abbe number of each lens can satisfy any one among the conditions below.

$$v 3 , v 4 > v 1 = v 7 > v 2 , v 5 , v 6 \qquad Condition 1$$

$$v 1 , v 3 , v 4 , v 7 > v 2 > v 5 , v 6 \qquad Condition 2$$

$$v 4 > v 3 > v 1 , v 2 , v 5 , v 6 , v 7 \qquad Condition 3$$

$$v 4 > v 1 , v 2 , v 3 , v 5 , v 6 , v 7 \qquad Condition 4$$

$$v 1 , v 2 , v 3 , v 4 , v 7 > v 5 = v 6 \qquad Condition 5$$

The focal lengths F1, F2, F4, and F6 of the first, second, fourth, and sixth lenses 301, 302, 304, and 306 can have positive (+) signs. The first, second, fourth, and sixth lenses 301, 302, 304, and 306 can have positive (+) refractive power. The focal lengths F3 and F5 of the third and fifth lenses 303 and 305 can have negative (−) signs. The third and fifth lenses 303 and 305 can have negative (−) refractive power.

When comparing the focal lengths in absolute values, the focal length of the first lens 301 is the largest among the lenses, and may be 90 or more and 110 or less. The focal length of the fourth lens 304 is the smallest among the lenses, and the absolute value of the focal length of the fourth lens 304 may be 3 or more and 5 or less.

The absolute value of the focal length of each lens can satisfy any one among the conditions below.

$$\vert f 1 \vert > \vert f 2 \vert , \vert f 3 \vert , \vert f 4 \vert , \vert f 5 \vert , \vert f 6 \vert , \vert f 7 \vert \qquad Condition 1$$

$$\vert f 1 \vert , \vert f 5 \vert > \vert f 2 \vert > \vert f 3 \vert , \vert f 4 \vert , \vert f 6 \vert , \vert f 7 \vert \qquad Condition 2$$

$$\vert f 1 \vert , \vert f 2 \vert , \vert f 5 \vert , \vert f 6 \vert > \vert f 3 \vert > \vert f 4 \vert , \vert f 7 \vert \qquad Condition 3$$

$$\vert f 1 \vert , \vert f 2 \vert , \vert f 3 \vert , \vert f 5 \vert , \vert f 6 \vert , \vert f 7 \vert > \vert f 4 \vert \qquad Condition 4$$

$$\vert f 1 \vert > \vert f 5 \vert > \vert f 2 \vert , \vert f 3 \vert , \vert f 4 \vert , \vert f 6 \vert , \vert f 7 \vert \qquad Condition 5$$

$$\vert f 1 \vert , \vert f 2 \vert , \vert f 5 \vert > \vert f 6 \vert > \vert f 3 \vert , \vert f 4 \vert , \vert f 7 \vert \qquad Condition 6$$

$$\vert f 1 \vert , \vert f 2 \vert , \vert f 3 \vert , \vert f 5 \vert , \vert f 6 \vert > \vert f 7 \vert > \vert f 4 \vert \qquad Condition 7$$

The composite focal length (f_G1) of the first lens group G1 may have a negative (−) sign. The first lens group G1 may have negative (−) composite refractive power. The composite focal length (f_G2) of the second lens group G2 may have a positive (+) sign. The second lens group G2 may have positive (+) composite refractive power. The composite focal length (f_G3) of the third lens group G3 may have a negative (−) sign. The third lens group G3 may have negative (−) composite refractive power. Through this, light incident from the object side can move away from the optical axis direction and then gather back on the optical axis direction, thereby forming a stable optical path.

When comparing the absolute values of the composite focal lengths of the first to third lens groups G1, G2, and G3, the composite focal length of the first lens group G1 may be the largest, and the composite focal length of the second lens group G2 may be the smallest. The relationship between the composite focal lengths of the first to third lens groups G1, G2, and G3 may satisfy |f_G1|>|f_G3|>|f_G2|.

The difference between the maximum and minimum thickness T1 of the first lens 301 may be 1 times or more, for example, in the range of 1 time to 1.3 times, and its center thickness CT1 may be a minimum and its edge thickness ET1 may be a maximum. The maximum thickness T2 of the second lens 302 may be in the range of 2.3 times to 2.7 times the minimum thickness. The second lens 302 may have a minimum center thickness (CT2) and a maximum edge thickness (ET2). The thickness T3 of the third lens 303 may be a minimum at the center and a maximum at the edge, with the maximum thickness being in the range of 2.5 times to 3 times the minimum thickness. The thickness T4 of the fourth lens 304 may be a maximum at the center and a minimum at the edge, with the maximum thickness being in the range of 1 time to 1.5 times the minimum thickness. The thickness T5 of the fifth lens 305 may be a minimum at the center and a maximum at the edge, with the maximum thickness being in the range of 1 time to 1.5 times the minimum thickness. The thickness T6 of the sixth lens 306 may be a maximum at the center and a minimum at the edge, with the maximum thickness being in the range of 1 time to 1.5 times the minimum thickness. The thickness T7 of the seventh lens 307 may be a minimum at the center and a maximum at the edge, with the maximum thickness being in the range of 2 times to 2.5 times the minimum thickness.

The thickness of each lens can satisfy any one among the conditions below.

$$0.5 < C T 1 / E T 1 < 1 , 1 < E T 1 / C T 1 < 1.3 \qquad Condition 1$$

$$2.3 < C T 2 / ET 2 < 2.7 , 0.1 < E T 2 / CT 2 < 0.5 \qquad Condition 2$$

$$0.1 < C T 3 / ET 3 < 0.5 , 2 < E T 3 / CT 3 < 2.5 \qquad Condition 3$$

$$2.5 < C T 4 / ET 4 < 3 , 0.1 < E T 4 / CT 4 < 0.5 \qquad Condition 4$$

$$0.5 < C T 5 / ET 5 < 1 , 1 < E T 5 / CT 5 < 1.5 \qquad Condition 5$$

$$1 < CT 6 / ET 6 < 1.5 , 0.5 < E T 6 / CT 6 < 1 \qquad Condition 6$$

$$0.1 < C T 7 / ET 7 < 0.5 , 2 < E T 7 / CT 7 < 2.5 \qquad Condition 7$$

$$1 < ΣC T / Σ ET < 1.5 , 0.5 < Σ E T / Σ CT < 1 \qquad Condition 8$$

Among the gaps G1 to G6 between the lenses, the gap G1 between the first and second lenses 301 and 302 may have a maximum in the center and a minimum in the edge. The gap G2 between the second and third lenses 302 and 303 may have a maximum in the edge and a minimum in the center. The gap G3 between the third and fourth lenses 303 and 304 may have a maximum in the edge and a minimum in the center. The gap G4 between the fourth and fifth lenses 304 and 305 may have a maximum in the edge and a minimum in the center. The fifth gap G5 between the fifth and sixth lenses 305 and 306 may have a maximum in the center and a minimum in the edge. The sixth gap G6 between the sixth and seventh lenses 306 and 307 may have a minimum in the center and a maximum in the edge.

FIG. 18 and FIG. 20 are graphs showing the diffraction MTF (Modulation Transfer Function) at the wide-angle end (wide) and the telephoto end (tele) in the optical system of FIG. 15 and FIG. 16, and are graphs showing the luminance ratio (modulation) according to the spatial frequency. As shown in FIG. 18 and FIG. 20, the deviation of the MTF of the wide-angle end (wide) and the telephoto end (tele) at room temperature in the second embodiment of the invention may be less than 10%, that is, 7% or less.

FIG. 19 and FIG. 21 are graphs showing aberration characteristics at the wide-angle end (wide) and the telephoto end (tele) in the optical systems of FIG. 15 and FIG. 16. In the aberration graphs of FIG. 19 and FIG. 21, spherical aberration (longitudinal spherical aberration), astigmatic field curves, and distortion are measured from left to right. In FIG. 19 and FIG. 21, the X-axis may represent the focal length (mm) and the (degree) of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graph for astigmatism and distortion is a graph for light in wavelength bands of about 546 nm. In the aberration diagrams of FIG. 19 and FIG. 21, the closer the curves at the wide-angle end (wide) and the telephoto end (tele) are to the Y-axis, the better the aberration correction function can be interpreted, so it can be seen that the optical system 1200 according to the third embodiment has measured values close to the Y-axis in almost all areas. That is, the optical system 1200 according to the third embodiment has improved resolution and can have good optical performance not only in the central portion of the field of view (FOV) but also in the peripheral portion.

The optical systems 1000, 1100, and 1200 according to the first to third embodiment disclosed above can satisfy at least one or two or more of the Mathematical expressions described below. Accordingly, the optical systems 1000, 1100, and 1200 according to the first to third embodiment can have improved optical characteristics. For example, when the optical systems 1000, 1100, and 1200 satisfy at least one Mathematical expression, the optical systems 1000, 1100, and 1200 can effectively control aberration characteristics such as chromatic aberration and distortion aberration, and can have good optical performance not only at the center of the field of view (FOV) but also at the peripheral portion. In addition, the optical systems 1000, 1100, and 1200 can have improved resolution. In addition, the thickness at the optical axis OA of the lens described in the Mathematical expressions and the gap at the optical axis OA of adjacent lenses may refer to the first to third embodiments disclosed above.

$$0.5 < f\_tele / f\_wide < 1 \qquad [ Mathematical expression 1 ]$$

Mathematical expression 1 can set the relationship between the total focal length (f_tele) of the optical systems 1000, 1100, and 1200 at the telephoto end (tele) and the total focal length (f_wide) of the optical systems 1000, 1100, and 1200 at the wide-angle end (wide). f_tele/f_wide can be referred to as the magnification ratio or zoom ratio of the zoom lens optical system. Mathematical expression 1 is a condition for limiting the zoom optical performance.

If the upper limit of Mathematical expression 1 is exceeded, it is difficult to secure optical performance due to chromatic aberration at the telephoto end (tele), and the amount of movement of each lens group increases significantly during zooming, making mechanical miniaturization difficult. If the lower limit of Mathematical expression 1 is less than the lower limit of Mathematical expression 1, it is difficult to secure performance as a zoom optical system. A zoom optical system satisfying Mathematical expression 1 can secure practically useful optical performance. Mathematical expression 1 can preferably satisfy 0.5<f_tele/f_wide<0.8 in the first to third embodiments.

$$0.3 < \vert f\_G2 / f\_G1 \vert < 0.7 \qquad [ Mathematical expression 2 ]$$

Mathematical expression 2 can establish the relationship between the focal length (f_G1) of the first lens group G1 and the focal length (f_G2) of the second lens group G2. Mathematical expression 2 is a condition for reducing aberrations and improving optical performance.

The first lens group G1 and the second lens group G2 that satisfy Mathematical expression 2 can appropriately correct astigmatism and coma aberrations. In addition, the zoom optical system has a zoom magnification of 3× to 5× and can reduce the overall length of the optical system. Mathematical expression 2 preferably satisfies 0.3<|f_G2/f_G1|<0.5 in the first to third embodiments.

$$0.3 < \vert f\_G1 / f\_wide \vert < 1.7 \qquad [ Mathematical expression 3 ]$$

Mathematical expression 3 can set the relationship between the focal length (f_G1) of the first lens group G1 and the overall focal length (f_wide) of the optical systems 1000, 1100, and 1200 at the wide-angle end (wide). Mathematical expression 3 is a condition for limiting the magnitude of the refractive power of the first lens group G1.

If the upper limit of Mathematical expression 3 is exceeded, the first lens group G1 has a weak refractive power, making it difficult to secure a back focal length and thus obtaining a clear image. If the lower limit of Mathematical expression 3 is less than the lower limit of Mathematical expression 3, the first lens group G1 has a strong refractive power, making it difficult to correct field curvature aberration at the wide-angle position, spherical aberration at the telephoto position, and coma aberration. Mathematical expression 3 can preferably satisfy 1.3<|f_G1/f_wide|<1.6 in the first to third embodiment.

$$0.5 < f\_G2 / f\_wide < 1 \qquad [ Mathematical expression 4 ]$$

In Mathematical expression 4, the relationship between the focal length (f_G2) of the second lens group G2 and the overall focal length (f_wide) of the optical systems 1000, 1100, and 1200 in the first mode, the wide-angle end (wide), can be established. Mathematical expression 4 is a condition for limiting the size of the refractive power of the second lens group G2.

If the upper limit of Mathematical expression 4 is exceeded, the movement amount of the second lens group G2 for zoom operation may be large. If the lower limit of Mathematical expression 4 is less than the lower limit of Mathematical expression 4, the second lens group G2 may be difficult to manufacture. Mathematical expression 4 may preferably satisfy 0.5<f_G2/f_wide<0.7 in the first to third embodiments.

$$1.3 < \vert f\_G3 / f\_wide \vert < 1.7 \qquad [ Mathematical expression 5 ]$$

In Mathematical expression 5, the relationship between the focal length (f_G3) of the third lens group G3 and the overall focal length (f_wide) of the optical systems 1000, 1100, and 1200 at the wide-angle end (wide) can be established. Mathematical expression 5 is a condition for limiting the size of the refractive power of the third lens group G3.

If the upper limit of Mathematical expression 5 is exceeded, the stroke length of the third lens group G3 increases during focusing, making it difficult to miniaturize the zoom lens. If the lower limit of Mathematical expression 5 is less than the lower limit of Mathematical expression 5, the refractive power of the third lens group G3 becomes too strong, and the variation of aberration becomes large when performing image plane correction according to the object distance. Mathematical expression 5 can preferably satisfy 1.3<|f_G3/f_wide|<1.6 in the first to third embodiments.

$$0.5 < \vert f\_G1 / f\_tele \vert < 1 \qquad [ Mathematical expression 6 ]$$

Mathematical expression 6 can set the relationship between the focal length (f_G1) of the first lens group G1 and the total focal length (f_tele) of the optical systems 1000, 1100, and 1200 at the telephoto end (tele). Mathematical expression 6 is a condition for limiting the size of the refractive power of the first lens group G1.

If the upper limit of Mathematical expression 6 is exceeded, the first lens group G1 has a weak refractive power, making it difficult to secure a back focal length and thus obtaining a clear image. If the lower limit of Mathematical expression 6 is less than the lower limit of Mathematical expression 6, the first lens group G1 has a strong refractive power, making it difficult to correct field curvature aberration at the wide-angle position, spherical aberration at the telephoto position, and coma aberration. Mathematical expression 6 can preferably satisfy 0.8<|f_G1/f_tele|<1 in the first to third embodiments.

$$0.1 < f\_G2 / f\_tele < 0.5 \qquad [ Mathematical expression 7 ]$$

In Mathematical expression 7, the relationship between the focal length (f_G2) of the second lens group G2 and the total focal length (f_tele) of the optical systems 1000, 1100, and 1200 at the telephoto end (tele) can be established. Mathematical expression 7 is a condition for limiting the size of the refractive power of the second lens group G2.

If the upper limit of Mathematical expression 7 is exceeded, the movement amount of the second lens group G2 for zoom operation may be large. If the lower limit of Mathematical expression 7 is less than the lower limit, the second lens group G2 may be difficult to manufacture. Mathematical expression 7 may preferably satisfy 0.2<f_G2/f_tele<0.4 in the first to third embodiments.

$$1.3 < \vert f\_G3 / f\_tele \vert < 1.7 \qquad [ Mathematical expression 8 ]$$

Mathematical expression 8 can establish the relationship between the focal length (f_G3) of the third lens group G3 and the overall focal length (f_wide) of the optical systems 1000, 1100, and 1200 at the wide-angle end (wide). Mathematical expression 8 is a Condition for limiting the magnitude of the refractive power of the third lens group G3.

If the upper limit of Mathematical expression 8 is exceeded, the stroke length of the third lens group G3 increases during focusing, making it difficult to miniaturize the zoom lens. If the lower limit of Mathematical expression 8 is less than the lower limit of Mathematical expression 8, the refractive power of the third lens group G3 becomes too strong, and the variation of aberration becomes large when performing image plane correction according to the object distance. Mathematical expression 8 can preferably satisfy 1.3<|f_G3/f_tele|<1.6 in the first to third embodiments.

$$2 < G2\_stroke < 3 \qquad [ Mathematical expression 9 ]$$

Mathematical expression 9 can set the range of the stroke length (G2_stroke) of the second lens group G2. If the upper limit of Mathematical expression 9 is exceeded, the stroke length of the second lens group G2 increases during focusing, making it difficult to miniaturize the zoom lens. If the lower limit of Mathematical expression 9 is less than the lower limit of Mathematical expression 9, the performance of the zoom optical system may deteriorate. Mathematical expression 9 can preferably satisfy 2<G2_stroke<2.5 in the first to third embodiments.

$$3 < G3\_stroke < 4 \qquad [ Mathematical expression 10 ]$$

Mathematical expression 10 can set the range of the stroke length (G3_stroke) of the third lens group G3. If the upper limit of Mathematical expression 10 is exceeded, the stroke length of the third lens group G3 increases during focusing, making it difficult to miniaturize the zoom lens. If the lower limit of Mathematical expression 10 is less than the lower limit of Mathematical expression 10, the performance of the zoom optical system may deteriorate. Mathematical expression 10 can preferably satisfy 3<G3_stroke<3.5 in the first to third embodiments.

$$15 < TTL < 20 \qquad [ Mathematical expression 11 ]$$

In Mathematical expression 11, TTL (Total track length) means the distance (mm) from the center of the first surface S1 of the first lenses 101, 201, and 301 to the upper surface of the image sensor 700 on the optical axis OA. When Mathematical expression 11 is satisfied, a mobile optical system can be provided. In the first to third embodiments, Mathematical expression 11 can preferably satisfy 15<TTL<18.

$$4 < ImgH < 6 \qquad [ Mathematical expression 12 ]$$

Mathematical expression 12 indicates that ImgH represents the maximum diagonal length of the image sensor 700. Mathematical expression 12 can set the diagonal size (ImgH) of the image sensor 700 and provide an optical system having a mobile sensor size. In the first to third embodiments, Mathematical expression 12 can preferably satisfy 4.5<ImgH<5.5.

$$1 < BFL\_wide < 3 \qquad [ Mathematical expression 13 ]$$

In Mathematical expression 13, BFL is the optical axis distance from the image sensor 700 to the center of the sensor side of the last lens. When Mathematical expression 13 is satisfied, the installation space of the filter 800 and the cover glass can be secured, the assemblability of the components can be improved through the gap between the image sensor 700 and the last lens, and the coupling reliability can be improved. In the first to third embodiments, Mathematical expression 13 can preferably satisfy 2.3<BFL<2.7. When BFL is less than the range of Mathematical expression 13, some of the light traveling to the image sensor may not be transmitted to the image sensor, which may cause a decrease in resolution. When BFL exceeds the range of Mathematical expression 13, stray light may be introduced, which may deteriorate the aberration characteristics of the optical system.

$$30 < FOV\_wide < 40 \qquad [ Mathematical expression 14 ]$$

Mathematical expression 14 can set the range of the field of view (FOV_wide) at the wide-angle end (wide). Mathematical expression 14 can provide an angle of view suitable for a mobile optical system. In the first to third embodiment, the FOV can preferably satisfy 33<FOV_wide<36.

$$20 < FOV\_tele < 25 \qquad [ Mathematical expression 15 ]$$

Mathematical expression 15 can set the range of the field of view (FOV_tele) at the telephoto end (tele). Mathematical expression 14 can provide an angle of view suitable for a mobile optical system. In the first to third embodiments, the FOV can preferably satisfy 20<FOV_tele<23.

$$3 < TTL / CA\_max < 5 \qquad [ Mathematical expression 16 ]$$

In Mathematical expression 16, CA_max means the largest effective diameter (mm) among the object side surface and the sensor side surface of a plurality of lenses, and TTL (Total track length) means the distance (mm) from the vertex of the first surface S1 of the first lenses 101, 201 and 301 to the upper surface of the image sensor 700 on the optical axis OA. Mathematical expression 16 sets the relationship between the total optical axis length of the optical system and the maximum effective diameter, thereby providing an improved mobile optical system. In the first to third embodiments, Mathematical expression 16 can preferably satisfy 3<TTL/CA_max<4.

$$3 < TTL / ImgH < 5 \qquad [ Mathematical expression 17 ]$$

Mathematical expression 17 indicates that TTL (Total track length) means the distance (mm) from the vertex of the first surface S1 of the first lens to the upper surface of the image sensor 700 on the optical axis OA, and ImgH means the maximum diagonal length of the image sensor 700. When Mathematical expression 17 is satisfied, the optical systems 1000, 1100, and 1200 can have TTL for application to the mobile image sensor 700, thereby providing improved image quality. In the first to third embodiments, Mathematical expression 17 can preferably satisfy 3<TTL/ImgH<4.

$$1.5 < F\_wide / ImgH < 2 \qquad [ Mathematical expression 18 ]$$

Mathematical expression 18 indicates that F_wide is the total effective focal length of the optical systems 1000, 1100, and 1200 at the wide-angle end (wide), and ImgH means the maximum diagonal length of the image sensor 700. Such optical systems 1000, 1100, and 1200 can have improved aberration characteristics in the size of the mobile image sensor 700. In the first to third embodiments, Mathematical expression 18 can preferably satisfy 1.5<F_wide/ImgH<1.8.

$$2.5 < F\_tele / ImgH < 3 \qquad [ Mathematical expression 19 ]$$

Mathematical expression 19 indicates that F_tele is the total effective focal length of the optical systems 1000, 1100, and 1200 at the telephoto end (tele), and ImgH means the maximum diagonal length of the image sensor 700. Such optical systems 1000, 1100, and 1200 can have improved aberration characteristics in the size of the mobile image sensor 700. In the first to third embodiments, Mathematical expression 19 can preferably satisfy 2.5<F_tele/ImgH<2.8.

$$0.1 < Σ CT / TTL < 0.5 \qquad [ Mathematical expression 20 ]$$

Mathematical expression 20 can set the relationship between the sum of the center thicknesses of the lenses (ΣCT) and the distance (TTL) from the vertex of the first surface S1 of the first lens to the upper surface of the image sensor 700 on the optical axis OA. If the upper limit of Mathematical expression 20 is exceeded, the number of lenses increases and the movement of the moving lens group in the zoom optical system may become disadvantageous. If the lower limit of Mathematical expression 20 is lower, the magnification performance of the zoom lens optical system may deteriorate. In the first to third embodiment, Mathematical expression 20 can preferably satisfy 0.3<ΣCT/TTL<0.5.

$$0.1 < Σ CG / TTL < 0.5 \qquad [ Mathematical expression 21 ]$$

Mathematical expression 21 can set the relationship between the sum of the gaps between adjacent lenses (ECG) and the distance (TTL) from the vertex of the first surface S1 of the first lens to the upper surface of the image sensor 700 on the optical axis OA. If the upper limit of Mathematical expression 21 is exceeded, the moving distance of the moving lens group in the zoom lens optical system increases, which may increase current consumption during zooming operation. If the lower limit of Mathematical expression 21 is lower, the magnification performance of the zoom lens optical system may deteriorate. In the first to third embodiments, Mathematical expression 21 can preferably satisfy 0.3<ΣCG/TTL<0.5.

$$1 < Σ C T / Σ C G < 1.5 \qquad [ Mathematical expression 22 ]$$

Mathematical expression 22 can set the relationship between the sum of the center thicknesses of the lenses (ΣCT) and the sum of the gaps between adjacent lenses (ΣCT). If the upper limit of Mathematical expression 22 is exceeded, the number of lenses increases and the movement of the moving lens group in the zoom optical system may become disadvantageous. If the lower limit of Mathematical expression 22 is lower, the magnification performance of the zoom lens optical system may deteriorate. In the first to third embodiment, Mathematical expression 22 can preferably satisfy 1<ΣCT/ΣCG<1.2.

$$1 < CA\_max / CA\_min < 1.5 \qquad [ Mathematical expression 23 ]$$

Mathematical expression 23 indicates that CA_max represents the maximum effective diameter among the object side surfaces and the sensor side surfaces of the lenses, and CA_Min represents the minimum effective diameter among the object side surfaces and the sensor side surfaces of the lenses. When Mathematical expression 23 is satisfied, the optical system can set a size for a slim and compact structure while maintaining optical performance. In the first to third embodiments, Mathematical expression 23 can preferably satisfy 1.1<CA_max/CA_min<1.4.

$$0.5 < CA\_max / ImgH < 1 \qquad [ Mathematical expression 24 ]$$

Mathematical expression 24 indicates that CA_max represents the maximum effective diameter among the object side surfaces and the sensor side surfaces of the lenses, and Imgh represents the maximum diagonal length of the image sensor 700. When Mathematical expression 24 is satisfied, the optical system can maintain good optical performance and set a size for a slim and compact structure. In the first to third embodiments, Mathematical expression 24 can preferably satisfy 0.8<CA_max/ImgH<1.

$$0.5 < CA\_min / ImgH < 1 \qquad [ Mathematical expression 25 ]$$

Mathematical expression 25 indicates that CA_Min represents the minimum effective diameter among the object side surfaces and the sensor side surfaces of the lenses, and Imgh represents the maximum diagonal length of the image sensor 700. When Mathematical expression 25 is satisfied, the optical system can maintain good optical performance and set a size for a slim and compact structure. In the first to third embodiments, Mathematical expression 25 can preferably satisfy 0.7<CA_min/ImgH<0.9.

$$G1\_LjR2 > 0 \qquad [ Mathematical expression 26 ]$$

$$G2\_LiR1 > 0 , G2\_LiR2 < 0$$

Mathematical expression 26 can set the relationship between the sign of the radius of curvature of the lens (G1_Lj) being disposed closest to the sensor side among the lenses included in the first lens group G1 and the sign of the radius of curvature of the lens (G2_Li) being disposed closest to the object side among the lenses included in the second lens group G2. The first lens group G1 corresponds to a fixed group during zooming operation, and the sensor side of the lens being disposed closest to the sensor side in the first lens group G1 has a concave shape and can serve to spread light as a lens with negative (−) refractive power. The second lens group G2 corresponds to a moving group during zooming operation, and the lens being disposed closest to the object side in the second lens group G2 has a biconvex shape and can serve to gather light as a lens with positive (+) refractive power. That is, the third lenses 103, 203, and 303 and the fourth lenses 104, 204, and 304 being disposed adjacent to one another sequentially spread and gather light, thereby securing the variable magnification performance of the zoom optical system.

$$25 < \vert v 3 - v 4 \vert < 35 \qquad [ Mathematical expression 27 ]$$

Mathematical expression 27 can set the relationship between the Abbe number of the third lenses 103, 203, and 303 and the Abbe number of the fourth lenses 104, 204, and 304. The third lenses 103, 203, and 303 is the lens being disposed closest to the object side of the aperture (STOP), and the fourth lenses 104, 204, and 304 is the lens being disposed closest to the sensor side of the aperture (STOP). Since the lens being disposed closest to the aperture (STOP) is a sensitive lens that affects the entire optical system, the occurrence of chromatic aberration noise can be reduced by arranging a lens with a large Abbe number difference closest to the aperture (STOP). Any one of Abbe numbers the third lenses 103, 203, and 303 or fourth lenses 104, 204, and 304 can satisfy 50 or more. In the first to third embodiments, Mathematical expression 27 preferably satisfies 28<CA_min/ImgH<32.

$$0.3 < f\_wide / TTL < 0.7 \qquad [ Mathematical expression 28 ]$$

Mathematical expression 28 indicates that f_wide is the total effective focal length of the optical systems 1000, 1100, and 1200 at the wide-angle end (wide), and TTL is the distance from the vertex of the first surface S1 of the first lens to the image surface of the image sensor 700 on the optical axis OA. When Mathematical expression 28 is satisfied, the optical systems 1000, 1100, and 1200 can have narrow-angle optical characteristics suitable for the size of the mobile image sensor 700. In the first to third embodiments, Mathematical expression 28 can preferably satisfy 0.3<f_wide/TTL<0.6.

$$0.5 < f\_tele / TTL < 1 \qquad [ Mathematical expression 29 ]$$

Mathematical expression 29 indicates that f_tele is the total effective focal length of the optical systems 1000, 1100, and 1200 at the telephoto end (tele), and TTL is the distance from the vertex of the first surface S1 of the first lens to the top surface of the image sensor 700 on the optical axis OA. When Mathematical expression 29 is satisfied, the optical systems 1000, 1100, and 1200 can have narrow-angle optical characteristics suitable for the size of the mobile image sensor 700. In the first to third embodiments, Mathematical expression 29 can preferably satisfy 2.5<f_tele/TTL<2.8.

$$z = \frac{{cY}^{2}}{1 + \sqrt{1 - ( 1 + K ) {c}^{2} {Y}^{2}}} + {AY}^{4} + {BY}^{5} + {CY}^{4} + {DY}^{5} + {EY}^{4} + ⋯ \qquad [ Mathematical expression 30 ]$$

In Mathematical expression 30, Z can represent Sag, the distance on the optical axis direction from any location on the aspheric surface to the vertex of the aspheric surface. Y can represent the distance in the direction perpendicular to the optical axis from any location on the aspheric surface to the optical axis. c can represent the curvature of the lens, and K can represent the conic constant. In addition, A, B, C, D, E, and F can represent aspheric constants.

The optical systems 1000, 1100, and 1200 according to the first to third embodiments can satisfy at least one or two or more Mathematical expressions from Mathematical expression 1 to Mathematical expression 30. In this case, the optical systems 1000, 1100, and 1200 can have improved optical characteristics. In detail, when the optical systems 1000, 1100, and 1200 satisfies at least one or two or more Mathematical expressions from Mathematical expression 1 to Mathematical expression 30, the optical systems 1000, 1100, and 1200 can have improved resolution and improve aberration and distortion characteristics. In addition, the optical systems 1000, 1100, and 1200 can secure a BFL (Back focal length) for applying the image sensor 700, compensate for the deterioration of optical characteristics due to temperature change, and minimize the gap between the last lens and the image sensor 700, thereby providing good optical performance in the central and peripheral portions of the field of view (FOV).

TABLE 10

| | | First | Second | Third |
|---|---|---|---|---|
| | | embodi- | embodi- | embodi- |
| Mathematical expression | | ment | ment | ment |
| 1 | 0.5 < f_tele/f_wide < 1 | 0.621 | 0.621 | 0.621 |
| 2 | 0.3 < \|f_G2/f_G1\| < 0.7 | 0.429 | 0.407 | 0.407 |
| 3 | 1.3 < \|f_G1/f_wide\| < 1.7 | 1.460 | 1.502 | 1.502 |
| 4 | 0.5 < f_G2/f_wide < 1 | 0.627 | 0.611 | 0.611 |
| 5 | 1.3 < \|f_G3/f_wide\| < 1.7 | 1.514 | 1.455 | 1.455 |
| 6 | 0.5 < \|f_G1/f_tele\| < 1 | 0.907 | 0.933 | 0.933 |
| 7 | 0.1 < f_G2/f_tele < 0.5 | 0.389 | 0.380 | 0.380 |
| 8 | 0.5 < \|f_G3/f_tele\| < 1 | 0.940 | 0.904 | 0.904 |
| 9 | 2 < G2_stroke < 3 | 2.347 | 2.374 | 2.374 |
| 10 | 3 < G3_stroke < 4 | 3.150 | 3.189 | 3.189 |
| 11 | 15 < TTL < 20 | 16.900 | 16.900 | 16.900 |
| 12 | 4 < ImgH < 6 | 5.040 | 5.040 | 5.040 |
| 13 | 1 < BFL_wide < 3 | 2.500 | 2.500 | 2.500 |
| 14 | 30 < FOV_wide < 40 | 34.300 | 34.340 | 34.340 |
| 15 | 20 < FOV_tele < 25 | 21.300 | 21.240 | 21.240 |
| 16 | 3 < TTL/CA_max < 5 | 3.407 | 3.407 | 3.407 |
| 17 | 3 < TTL/ImgH < 5 | 3.353 | 3.353 | 3.353 |
| 18 | 1.5 < f_wide/ImgH < 2 | 1.669 | 1.669 | 1.669 |
| 19 | 2.5 < f_tele/ImgH < 3 | 2.687 | 2.687 | 2.687 |
| 20 | 0.1 < ΣCT/TTL < 0.5 | 0.455 | 0.467 | 0.469 |
| 21 | 0.1 < ΣCG/TTL < 0.5 | 0.437 | 0.449 | 0.441 |
| 22 | 1 < ΣCT/ΣCG < 1.5 | 1.042 | 1.041 | 1.063 |
| 23 | 1 < CA_max/CA_min < | 1.219 | 1.223 | 1.314 |
| | 1.5 | | | |
| 24 | 0.5 < CA_max/ImgH < 1 | 0.984 | 0.984 | 0.984 |
| 25 | 0.5 < CA_min/ImgH < 1 | 0.807 | 0.804 | 0.749 |
| 26 | G1_LjR2 > 0, G2_LiR1 > | Satisfy | Satisfy | Satisfy |
| | 0, G2_LiR2 < 0 | | | |
| 27 | 25 < \|v3-v4\| < 35 | 30.09 | 30.09 | 30.09 |
| 28 | 0.3 < f_wide/TTL < 0.7 | 0.498 | 0.498 | 0.498 |
| 29 | 0.5 < f_tele/TTL < 1 | 0.801 | 0.801 | 0.801 |

Table 10 shows the result values for Mathematical expression 1 to Mathematical expression 29 described above in the optical systems 1000, 1100, and 1200 of the embodiment. Referring to Table 10, it can be seen that the optical systems 1000, 1100, and 1200 satisfy at least one, two or more, or three or more of Mathematical expression 1 to Mathematical expression 29. In detail, it can be seen that the optical systems 1000, 1100, and 1200 according to the embodiment satisfy all of Mathematical expression 1 to Mathematical expression 29. Accordingly, the optical systems 1000, 1100, and 1200 can have good optical performance in the center and peripheral portions of the field of view (FOV) and can have excellent optical characteristics.

The optical systems 1300, 1400, and 1500 according to the fourth to sixth embodiments may include a plurality of lens groups. In detail, the optical systems 1300, 1400, and 1500 may include a plurality of lens groups each including at least one lens. For example, the optical systems 1300, 1400, and 1500 may include a first lens group G1, a second lens group G2, a third lens group G3, and an image sensor 700 being sequentially disposed along the optical axis OA from the object side toward the sensor.

Each of the first to third lens groups G1, G2, and G3 can have positive (+) or negative (−) refractive power. In detail, the first lens group G1 and the second lens group G2 can have opposite refractive powers. For example, the first lens group G1 can have negative (−) refractive power, and the second lens group G2 can have positive (+) refractive power. In addition, the second lens group G2 and the third lens group G4 can have opposite refractive powers. For example, the second lens group G3 can have positive (+) refractive power, and the third lens group G3 can have negative (−) refractive power.

The first lens group G1 and the second lens group G2 may have different focal lengths. Specifically, since the first and second lens groups G1 and G2 have opposite refractive powers, the focal length of the second lens group G2 may have a sign (+, −) opposite to the focal length of the first lens group G1. In addition, the second lens group G2 and the third lens group G3 may have different focal lengths. Specifically, since the second and third lens groups G2 and G3 have opposite refractive powers, the focal length of the second lens group G2 may have a sign (+, −) opposite to the focal length of the third lens group G3.

At least one among the first to third lens groups G1, G2, and G3 may be provided to be movable in an optical axis direction OA. In detail, at least two among the plurality of lens groups G1, G2, and G3 may be provided to be movable, and the remaining lens groups may be fixed. For example, the first lens group G1 may be disposed at a fixed position, and the second lens group G2 and the third lens group G3 may be provided to be movable in an optical axis direction OA.

The first lens group G1 may include a plurality of lenses. Specifically, the first lens group G1 may include one or more lenses having opposite refractive powers. For example, the first lens group G1 may include two lenses.

A plurality of lenses included in the first lens group G1 may have a set gap. In detail, the gap between the plurality of lenses included in the first lens group G1 may be constant without changing in the operation mode described later. For example, the gap between the first lenses 401, 501, and 601 and the second lenses 402, 502, and 602 may be constant without changing in the operation mode described later. Here, the gap between the plurality of lenses may mean the optical axis direction gap of adjacent lenses on the optical axis.

The second lens group G2 may include a plurality of lenses. Specifically, the second lens group G2 may include two or more lenses having opposite refractive powers. The number of lenses included in the second lens group G2 may be less than the number of lenses included in the first lens group G1. For example, the second lens group G2 may include two lenses.

The plurality of lenses included in the second lens group G2 may have a set gap. Specifically, the gap between the plurality of lenses included in the second lens group G2 may be constant and not change in the operation mode described later. For example, the gap between the third lenses 403, 503, and 603 and the fourth lenses 404, 504, and 604 may be constant and not change in the operation mode described later.

The third lens group G3 may include a plurality of lenses. Specifically, the third lens group G3 may include two or more lenses having opposite refractive powers. The number of lenses included in the third lens group G3 may be less than the number of lenses included in the first lens group G1. For example, the third lens group G3 may include two lenses.

The plurality of lenses included in the third lens group G3 may have a set gap. Specifically, the gap between the plurality of lenses included in the third lens group G3 may be constant and not change in the operation mode described later. For example, the gap between the fifth lens 405, 505, and 605 and the sixth lens 406, 506, and 606 may be constant and not change in the operation mode described later.

That is, the optical systems 1300, 1400, and 1500 may include a plurality of lens groups G1, G2, and G3 and an image sensor 700 sequentially disposed from the object side toward the sensor. In addition, the optical systems 1300, 1400, and 1500 may include a plurality of lenses included in the lens groups G1, G2, and G3, for example, first lenses 401, 501, and 601, second lenses 402, 502, and 602, third lenses 403, 503, and 603, fourth lenses 404, 504, and 604, fifth lenses 405, 505, and 605, and sixth lenses 406, 506, and 606. In this case, the first lens group G1 may include first and second lenses 401 and 402, 501 and 502, and 601 and 602, and the second lens group G2 may include third and fourth lenses 403 and 404, 503 and 504, and 603 and 604. In addition, the third lens group G3 may include fifth and sixth lenses 405 and 406, 505 and 506, and 605 and 606. The first to sixth lenses 401 to 406, 501 to 506, and 601 to 606 and the image sensor 700 may be sequentially disposed along the optical axis OA of the optical systems 1300, 1400, and 1500.

Each of the plurality of lenses 100 may include an effective area and an ineffective area. The effective area may be an area through which light incident on each of the first to sixth lenses 401 to 406, 501 to 506, and 601 to 606 passes. In other words, the effective area may be an area through which the incident light is refracted to implement optical characteristics.

FIG. 55 is a drawing illustrating a lens to which a D-cut technique is applied according to the present embodiment. Referring to FIG. 55, the lens may include an effective diameter and a rib disposed around the effective diameter. FIG. 55a illustrates a lens to which the D-cut technique is not applied. As illustrated in FIG. 55a, when the D-cut technique is not applied, the lens may not have the effective diameter and ribs cut off. FIG. 55b illustrates a lens to which the D-cut technique is applied. As illustrated in FIG. 55b, when the D-cut technique is applied, the lens may have a portion of the ribs cut off. FIG. 55c illustrates a lens to which a D-cut technique different from FIG. 55b is applied. As illustrated in FIG. 55c, when the D-cut technique is applied, the lens may have a portion of the ribs and a portion of the effective diameter cut off.

When the D-cut technique is applied, the height of the entire optical system can be reduced by cutting off a portion of the lens effective diameter or rib. Here, the height of the entire optical system may mean the length in the direction perpendicular to the optical axis, not the TTL. In the optical systems 1300, 1400, and 1500 according to the fourth to sixth embodiments, at least one of the first to sixth lenses 401 to 406, 501 to 506, and 601 to 606 may be applied with the D-cut technique.

The image sensor 700 can detect light. The image sensor 700 can detect light that has sequentially passed through a plurality of lenses, for example, the first to sixth lenses 401 to 406, 501 to 506, and 601 to 606. The image sensor 700 can include a CCD (Charge Coupled Device) or a CMOS (Complementary Metal Oxide Semiconductor).

In addition, the optical systems 1300, 1400, and 1500 may further include a filter 800. The filter 800 may be disposed between a plurality of lenses and the image sensor 700. The filter 800 may be disposed between the image sensor 700 and the third lens group G3 that is closest to the image sensor 700 among the plurality of lens groups G1, G2, and G3. For example, the filter 800 may be disposed between the last lens of the third lens group G3 that is closest to the image sensor 700 among the plurality of lenses and the image sensor 700.

The filter 800 may include at least one optical filter, such as an infrared filter or a cover glass. The filter 800 may allow light of a set wavelength band to pass through and filter out light of a different wavelength band. When the filter 800 includes an infrared filter, it may block radiant heat emitted from external light from being transmitted to the image sensor 700. In addition, the filter 800 may allow visible light to pass through and reflect infrared light.

The optical systems 1300, 1400, and 1500 may include an aperture not shown. The aperture can control the amount of light incident on the optical systems 1300, 1400, and 1500.

The aperture may be disposed in front of the first lenses 401, 501, and 601 or may be disposed between two lenses selected from the first to sixth lenses 401 to 406, 501 to 506, and 601 to 606. For example, the aperture may be disposed between the third lenses 403, 503, and 603 and the fourth lenses 404, 504, and 604. In addition, at least one lens from the first to sixth lenses 401 to 406, 501 to 506, and 601 to 606 may function as an aperture. For example, an object-side surface or a sensor-side surface of one lens selected from the first to sixth lenses 401 to 406, 501 to 506, and 601 to 606 may function as an aperture for controlling the amount of light. For example, at least one lens surface among the sensor side surface S6 (sixth surface) of the third lenses 403, 503, and 603 and the object side surface S7 (seventh surface) of the fourth lenses 404, 504, and 604 can function as an aperture.

An optical system according to the fourth embodiment of the invention will be described.

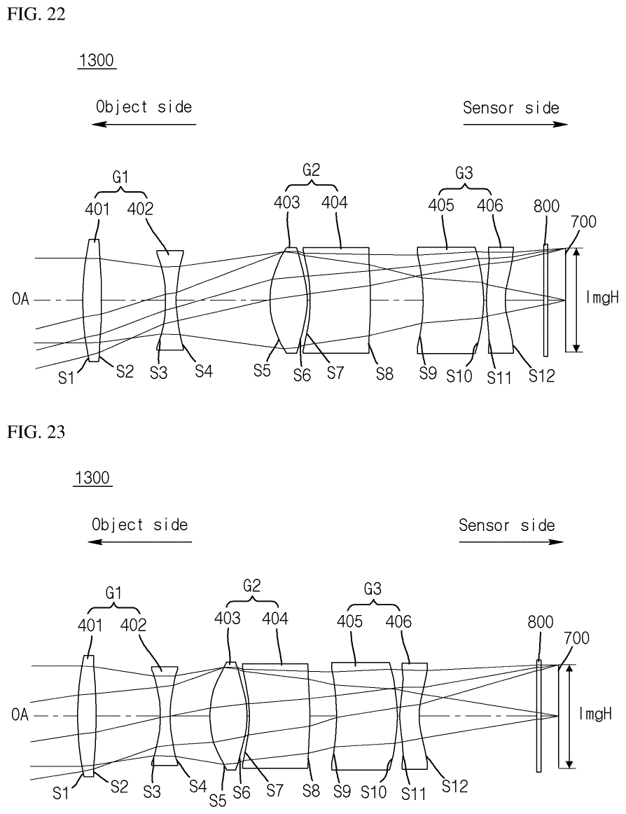

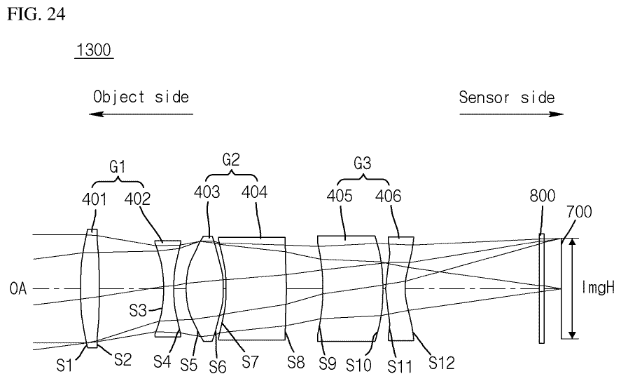

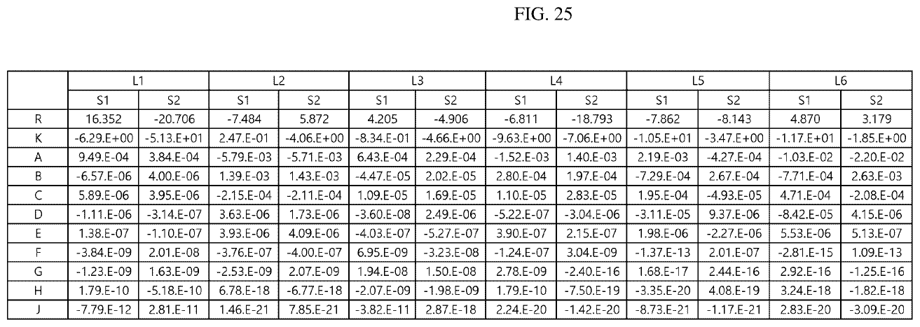

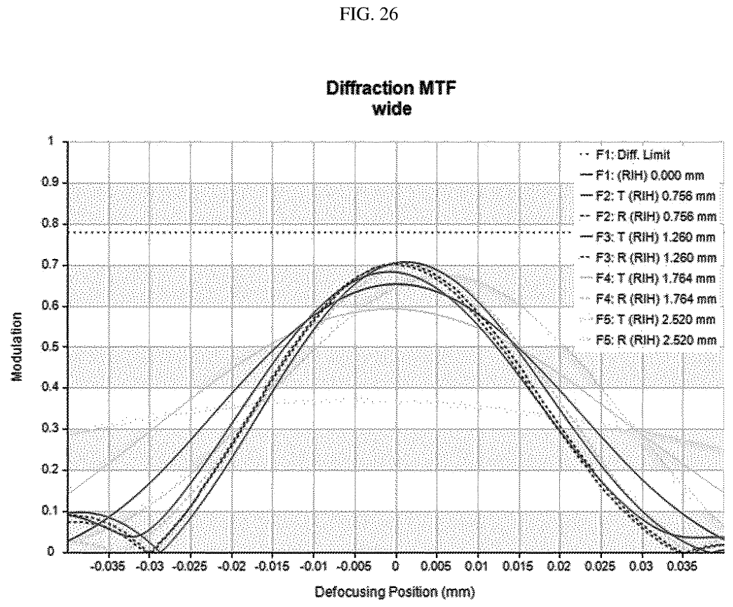

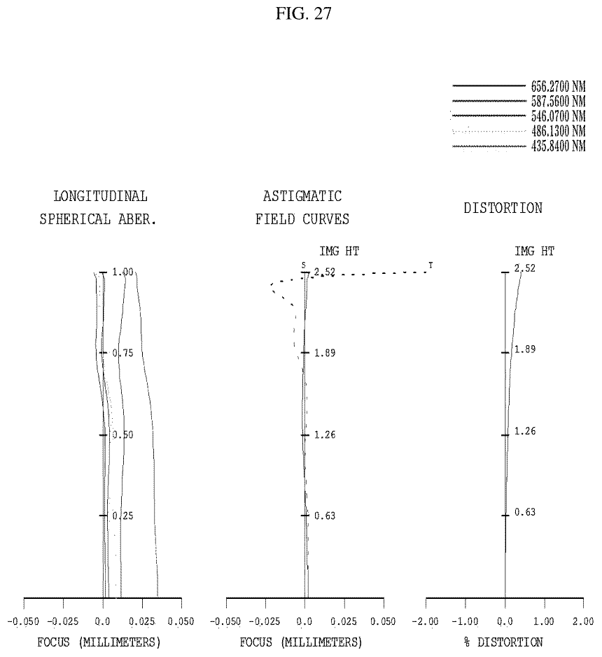

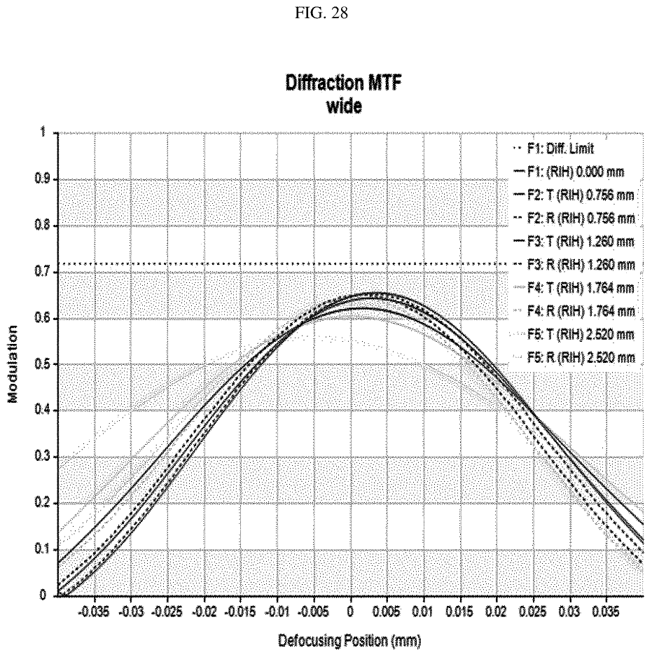

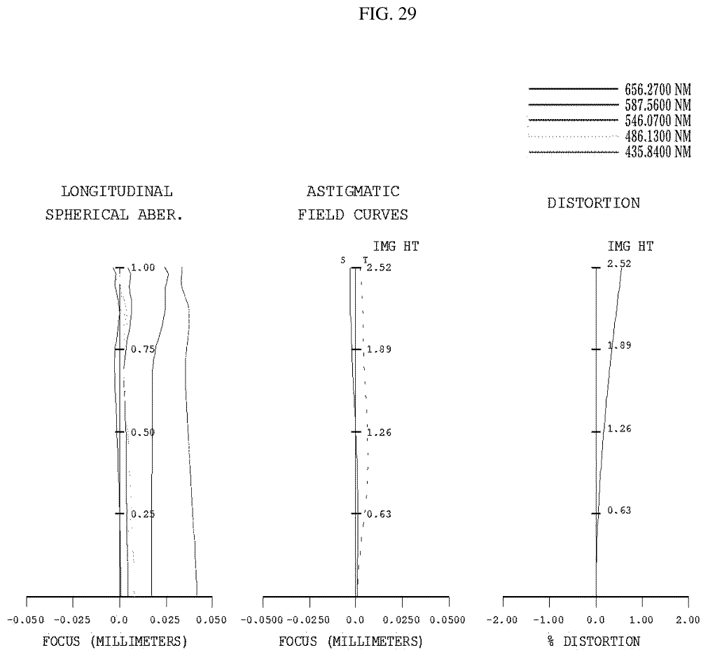

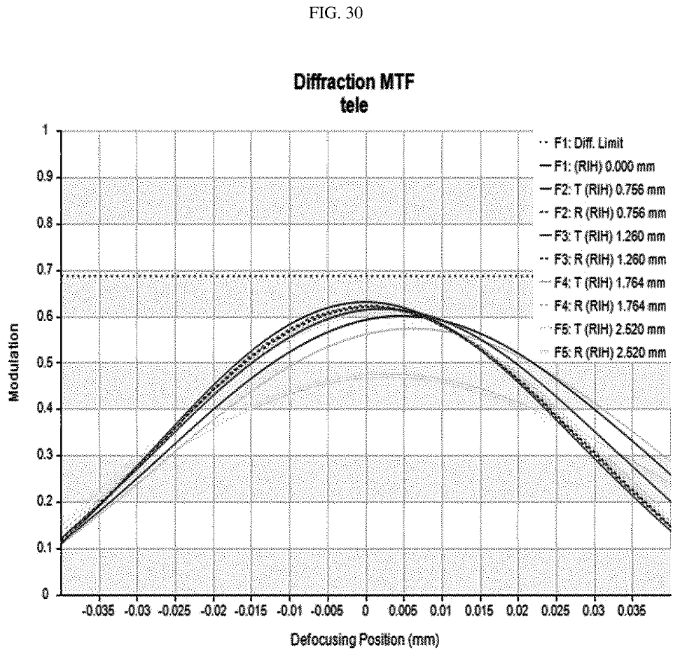

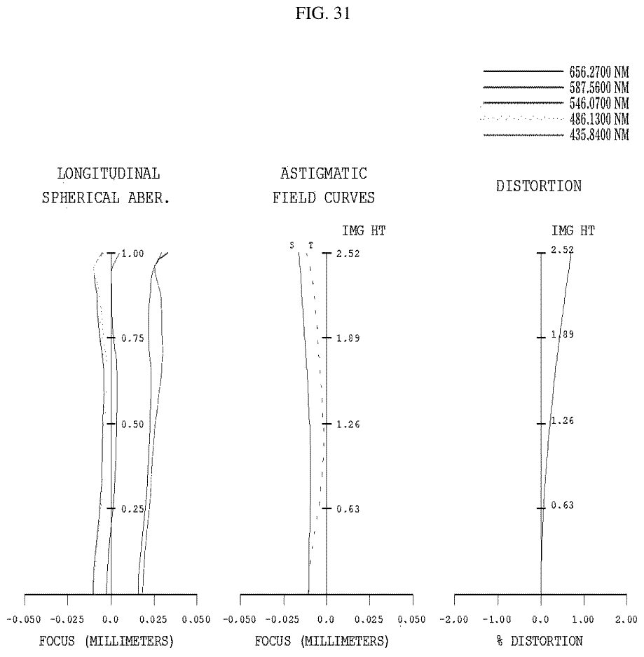

FIG. 22 is a diagram showing a configuration of an optical system according to a fourth embodiment operating in a first mode; FIG. 23 is a diagram showing a configuration of an optical system according to a fourth embodiment operating in a second mode; FIG. 24 is a diagram showing a configuration of an optical system according to a fourth embodiment operating in a third mode; FIG. 25 is a table showing aspherical coefficients of lenses in an optical system according to a fourth embodiment; FIG. 26 is a graph showing data on diffraction MTF (Modulation Transfer Function) at room temperature of an optical system according to a fourth embodiment operating in a first mode; FIG. 27 is a graph showing data on aberration characteristics of an optical system according to a fourth embodiment operating in a first mode; FIG. 28 is a graph showing data on diffraction MTF (Modulation Transfer Function) at room temperature of an optical system according to a fourth embodiment operating in a second mode; FIG. 29 is a graph showing data on aberration characteristics of an optical system according to a fourth embodiment operating in a second mode; FIG. 30 is a graph showing data on diffraction MTF (Modulation Transfer Function) at room temperature of an optical system according to a fourth embodiment operating in a third mode; FIG. 31 is a graph showing data on aberration characteristics of an optical system according to a fourth embodiment operating in a third mode; and FIG. 32 is a graph showing data on relative illumination versus relative field of an optical system according to a fourth embodiment.

Referring to FIG. 22, the optical system 1300 includes a lens unit, and the lens unit may include a first lens 401 to a sixth lens 406. The first to sixth lenses 401 to 406 may be sequentially disposed along the optical axis OA of the optical system 1300. Light corresponding to information about an object may pass through the first to sixth lenses 401 to 406 and the filter 800 and be incident on the image sensor 700.

The first lens 401 may be disposed closest to the object side. The first lens 401 may be disposed furthest from the sensor side. The first lens 401 may have positive refractive power on the optical axis OA. The first lens 401 may include a plastic material or a glass material, and may be, for example, a plastic material.

The object-side first surface S1 of the first lens 401 may be convex with respect to the optical axis, and the sensor-side second surface S2 may be convex. The first lens 401 may have a convex shape on both sides. The first lens 401 may be made of a plastic material and may have an aspherical surface. The aspherical coefficients of the first and second surfaces S1 and S2 may be provided as L1S1, L1S2 of FIG. 25.

The refractive index (n1) of the first lens 401 can satisfy the condition of n1>1.5, preferably n1>1.55. If the refractive index (n1) of the first lens 401 is less than the condition, the lens surface must be formed sharply concave or convex in order to increase the refractive power of the first and second lenses 401 and 402. In this case, lens manufacturing is not easy, the lens defect rate increases, and it may cause a decrease in yield.

The second lens 402 may be disposed second from the object side. The second lens 402 may be disposed sixth from the sensor side. The second lens 402 may be disposed between the first lens 401 and the third lens 403. The second lens 402 may have negative (−) refractive power on the optical axis OA. The second lens 402 may have different refractive power from the first lens 401 on the optical axis OA. The second lens 402 may include a plastic or glass material. For example, the second lens 402 may be provided as a plastic material.

The third surface S3 on the object side of the second lens 402 may be concave with respect to the optical axis OA, and the fourth surface S4 on the sensor side may be concave. The second lens 402 may have a concave shape for both surfaces. The second lens 402 may be made of a plastic material and may have an aspherical surface. The aspherical coefficients of the third and fourth surfaces S3 and S4 may be provided as L2S1 and L2S2 of FIG. 25.

The third lens 403 may be disposed third from the object side. The third lens 403 may be disposed fourth from the sensor side. The third lens 403 may be disposed between the second lens 402 and the fourth lens 404. The third lens 403 may have positive (+) refractive power on the optical axis OA. The third lens 403 may include a plastic or glass material. For example, the third lens 403 may be provided as a glass material.

The object-side fifth surface S5 of the third lens 403 may be convex with respect to the optical axis, and the sensor-side sixth surface S6 may be convex. The third lens 403 may have a shape in which both sides are convex with respect to the optical axis OA. The third lens 403 may be made of a plastic material and may have an aspherical surface. The aspherical coefficients of the fifth and sixth surfaces S5 and S6 may be provided as L3S1 and L3S2 of FIG. 25.

The aperture (STOP) may be disposed around the periphery of the sensor-side sixth surface S6 of the third lens 403. The aperture (STOP) may be disposed around the object-side seventh surface S7 of the fourth lens 403. The aperture can reduce the TTL within the field of view range, enabling miniaturization of the optical system. Accordingly, a decrease in the yield by weight of the optical system can be prevented, and production efficiency can be improved. In addition, the optical system can be miniaturized by reducing the TTL within the horizontal field of view (FOV_H) of 20 to 35 degrees.

The fourth lens 404 may be disposed fourth from the object side. The fourth lens 404 may be disposed third from the sensor side. The fourth lens 404 may be disposed between the third lens 403 and the fifth lens 405. The fourth lens 404 may have negative (−) refractive power. The fourth lens 404 may include a plastic or glass material. For example, the fourth lens 404 may be provided as a plastic material.

The object-side seventh surface S7 of the fourth lens 404 with respect to the optical axis may be concave, and the eighth surface S8 on the sensor-side may be convex. The fourth lens 404 may have a meniscus shape with a convex sensor side. The fourth lens 404 may be made of a plastic material and may have an aspherical surface. The aspherical coefficients of the seventh and eighth surfaces S7 and S8 may be provided as L4S1 and L4S2 of FIG. 25.

The fifth lens 405 may be disposed as the fifth lens from the object side. The fifth lens 405 may be disposed as the second lens from the sensor side. The fifth lens 405 may be disposed between the fourth lens 404 and the sixth lens 406. The fifth lens 405 may have positive (+) or negative (−) refractive power on the optical axis OA. The fifth lens 405 may have positive (+) refractive power. The fifth lens 405 may include a plastic or glass material. For example, the fifth lens 405 may be provided as a plastic material.

With respect to the optical axis OA, the ninth surface S9 on the object side of the fifth lens 405 may be concave, and the tenth surface S10 on the sensor side may be convex. The fifth lens 405 may have a meniscus shape convex toward the sensor side. The fifth lens 405 may be made of a plastic material and may have an aspherical surface. The aspherical coefficients of the ninth and tenth surfaces S9 and S10 may be provided as L5S1 and L5S2 of FIG. 25.

The sixth lens 406 may be disposed closest to the sensor side. The sixth lens 406 may be disposed furthest from the object side. The sixth lens 406 may have negative (−) refractive power. The sixth lens 406 may include a plastic or glass material. For example, the sixth lens 406 may be provided as a plastic material.

With respect to the optical axis OA, the eleventh surface S11 on the object side of the sixth lens 406 may be convex, and the twelfth surface S12 on the sensor side may be concave. The sixth lens 406 may have a meniscus shape that is convex on the object side. At least one or both of the eleventh surface S11 and the twelfth surface S12 may be aspherical. The aspherical coefficients of the eleventh and twelfth surfaces S11 and S12 may be provided as L6S1 and L6S2 of FIG. 25.

TABLE 11

| | | | | | | Semi |
|---|---|---|---|---|---|---|
| Lens | Surface | Radius | Thickness | nd | vd | Aperture |
| 1 | S1 | 16.352 | 0.921 | 1.564 | 39.196 | 2.700 |
| | S2 | −20.706 | 3.506 | | | 2.650 |
| 2 | S3 | −7.484 | 0.500 | 1.537 | 55.709 | 2.151 |
| | S4 | 5.872 | Variable(D1) | | | 2.185 |
| 3 | S5 | 4.505 | 1.843 | 1.537 | 55.709 | 2.370 |
| | S6(STOP) | −4.906 | 0.131 | | | 2.363 |
| 4 | S7 | −6.811 | 3.000 | 1.664 | 20.789 | 2.310 |
| | S8 | −18.793 | Variable(D2) | | | 2.215 |
| 5 | S9 | −7.862 | 3.000 | 1.680 | 19.240 | 2.175 |
| | S10 | −8.143 | 0.145 | | | 2.370 |
| 6 | S11 | 4.870 | 0.959 | 1.537 | 55.708 | 2.331 |
| | S12 | 3.179 | Variable(D3) | | | 2.341 |
| Filter | | Infinity | 0.210 | | | |
| | | Infinity | 0.890 | | | |
| Image | | Infinity | | | | |

Table 11 shows the surface number (Surface), radius of curvature (Radius), center thickness of each lens or distance between lens surfaces (Thickness), refractive index (Index,nd), Abbe number (Abbe,vd), effective radius (Semi Aperture), and focal length (Focal length) of the lens according to the fourth embodiment of the present invention. At this time, the unit of the radius of curvature and thickness or distance may be mm.

TABLE 12

| | wide | middle | tele |
|---|---|---|---|
| D1 | 4.679 | 1.966 | 0.634 |
| D2 | 2.604 | 1.363 | 1.850 |
| D3 | 1.912 | 5.867 | 6.712 |

Table 12 shows the gaps D1, D2, and D3 between lenses that are variable when the optical system according to the fourth embodiment of the present invention operates in any one among the first to third modes. Here, the first mode may refer to the wide-angle end (wide), the second mode may refer to the intermediate end (middle), and the third mode may refer to the telephoto end (tele). The wide-angle end may be referred to as a wide angle, and the telephoto end may be referred to as a telephoto.

In the optical system according to the fourth embodiment of the present invention, the distance between adjacent lens groups may change during the process of changing the magnification from the first mode to the third mode. The first lens group G1 is fixed, and only the second and third lens groups G2 and G3 can move. The first lens group G1 may be a fixed group, and the second and third lens groups G2 and G3 may be movable groups.

When operating from the first mode to the second mode, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the second mode to the third mode, the distance D1 between the first lens group G1 and the second lens group G2 may decrease the distance D2 between the second lens group G2 and the third lens group G3 may increase, and the distance D3 between the third lens group G3 and the filter 800 may increase.

When operating from the first mode to the third mode, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

The stroke length of the second lens group G2 can satisfy 4 mm to 4.5 mm, and preferably, can satisfy about 4.045 mm. The stroke length of the third lens group G3 can satisfy 4.5 mm to 5 mm, and preferably, can satisfy about 4.8 mm. The stroke length of the second lens group G2 can be smaller than the stroke length of the third lens group G3. The second lens group G2 and the third lens group G3 can have different moving speeds. The moving speed of the third lens group G3 can be greater than the moving speed of the second lens group G2.

By moving the second lens group G2 and the third lens group G3, the magnification of the zoom optical system can be continuously adjusted from about 3 times to about 7 times. Here, the magnification may mean the ratio of the focal lengths of the reference optical system center thickness together with the optical system according to the embodiment in the mobile terminal. In the fourth embodiment, the magnifications of the wide-angle end and the telephoto end can satisfy a range of 1.5 times to 2 times, and can satisfy a magnification of about 1.8 times.

TABLE 13

| | | | |
|---|---|---|---|
| EFL(f)_wide | 10.247 | EFL(f)_tele | 19.130 |
| BFL_wide | 3.012 | BFL_tele | 7.812 |
| EPD_wide | 4.125 | EPD_tele | 5.452 |
| SD_wide | 12.7503 | SD_tele | 12.7503 |
| Fno_wide | 2.484 | Fno_tele | 3.509 |
| FOV_wide | 27.534 | FOV_tele | 16.129 |
| f1 | 16.360 | f_G1 | −15.00 |
| f2 | −6.047 | f_G2 | 6.23 |
| f3 | 4.536 | f_G3 | −23.10 |
| f4 | −17.872 | G2_stroke | 4.045 |
| f5 | 100.967 | G3_stroke | 4.800 |
| f6 | −21.255 | TTL | 24.000 |
| ET1 | 0.5319 | ImgH | 5.040 |
| ET2 | 1.0282 | CA_Max | 5.4 |
| ET3 | 0.6866 | CA_Min | 4.602 |
| ET4 | 3.2662 | CA_Aver | 4.693 |
| ET5 | 2.9004 | L_CT_max | 3.000 |
| ET6 | 1.2722 | L_CT_min | 0.500 |
| | | L_CT_aver | 1.704 |
| | | Air_max | 4.679 |

Table 13 shows the items of Mathematical expressions described above in the optical system 1300 of the fourth embodiment, and the effective focal length (F) (mm), BFL (Back Focal Length) (mm), EPD (mm), SD (mm), Fno, FOV (degree) which is the optical axis distance from the aperture (STOP) to the twelfth surface S12 at each of the wide-angle end (wide) and the telephoto end (tele) of the optical system 1300, and the focal lengths (f1 to f6) (mm), edge thicknesses (ET1 to ET6) of the first to sixth lenses 401 to 406, the focal lengths (f_G1, f_G2, and f_G3) (mm) of the first to third lens groups G1, G2, and G3, the stroke length (G2_stroke) of the second lens group G2, the stroke length (G3_stroke) of the third lens group G3, and the optical system 1300 This is for the total optical axis distance TTL (mm), ImgH (mm), maximum effective diameter (CA_Max), minimum effective diameter (CA_Min), average effective diameter (CA_Aver), maximum center thickness (L_CT_max), minimum center thickness (L_CT_min), average center thickness (L_CT_aver) among the first to sixth lenses 401 to 406, and maximum value among adjacent lens gaps (Air_max).

The center thicknesses of the first to sixth lenses 401 to 406 are represented by CT1 to CT6, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. BFL (Back focal length) is the optical axis distance from the image sensor 700 to the center of the last lens. TTL is the optical axis distance from the center of the first surface S1 of the first lens 401 to the upper surface of the image sensor 700.

When comparing the absolute values of the curvature radius of each lens, the curvature radius of the second surface S2 of the first lens 401 on the optical axis OA may be the largest among the lenses, and the curvature radius of the twelfth surface S12 of the sixth lens 406 may be the smallest among the lenses. The difference between the maximum curvature radius and the minimum curvature radius may be 5 times or more, for example, 6 to 7 times. The absolute value of the curvature radius of the first surface S1 of the first lens 401 may be smaller than the absolute value of the curvature radius of the second surface S2. The absolute value of the curvature radius of the third surface S3 of the second lens 402 may be larger than the absolute value of the curvature radius of the fourth surface S4. The absolute value of the curvature radius of the fifth surface S5 of the third lens 403 may be smaller than the absolute value of the curvature radius of the sixth surface S6. The absolute value of the curvature radius of the seventh surface S7 of the fourth lens 404 may be smaller than the absolute value of the curvature radius of the eighth surface S8. The absolute value of the curvature radius of the ninth surface S9 of the fifth lens 405 may be smaller than the absolute value of the curvature radius of the tenth surface S10. The absolute value of the curvature radius of the eleventh surface S11 of the sixth lens 406 may be larger than the absolute value of the curvature radius of the twelfth surface S12.

The ratio of the radius of curvature of each lens can satisfy the following conditions.

$$0.5 < \vert L 1 R 1 / L 1 R 2 \vert < 1 \qquad Condition 1$$

$$1 < \vert L 2 R 1 / L 2 R 2 \vert < 1.3 \qquad Condition 2$$

$$0.5 < \vert L 3 R 1 / L 3 R 2 \vert < 1 \qquad Condition 3$$

$$0.1 < \vert L 4 R 1 / L 4 R 2 \vert < 0.5 \qquad Condition 4$$

$$0.5 < \vert L 5 R 1 / L 5 R 2 \vert < 1 \qquad Condition 5$$

$$1.3 < L 6 R 1 / L 6 R 2 < 1.7 \qquad Condition 6$$

When describing the center thickness of the lenses based on the optical axis, the center thickness CT4 of the fourth lens 404 or the center thickness CT5 of the fifth lens 405 is the largest among the lenses, and the center thickness (CT2) of the second lens 402 is the smallest among the lenses. The difference between the maximum center thickness and the minimum center thickness among the lenses may be in the range of 2 mm or more and 3 mm or less.

The center thickness of each lens can satisfy any one among the conditions below.

$$CT 3 , CT 4 , CT 5 , CT 6 > CT 1 > CT 2 \qquad Condition 1$$

$$CT 1 , CT 3 , CT 4 , CT 5 , CT 6 > CT 2 \qquad Condition 2$$

$$CT 4 , CT 5 > CT 3 > CT 1 , CT 2 , CT 6 \qquad Condition 3$$

$$CT 4 = CT 5 > CT 1 , CT 2 , CT 3 , CT 6 \qquad Condition 4$$

$$CT 3 , CT 4 , CT 5 > CT 6 > CT 1 , CT 2 \qquad Condition 5$$

When zooming, the gap CG1 between the first lens 401 and the second lens 402, the gap CG3 between the third lens 403 and the fourth lens 404, and the gap CG5 between the fifth lens 405 and the sixth lens 406 do not change, while the gap CG2 between the second lens 402 and the third lens 403, and the gap CG4 between the fourth lens 404 and the fifth lens can change. Among the center gaps between the lenses that do not change, the center gap CG1 between the first lens 401 and the second lens 402 can be the maximum, and the center gap CG3 between the third and fourth lenses 403 and 404 can be the minimum. The difference between the maximum center gap and the minimum center gap among the spaced lens gaps can be 5.5 mm or more, for example, in the range of 5.8 mm to 6.5 mm.

The center gap between each lens may satisfy the following condition.

$$CG 1 > C G 5 > C G 3 \qquad Condition 1$$

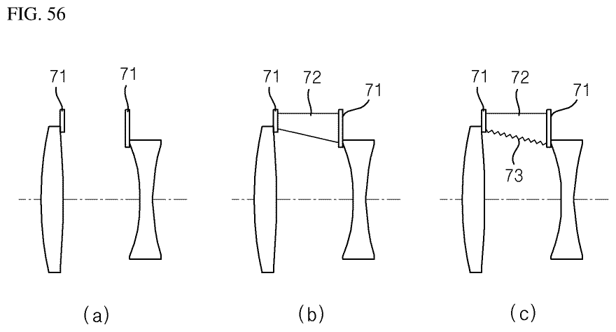

Referring to FIG. 56, optical members 71 and 72 may be center thickness on one surface of the first to sixth lenses 401 to 406. For example, since the gap between the first lens 401 and the second lens 402 is the largest on the optical axis direction, the first optical member 71 may be disposed in the ineffective area of one surface of the lens to prevent flare due to diffuse reflection. The first optical member 71 may be a light-shielding film. A second optical member 72 connecting the first lens 401 and the second lens 402 may be disposed. The second optical member 72 may be an injection-molded component. One surface of the second optical member 72 along the optical axis direction may have a pattern formed thereon. The pattern formed on one side of the second optical member 72 can prevent light that has been reflected from entering the image sensor 700.

When explaining the effective diameter, the lens having the maximum effective diameter may be the first lens 401. Here, the effective diameter is the average of the effective diameters of the object-side surface and the sensor-side surface of each lens. The lens surface having the maximum effective diameter may be the first surface S1 of the first lens 401. The lens having the minimum effective diameter may be the second lens 402. The lens surface having the minimum effective diameter may be the third surface S3 of the second lens 402.

The effective diameter (CA_L1) of the first lens 401 may be larger than the diagonal length of the image sensor 700. The average effective diameter of the second to sixth lenses 402 to 406 may be smaller than the diagonal length of the image sensor 700. Accordingly, light incident through a plurality of lenses aligned along the optical axis can be guided to the image sensor 700.

The effective diameter of each lens can satisfy any one among the conditions below.

$$CA\_L 1 > CA\_L 2 , CA\_L 3 , CA\_L4 , CA\_L 5 , CA\_L6 \qquad Condition 1$$

$$CA\_L 1 , CA\_L3 , CA\_L4 , CA\_L5 , CA\_L6 > CA\_L2 \qquad Condition 2$$

$$CA\_L1 > CA\_L3 > CA\_L2 , CA\_L4 , CA\_L5 , CA\_L6 \qquad Condition 3$$

$$CA\_L1 , CA\_L3 , CA\_L5 , CA\_L6 > CA\_L4 > CA\_L2 \qquad Condition 4$$

$$CA\_L1 , CA\_L3 , CA\_L6 > CA\_L5 > CA\_L2 , CA\_L4 \qquad Condition 5$$

$$CA\_L1 , CA\_L3 > CA\_L6 > CA\_L2 , CA\_L4 , CA\_L5 \qquad Condition 6$$

When explaining the refractive index, the refractive index of the fifth lens 405 may be the highest among the lenses and may be greater than 1.6, for example, greater than 1.65. One or all among the second lens 402, the third lens 403, and the sixth lens 406 may have the lowest refractive index among the lenses. For example, the refractive indices of the second lens 402, the third lens 403, and the sixth lens 406 may be the lowest among the lenses and may be less than 1.6, for example, less than 1.55. The difference between the maximum refractive index and the minimum refractive index may be 0.13 or more.

The refractive index of each lens can satisfy any one of the conditions below.

$$n 4 , n 5 > n 1 > n 2 , n 3 , n 6 \qquad Condition 1$$

$$n 1 , n 4 , n 5 > n 2 = n 3 = n 6 \qquad Condition 2$$

$$n 5 > n 4 > n 1 , n 2 , n 3 , n 6 \qquad Condition 3$$

$$n 5 > n 1 , n 2 , n 3 , n 4 , n 6 \qquad Condition 4$$

Comparing the Abbe numbers, the Abbe number of any one among the second lens 402, the third lens 403, and the sixth lens 406 is the largest among the lenses and may be 50 or more. The Abbe number of the fifth lens 405 is the smallest among the lenses and may be 25 or less. The difference between the maximum refractive index and the minimum Abbe number may be 30 or more.

The Abbe number of each lens can satisfy any one among the conditions below.

$$v 2 , v 3 , v 6 > v 1 > v 4 , v 5 \qquad Condition 1$$

$$v 2 = v 3 = v 6 > v 1 , v 4 , v 5 \qquad Condition 2$$

$$v 1 , v 2 , v 3 , v 6 > v 4 > v 5 \qquad Condition 3$$

$$v 1 , v 2 , v 3 , v 4 , v 6 > v 5 \qquad Condition 4$$

The focal lengths F1, F3, and F5 of the first, third, and fifth lenses 401, 403, and 405 may have positive (+) signs. The first, third, and fifth lenses 401, 403, and 405 may have positive (+) refractive power. The focal lengths F2, F4, and F6 of the second, fourth, and sixth lenses 402, 404, and 406 may have negative (−) signs. The second, fourth, and sixth lenses 402, 404, and 406 may have negative (−) refractive power.

When comparing the focal lengths in absolute values, the focal length of the fifth lens 405 is the largest among the lenses, and may be 100 or more and 110 or less. The focal length of the third lens 403 is the smallest among the lenses, and the absolute value of the focal length of the third lens 403 may be 3 or more and 5 or less.

The absolute value of the focal length of each lens can satisfy any one among the conditions below.

$$\vert f 4 \vert , \vert f 5 \vert , \vert f 6 \vert > \vert f 1 \vert > \vert f 2 \vert , \vert f 3 \vert \qquad Condition 1$$

$$\vert f 1 \vert , \vert f 4 \vert , \vert f 5 \vert , \vert f 6 \vert > \vert f 2 \vert > \vert f 3 \vert \qquad Condition 2$$

$$\vert f 1 \vert , \vert f 2 \vert , \vert f 4 \vert , \vert f 5 \vert , \vert f 6 \vert > \vert f 3 \vert \qquad Condition 3$$

$$\vert f 5 \vert , \vert f 6 \vert > \vert f 4 \vert > \vert f 1 \vert , \vert f 2 \vert , \vert f 3 \vert \qquad Condition 4$$

$$\vert f 5 \vert > \vert f 1 \vert , \vert f 2 \vert , \vert f 3 \vert , \vert f 4 \vert , \vert f 6 \vert \qquad Condition 5$$

$$\vert f 5 \vert > \vert f 6 \vert > \vert f 1 \vert , \vert f 2 \vert , \vert f 3 \vert , \vert f 4 \vert \qquad Condition 6$$

The composite focal length (f_G1) of the first lens group G1 can have a positive (+) sign. The first lens group G1 can have positive (+) composite refractive power. The composite focal length (f_G2) of the second lens group G2 can have a negative (−) sign. The second lens group G2 can have negative (−) composite refractive power. The composite focal length (f_G3) of the third lens group G3 can have a positive (+) sign. The third lens group G3 can have positive (+) composite refractive power. Through this, light incident from the object side can move away from the optical axis direction and then gather back on the optical axis direction, thereby forming a stable optical path.

When comparing the absolute values of the composite focal lengths of the first to third lens groups G1, G2, and G3, the composite focal length of the third lens group G3 may be the largest, and the composite focal length of the second lens group G2 may be the smallest. The relationship between the composite focal lengths of the first to third lens groups G1, G2, and G3 may satisfy |f_G3|>|f_G1|>f_G2.

The difference between the maximum and minimum thickness T1 of the first lens 401 may be 1.5 times or more, for example, in the range of 1.5 to 2 times, and its center thickness CT1 may be a maximum and its edge thickness ET1 may be a minimum. The maximum thickness T2 of the second lens 402 may be in the range of 1.8 to 2.3 times the minimum thickness. The second lens 402 may have a minimum center thickness CT2 and a maximum edge thickness ET2. The thickness T3 of the third lens 403 may be a maximum at the center and a minimum at the edge, with the maximum thickness being in the range of 2.5 to 3 times the minimum thickness. The thickness T4 of the fourth lens 404 may be a minimum at the center and a maximum at the edge, with the maximum thickness being in the range of 1 to 1.5 times the minimum thickness. The thickness T5 of the fifth lens 405 may be a maximum at the center and a minimum at the edge, with the maximum thickness being in the range of 1 to 1.5 times the minimum thickness. The thickness T6 of the sixth lens 406 may be a minimum at the center and a maximum at the edge, with the maximum thickness being in the range of 1.2 to 1.5 times the minimum thickness.

The thickness of each lens can satisfy any one among the conditions below.

$$1.5 < CT 1 / ET 1 < 2 , 0.2 < ET 1 / CT 1 < 0.7 \qquad Condition 1$$

$$0.1 < C T 2 / ET 2 < 0.5 , 1.9 < E T 2 / CT 2 < 2.2 \qquad Condition 2$$

$$2.5 < C T 3 / ET 3 < 3 , 0.1 < E T 3 / CT 3 < 0.5 \qquad Condition 3$$

$$0.5 < C T 4 / ET 4 < 1 , 1 < E T 4 / CT 4 < 1.2 \qquad Condition 4$$

$$1 < CT 5 / ET 5 < 1.2 , 0.5 < E T 5 / CT 5 < 1 \qquad Condition 5$$

$$0.5 < C T 6 / ET 6 < 1 , 1.2 < E T 6 / CT 6 < 1.5 \qquad Condition 6$$

$$1 < Σ CT / Σ ET < 1.5 , 0.5 < Σ E T / Σ CT < 1 \qquad Condition 7$$

Among the gaps G1 to G6 between the lenses, the gap G1 between the first and second lenses 401 and 402 may have a maximum in the center and a minimum in the edge. The gap G2 between the second and third lenses 402 and 403 may have a maximum in the edge and a minimum in the center. The gap G3 between the third and fourth lenses 403 and 404 may have a maximum in the edge and a minimum in the center. The gap G4 between the fourth and fifth lenses 404 and 405 may have a minimum in the edge and a maximum in the center. The fifth gap G5 between the fifth and sixth lenses 405 and 406 may have a minimum in the center and a maximum in the edge.

FIGS. 26, 28, and 30 are graphs showing the diffraction MTF (Modulation Transfer Function) at the wide-angle end (wide), intermediate end (mid), and telephoto end (tele) in the optical system of FIG. 22, and are graphs showing the luminance ratio (modulation) according to the spatial frequency. As shown in FIGS. 26, 28, and 30, in the fourth embodiment of the invention, the deviation of the MTF with respect to the intermediate end (mid) at low or high temperature may be less than 10%, that is, 7% or less.

FIGS. 27, 28, and 29 are graphs showing the aberration characteristics of the optical system from FIG. 22 at the wide-angle end (wide), intermediate end (mid), and telephoto end (tele). The aberration graphs in FIGS. 27, 28, and 29, from left to right, are graphs measuring longitudinal spherical aberration, astigmatic field curves, and distortion. In FIGS. 27, 28, and 29, the X-axis may represent focal length (mm) and distortion (%), and the Y-axis may represent image height. In addition, the graph for spherical aberration is for light in the wavelength bands of approximately 435 nm, 486 nm, 546 nm, 587 nm, and 656 nm, while the graphs for astigmatic field curves and distortion are for light in the wavelength band of approximately 546 nm. In the aberration diagrams of FIGS. 27, 28, and 29, it can be interpreted that the closer each curve is to the Y-axis at the wide-angle end (wide), intermediate end (mid), and telephoto end (tele) the better the aberration correction function is. It can be seen that the measured values of the optical system 1300 according to the fourth embodiment are adjacent to the Y-axis in almost all areas. That is, the optical system 1300 according to the fourth embodiment has improved resolution and can have good optical performance not only in the central part of the field of view (FOV) but also in the peripheral portion.

An optical system according to the fifth embodiment of the invention will be described.

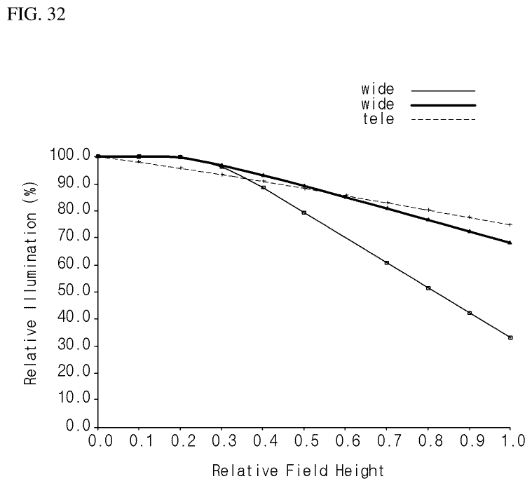

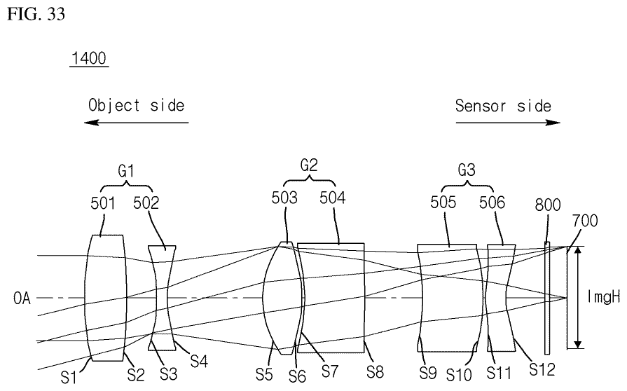

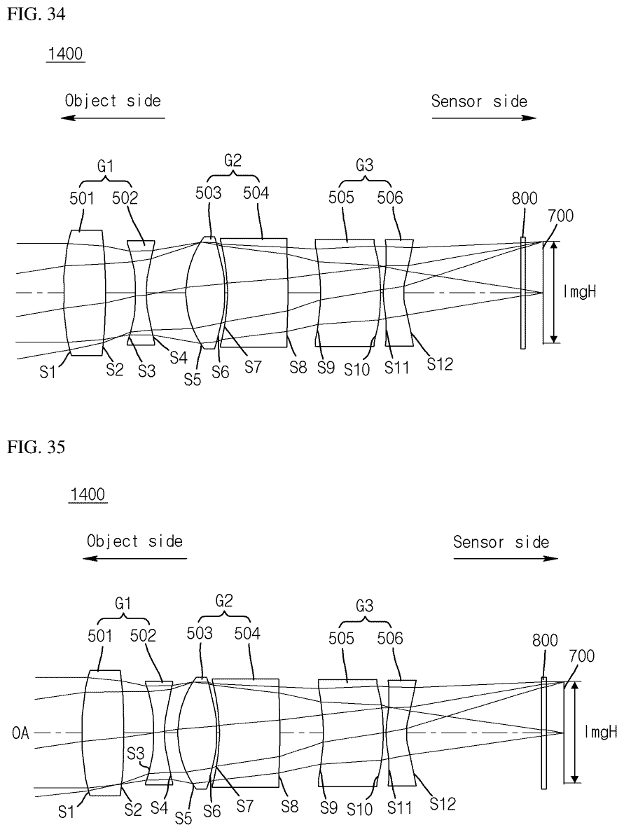

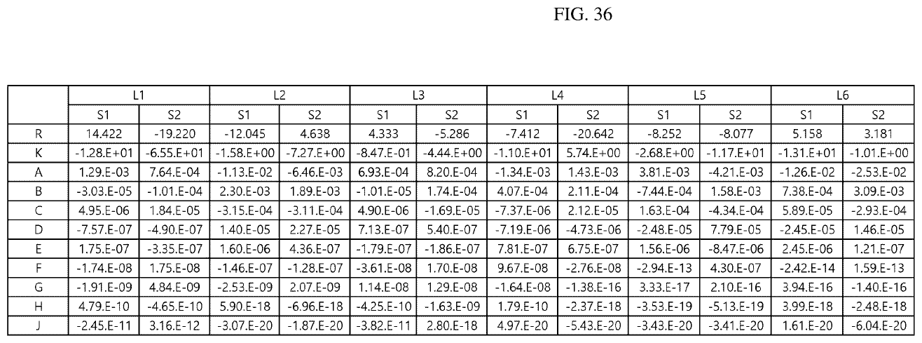

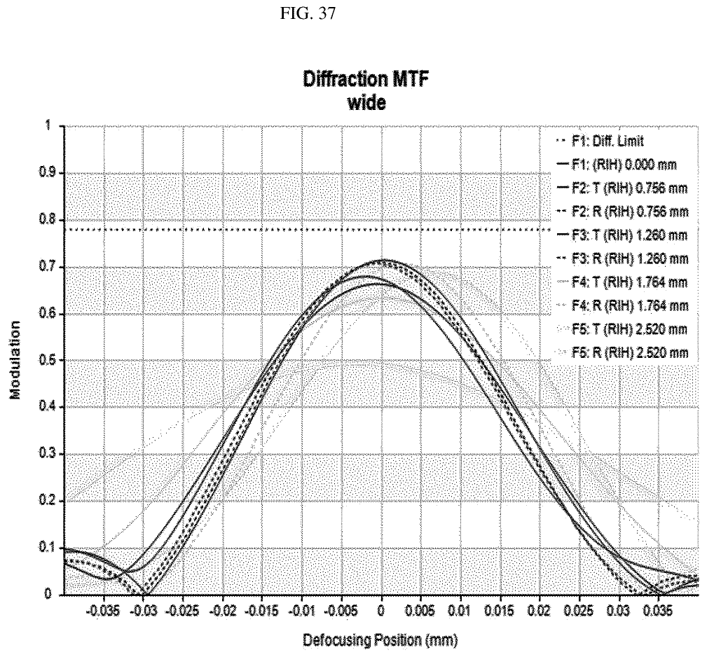

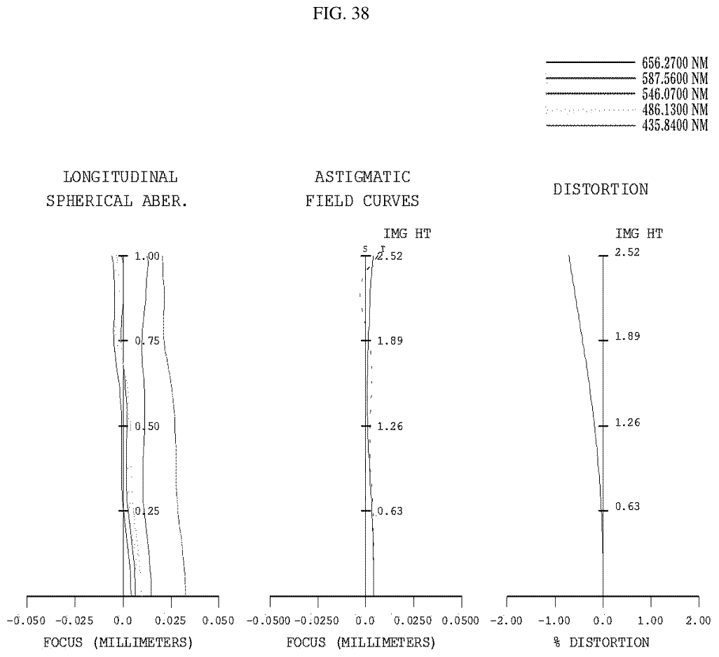

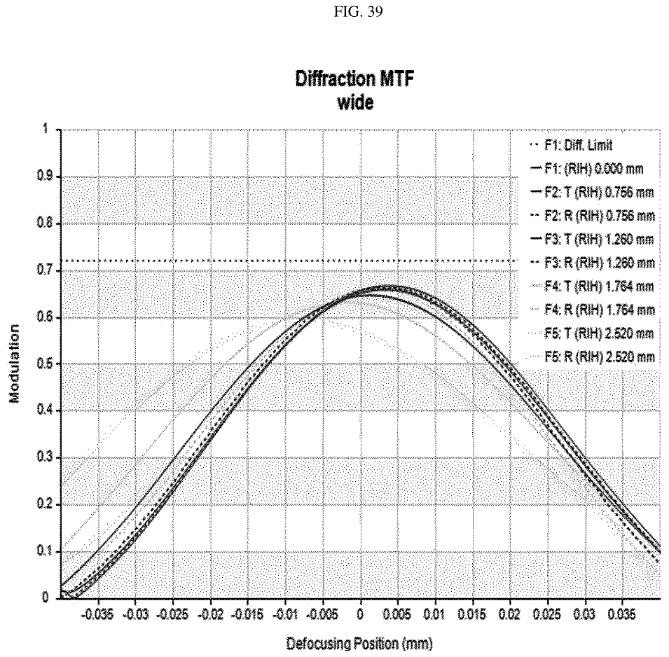

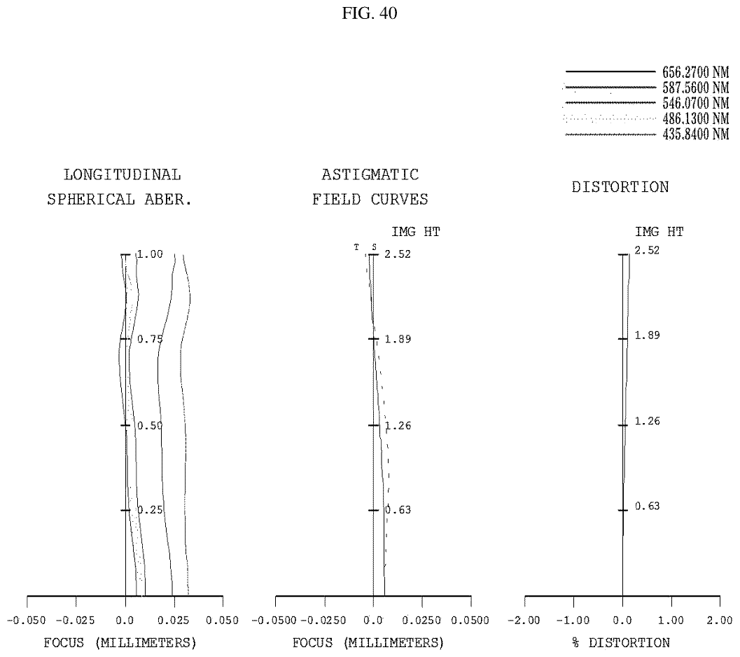

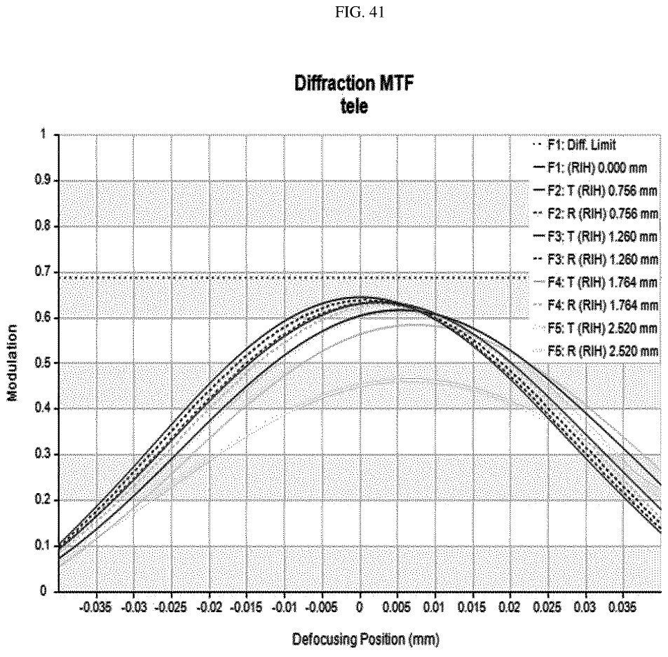

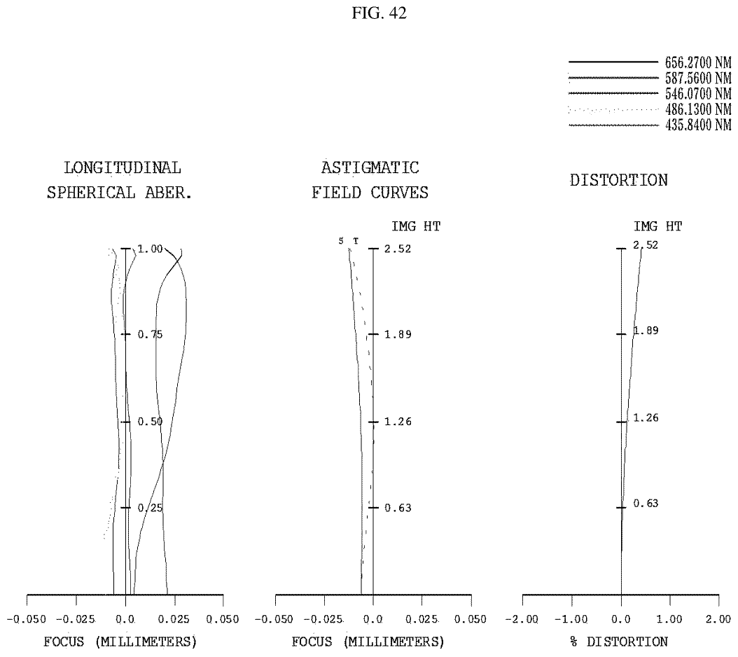

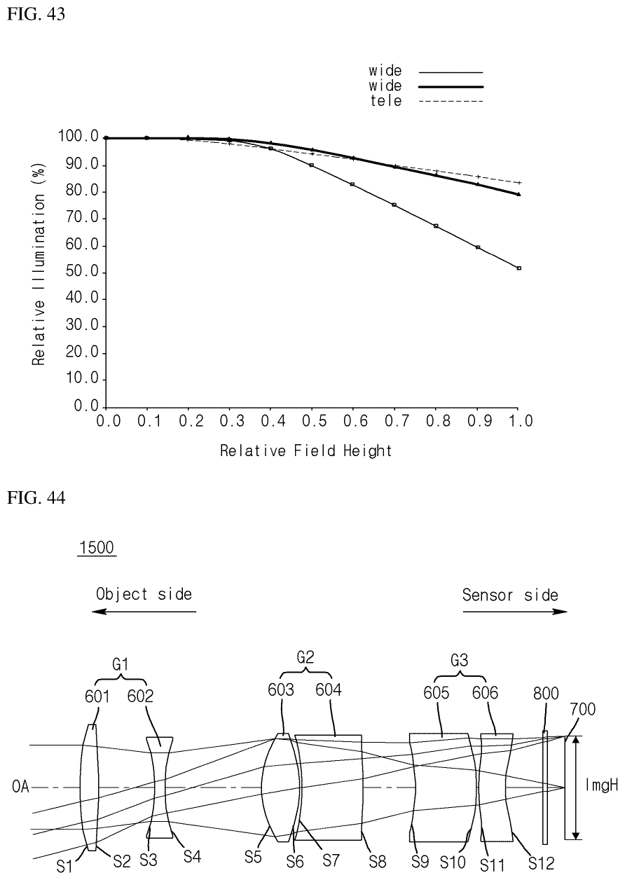

FIG. 33 is a diagram showing a configuration of an optical system according to a fifth embodiment operating in a first mode; FIG. 34 is a diagram showing a configuration of an optical system according to a fifth embodiment operating in a second mode; FIG. 35 is a diagram showing a configuration of an optical system according to a fifth embodiment operating in a third mode; FIG. 36 is a table showing aspherical coefficients of lenses in an optical system according to a fifth embodiment; FIG. 37 is a graph showing data on diffraction MTF (Modulation Transfer Function) at room temperature of an optical system according to a fifth embodiment operating in a first mode; FIG. 38 is a graph showing data on aberration characteristics of an optical system according to a fifth embodiment operating in a first mode; FIG. 39 is a graph showing data on diffraction MTF (Modulation Transfer Function) at room temperature of an optical system according to a fifth embodiment operating in a second mode; FIG. 40 is a graph showing data on aberration characteristics of an optical system according to a fifth embodiment operating in a second mode; FIG. 41 is a graph showing data on diffraction MTF (Modulation Transfer Function) at room temperature of an optical system according to a fifth embodiment operating in a third mode; FIG. 42 is a graph showing data on aberration characteristics of an optical system according to a fifth embodiment operating in a third mode; and FIG. 43 is a graph showing data on relative illumination versus relative field of an optical system according to a fifth embodiment operating in a fifth mode.

Referring to FIGS. 33 to 14, the optical system 1400 includes a lens unit, and the lens unit may include a first lens 501 to a sixth lens 506. The first to sixth lenses 501 to 506 may be sequentially disposed along the optical axis OA of the optical system 1400. Light corresponding to information about an object may pass through the first to sixth lenses 501 to 506 and the filter 800 and be incident on the image sensor 700.

The first lens 501 may be disposed closest to the object side. The first lens 501 may be disposed furthest from the sensor side. The first lens 501 may have positive (+) refractive power on the optical axis OA. The first lens 501 may include a plastic material or a glass material, and may be, for example, a plastic material.

The object-side first surface S1 of the first lens 501 may be convex with respect to the optical axis, and the sensor-side second surface S2 may be convex. The first lens 501 may have a convex shape on both sides. The first lens 501 may be made of a plastic material and may have an aspherical surface. The aspherical coefficients of the first and second surfaces S1 and S2 may be provided as L1S1, L1S2 of FIG. 36.

The refractive index n1 of the first lens 501 can satisfy the condition of n1>1.55, preferably n1>1.6. If the refractive index (n1) of the first lens 501 is less than the condition, the lens surface must be formed sharply concave or convex in order to increase the refractive power of the first and second lenses 501 and 502. In this case, lens manufacturing is not easy, the lens defect rate increases, and it may cause a decrease in yield.

The second lens 502 may be disposed second from the object side. The second lens 502 may be disposed fifth from the sensor side. The second lens 502 may be disposed between the first lens 501 and the third lens 503. The second lens 502 may have negative (−) refractive power on the optical axis OA. The second lens 502 may have different refractive power from the first lens 501 on the optical axis OA. The second lens 502 may include a plastic or glass material. For example, the second lens 502 may be provided as a plastic material.

The object-side third surface S3 of the second lens 502 is concave with respect to the optical axis OA, and the fourth surface S4 on the sensor-side may be concave. The second lens 502 may have a concave shape on both sides. The second lens 502 is made of a plastic material and may have an aspherical surface. The aspherical coefficients of the third and fourth surfaces S3 and S4 may be provided as L2S1 and L2S2 of FIG. 36.

The third lens 503 may be disposed third from the object side. The third lens 503 may be disposed fourth from the sensor side. The third lens 503 may be disposed between the second lens 502 and the fourth lens 504. The third lens 503 may have positive (+) refractive power on the optical axis OA. The third lens 503 may include a plastic or glass material. For example, the third lens 503 may be provided as a plastic material.

The object-side fifth surface S5 of the third lens 503 may be convex with respect to the optical axis, and the sensor-side sixth surface S6 may be convex. The third lens 503 may have a shape in which both sides are convex with respect to the optical axis OA. The third lens 503 may be made of a plastic material and may have an aspherical surface. The aspherical coefficients of the fifth and sixth surfaces S5 and S6 may be provided as L3S1 and L3S2 of FIG. 36.

The aperture (STOP) may be disposed around the sensor-side sixth surface S6 of the third lens 503. The aperture (STOP) may be disposed around the object-side seventh surface S7 of the fourth lens 503. The aperture can reduce the TTL within the field of view range, enabling miniaturization of the optical system. Accordingly, a decrease in the yield by weight of the optical system can be prevented, and production efficiency can be improved. In addition, the optical system can be miniaturized by reducing the TTL within the horizontal field of view (FOV_H) of 20 to 35 degrees.

The fourth lens 504 may be disposed fourth from the object side. The fourth lens 504 may be disposed third from the sensor side. The fourth lens 504 may be disposed between the third lens 503 and the fifth lens 505. The fourth lens 504 may have negative (−) refractive power. The fourth lens 504 may include a plastic or glass material. For example, the fourth lens 504 may be provided as a plastic material.

The object-side seventh surface S7 of the fourth lens 504 may be concave with respect to the optical axis, and the sensor-side eighth surface S8 may be convex. The fourth lens 504 may have a meniscus shape with a convex sensor side. The fourth lens 504 may be made of a plastic material and may have an aspherical surface. The aspherical coefficients of the seventh and eighth surfaces S7 and S8 may be provided as L4S1 and L4S2 of FIG. 36.

The fifth lens 505 may be disposed as the fifth lens from the object side. The fifth lens 505 may be disposed as the second lens from the sensor side. The fifth lens 505 may be disposed between the fourth lens 504 and the sixth lens 506. The fifth lens 505 may have positive (+) or negative (−) refractive power on the optical axis OA. The fifth lens 505 may have positive (+) refractive power. The fifth lens 505 may include a plastic or glass material. For example, the fifth lens 505 may be provided as a plastic material.

With respect to the optical axis OA, the ninth surface S9 on the object side of the fifth lens 505 may be concave, and the tenth surface S10 on the sensor side may be convex. The fifth lens 505 may have a meniscus shape convex toward the sensor side. The fifth lens 505 may be made of a plastic material and may have an aspherical surface. The aspherical coefficients of the ninth and tenth surfaces S9 and S10 may be provided as L5S1 and L5S2 of FIG. 36.

The sixth lens 506 may be disposed closest to the sensor side. The sixth lens 506 may be disposed furthest from the object side. The sixth lens 506 may have negative (−) refractive power. The sixth lens 506 may include a plastic or glass material. For example, the sixth lens 506 may be provided as a plastic material.

With respect to the optical axis OA, the eleventh surface S11 on the object side of the sixth lens 506 may be convex, and the twelfth surface S12 on the sensor side may be concave. The sixth lens 506 may have a meniscus shape that is convex on the object side. At least one or both of the eleventh surface S11 and the twelfth surface S12 may be aspherical. The aspherical coefficients of the eleventh and twelfth surfaces S11 and S12 may be provided as L6S1 and L6S2 of FIG. 36.

TABLE 14

| | | | | | | Semi |
|---|---|---|---|---|---|---|
| Lens | Surface | Radius | Thickness | nd | vd | Aperture |
| 1 | S1 | 14.422 | 2.069 | 1.621 | 25.171 | 2.800 |
| | S2 | −19.220 | 1.506 | | | 2.609 |
| 2 | S3 | −12.045 | 0.531 | 1.571 | 37.549 | 2.315 |
| | S4 | 4.638 | Variable(D1) | | | 2.330 |
| 3 | S5 | 4.333 | 1.955 | 1.537 | 55.709 | 2.500 |
| | S6(STOP) | −5.286 | 0.135 | | | 2.481 |
| 4 | S7 | −7.412 | 3.000 | 1.670 | 20.118 | 2.432 |
| | S8 | −20.642 | Variable(D2) | | | 2.324 |
| 5 | S9 | −8.252 | 3.000 | 1.680 | 19.240 | 2.605 |
| | S10 | −8.077 | 0.134 | | | 2.512 |
| 6 | S11 | 5.158 | 1.013 | 1.537 | 55.708 | 2.492 |
| | S12 | 3.181 | Variable(D3) | | | 2.489 |
| Filter | S13 | Infinity | 0.210 | | | |
| | S14 | Infinity | 0.890 | | | |
| Image | | Infinity | | | | |

Table 14 shows the surface number (Surface), radius of curvature (Radius), center thickness of each lens or distance between lens surfaces (Thickness), refractive index (Index,nd), Abbe number (Abbe,vd), effective radius (Semi Aperture), and focal length (Focal length) of the lens according to a fifth embodiment of the present invention. At this time, the unit of the radius of curvature and thickness or distance may be mm.

TABLE 15

| | wide | middle | tele |
|---|---|---|---|
| D1 | 4.746 | 2.002 | 0.630 |
| D2 | 2.867 | 1.657 | 2.183 |
| D3 | 1.945 | 5.899 | 6.745 |

Table 15 shows the gaps D1, D2, and D3 between lenses that are variable when the optical system according to the fifth embodiment of the present invention operates in any one among the first to third modes. Here, the first mode may refer to the wide-angle end (wide), the second mode may refer to the intermediate end (middle), and the third mode may refer to the telephoto end (tele). The wide-angle end may be referred to as a wide angle, and the telephoto end may be referred to as a telephoto.

In the optical system according to the fifth embodiment of the present invention, the distance between adjacent lens groups may change during the process of changing the magnification from the first mode to the third mode. The first lens group G1 is fixed, and only the second and third lens groups G2 and G3 can move. The first lens group G1 may be a fixed group, and the second and third lens groups G2 and G3 may be movable groups.

When operating from the first mode to the second mode, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the second mode to the third mode, the distance D1 between the first lens group G1 and the second lens group G2 may decrease the distance D2 between the second lens group G2 and the third lens group G3 may increase, and the distance D3 between the third lens group G3 and the filter 800 may increase.

When operating from the first mode to the third mode, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

The stroke length of the second lens group G2 can satisfy 4 mm to 4.5 mm, and preferably, can satisfy about 4.116 mm. The stroke length of the third lens group G3 can satisfy 4.5 mm to 5 mm, and preferably, can satisfy about 4.8 mm. The stroke length of the second lens group G2 can be smaller than the stroke length of the third lens group G3. The second lens group G2 and the third lens group G3 can have different moving speeds. The moving speed of the third lens group G3 can be greater than the moving speed of the second lens group G2.

By moving the second lens group G2 and the third lens group G3, the magnification of the zoom optical system can be continuously adjusted from about 3 times to about 7 times. Here, the magnification may mean the ratio of the focal lengths of the reference optical system center thickness together with the optical system according to the embodiment in the mobile terminal. In the fourth embodiment, the magnifications of the wide-angle end and the telephoto end can satisfy a range of 1.5 times to 2 times, and can satisfy a magnification of about 1.8 times.

TABLE 16

| | | | |
|---|---|---|---|
| EFL(f)_wide | 10.247 | EFL(f)_tele | 19.130 |
| BFL_wide | 3.045 | BFL_tele | 7.845 |
| EPD_wide | 3.982 | EPD_tele | 4.008 |
| SD_wide | 13.0594 | SD_tele | 13.0594 |
| Fno_wide | 2.573 | Fno_tele | 4.773 |
| FOV_wide | 13.9193 | FOV_tele | 7.4709 |
| f1 | 13.596 | f_G1 | −14.88 |
| f2 | −5.802 | f_G2 | 6.48 |
| f3 | 4.772 | f_G3 | −22.17 |
| f4 | −18.974 | G2_stroke | 4.116 |
| f5 | 70.634 | G3_stroke | 4.800 |
| f6 | −18.822 | TTL | 24.000 |
| ET1 | 1.6321 | ImgH | 5.0400 |
| ET2 | 1.1663 | CA_Max | 5.600 |
| ET3 | 0.7469 | CA_Min | 4.610 |
| ET4 | 3.2626 | CA_Aver | 4.931 |
| ET5 | 2.9024 | L_CT_max | 3.000 |
| ET6 | 1.3245 | L_CT_min | 0.531 |
| | | L_CT_aver | 1.928 |
| | | Air_max | 4.746 |

Table 16 shows the items of Mathematical expressions described above in the optical system 1400 of the fourth embodiment, and the effective focal length (F) (mm), BFL (Back Focal Length) (mm), EPD (mm), SD (mm), Fno, FOV (degree) which is the optical axis distance from the aperture (STOP) to the twelfth surface S12 at each of the wide-angle end (wide) and the telephoto end (tele) of the optical system 1400, and the focal lengths (f1 to f6) (mm), edge thicknesses (ET1 to ET6) of the first to sixth lenses 501 to 506, the focal lengths (f_G1, f_G2, and f_G3) (mm) of the first to third lens groups G1, G2, and G3, the stroke length (G2_stroke) of the second lens group G2, the stroke length (G3_stroke) of the third lens group G3, and the optical system 1400 This is for the total optical axis distance TTL (mm), ImgH (mm), maximum effective diameter (CA_Max), minimum effective diameter (CA_Min), average effective diameter (CA_Aver), maximum center thickness (L_CT_max), minimum center thickness (L_CT_min), average center thickness (L_CT_aver) among the first to sixth lenses 501 to 506, and maximum value among adjacent lens gaps (Air_max).

The center thicknesses of the first to sixth lenses 501 to 506 are represented by CT1 to CT6, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. BFL (Back focal length) is the optical axis distance from the image sensor 700 to the center of the last lens. TTL is the optical axis distance from the center of the first surface S1 of the first lens 501 to the upper surface of the image sensor 700.

When comparing the absolute values of the curvature radius of each lens, the curvature radius of the second surface S2 of the first lens 501 on the optical axis OA may be the largest among the lenses, and the curvature radius of the twelfth surface S12 of the sixth lens 506 may be the smallest among the lenses. The difference between the maximum curvature radius and the minimum curvature radius may be 5 times or more, for example, 6 to 7 times. The absolute value of the curvature radius of the first surface S1 of the first lens 501 may be smaller than the absolute value of the curvature radius of the second surface S2. The absolute value of the curvature radius of the third surface S3 of the second lens 502 may be larger than the absolute value of the curvature radius of the fourth surface S4. The absolute value of the curvature radius of the fifth surface S5 of the third lens 503 may be smaller than the absolute value of the curvature radius of the sixth surface S6. The absolute value of the curvature radius of the seventh surface S7 of the fourth lens 504 may be smaller than the absolute value of the curvature radius of the eighth surface S8. The absolute value of the curvature radius of the ninth surface S9 of the fifth lens 505 may be smaller than the absolute value of the curvature radius of the tenth surface S10. The absolute value of the curvature radius of the eleventh surface S11 of the sixth lens 506 may be larger than the absolute value of the curvature radius of the twelfth surface S12.

The ratio of the radius of curvature of each lens can satisfy the following conditions.

$$0.5 < \vert L 1 R 1 / L 1 R 2 \vert < 1 \qquad Condition 1$$

$$2 < \vert L 2 R 1 / L 2 R 2 \vert < 3 \qquad Condition 2$$

$$0.5 < \vert L 3 R 1 / L 3 R 2 \vert < 1 \qquad Condition 3$$

$$0.1 < \vert L 4 R 1 / L 4 R 2 \vert < 0.5 \qquad Condition 4$$

$$0.8 < \vert L 5 R 1 / L 5 R 2 \vert < 1.2 \qquad Condition 5$$

$$1.3 < L 6 R 1 / L 6 R 2 < 1.7 \qquad Condition 6$$

When describing the center thickness of the lenses with respect to the optical axis, the center thickness CT4 of the fourth lens 504 or the center thickness CT5 of the fifth lens 505 is the largest among the lenses, and the center thickness CT2 of the second lens 502 is the smallest among the lenses. The difference between the maximum center thickness and the minimum center thickness among the lenses may be in the range of 2 mm or more and 3 mm or less.

The center thickness of each lens can satisfy any one among the conditions below.

$$CT 4 , CT 5 > CT 1 > CT 2 , CT 3 , CT 6 \qquad Condition 1$$

$$CT 1 , CT 3 , CT 4 , CT 5 , CT 6 > CT 2 \qquad Condition 2$$

$$CT 1 , CT 4 , CT 5 > CT 3 > CT 2 , CT 6 \qquad Condition 3$$

$$CT 4 = CT 5 > CT 1 , CT 2 , CT 3 , CT 6 \qquad Condition 4$$

$$CT 1 , CT 3 , CT 4 , CT 5 > CT 6 > CT 2 \qquad Condition 5$$

When zooming, the gap CG1 between the first lens 501 and the second lens 502, the gap CG3 between the third lens 503 and the fourth lens 504, and the gap CG5 between the fifth lens 505 and the sixth lens 506 do not change, while the gap CG2 between the second lens 502 and the third lens 503, and the gap CG4 between the fourth lens 504 and the fifth lens can change. Among the center gaps between the lenses that do not change, the center gap CG1 between the first lens 501 and the second lens 502 can be the maximum, and the center gap CG5 between the fifth and sixth lenses 505 and 506 can be the minimum. The difference between the maximum center gap and the minimum center gap among the spaced lens gaps can be 5.5 mm or more, for example, in the range of 5.8 mm to 6.5 mm.

The center gap between each lens may satisfy the following condition.

$$CG 1 > CG 3 > CG 5 \qquad Condition 1$$

Referring to FIG. 56, optical members 71 and 72 may be disposed on one surface of the first to sixth lenses 501 to 506. For example, since the gap between the first lens 501 and the second lens 502 on the optical axis direction is the largest, the first optical member 71 may be disposed in the ineffective area of one surface of the lens to prevent a flare phenomenon due to diffuse reflection. The first optical member 71 may be a light-shielding film. A second optical member 72 may be disposed to connect the first lens 501 and the second lens 502. The second optical member 72 may be an injection-molded part. A pattern may be formed on one surface of the second optical member 72 on the optical axis direction. The pattern formed on one surface of the second optical member 72 can prevent diffusely reflected light from entering the image sensor 700.

When explaining the effective diameter, the lens having the maximum effective diameter may be the first lens 501. Here, the effective diameter is the average of the effective diameters of the object-side surface and the sensor-side surface of each lens. The lens surface having the maximum effective diameter may be the first surface S1 of the first lens 501. The lens having the minimum effective diameter may be the second lens 502. The lens surface having the minimum effective diameter may be the third surface S3 of the second lens 502.

The effective diameter (CA_L1) of the first lens 501 may be larger than the diagonal length of the image sensor 700. The average effective diameter of the second to sixth lenses 502 to 506 may be smaller than the diagonal length of the image sensor 700. Accordingly, light incident through a plurality of lenses aligned along the optical axis can be guided to the image sensor 700.

The effective diameter of each lens can satisfy any one among the conditions below.

$$CA\_L1 > CA\_L2 , CA\_L3 , CA\_L4 , CA\_L5 , CA\_L6 \qquad Condition 1$$

$$CA\_L1 , CA\_L3 , CA\_L4 , CA\_L5 , CA\_L6 > CA\_L2 \qquad Condition 2$$

$$CA\_L1 > CA\_L3 = CA\_L6 > CA\_L2 , CA\_L4 , CA\_L5 \qquad Condition 3$$

$$CA\_L1 , CA\_L3 , CA\_L5 , CA\_L6 > CA\_L4 > CA\_L2 \qquad Condition 4$$

$$CA\_L1 , CA\_L3 , CA\_L6 > CA\_L5 > CA\_L2 , CA\_L4 \qquad Condition 6$$

When explaining the refractive index, the refractive index of the fifth lens 505 may be the highest among the lenses and may be greater than 1.6, for example, greater than 1.65. One or all among the second lens 502, the third lens 503, and the sixth lens 506 may have the lowest refractive index among the lenses. For example, the refractive indices of the second lens 502, the third lens 503, and the sixth lens 506 may be the lowest among the lenses and may be less than 1.6, for example, less than 1.55. The difference between the maximum refractive index and the minimum refractive index may be 0.13 or more.

The refractive index of each lens can satisfy any one of the conditions below.

$$n 4 , n 5 > n 1 > n 2 , n 3 , n 6 \qquad Condition 1$$

$$n 1 , n 4 , n 5 > n 2 = n 3 = n 6 \qquad Condition 2$$

$$n 5 > n 4 > n 1 , n 2 , n 3 , n 6 \qquad Condition 3$$

$$n 5 > n 1 , n 2 , n 3 , n 4 , n 6 \qquad Condition 4$$

Comparing the Abbe numbers, the Abbe number of any one among the second lens 502, the third lens 503, and the sixth lens 506 is the largest among the lenses and may be 50 or more. The Abbe number of the fifth lens 505 is the smallest among the lenses and may be 25 or less. The difference between the maximum refractive index and the minimum Abbe number may be 30 or more.

The Abbe number of each lens can satisfy any one among the conditions below.

$$v 2 , v 3 , v 6 > v 1 > v 4 , v 5 \qquad Condition 1$$

$$v 2 = v 3 = v 6 > v 1 , v 4 , v 5 \qquad Condition 2$$

$$v 1 , v 2 , v 3 , v 6 > v 4 > v 5 \qquad Condition 3$$

$$v 1 , v 2 , v 3 , v 4 , v 6 > v 5 \qquad Condition 4$$

The focal lengths F1, F3, and F5 of the first, third, and fifth lenses 501, 503, and 505 may have positive (+) signs. The first, third, and fifth lenses 501, 503, and 505 may have positive (+) refractive power. The focal lengths F2, F4, and F6 of the second, fourth, and sixth lenses 502, 504, and 506 may have negative (−) signs. The second, fourth, and sixth lenses 502, 504, and 506 may have negative (−) refractive power.

When comparing the focal lengths in absolute values, the focal length of the fifth lens 505 is the largest among the lenses, and may be 65 or more and 75 or less. The focal length of the third lens 503 is the smallest among the lenses, and the absolute value of the focal length of the third lens 503 may be 4 or more and 7 or less.

The absolute value of the focal length of each lens can satisfy any one among the conditions below.

$$\vert f 4 \vert , \vert f 5 \vert , \vert f 6 \vert > \vert f 1 \vert > \vert f 2 \vert , \vert f 3 \vert \qquad Condition 1$$

$$\vert f 1 \vert , \vert f 4 \vert , \vert f 5 \vert , \vert f 6 \vert > \vert f 2 \vert > \vert f 3 \vert \qquad Condition 2$$

$$\vert f 1 \vert , \vert f 2 \vert , \vert f 4 \vert , \vert f 5 \vert , \vert f 6 \vert > \vert f 3 \vert \qquad Condition 3$$

$$\vert f 5 \vert > \vert f 4 \vert > \vert f 1 \vert , \vert f 2 \vert , \vert f 3 \vert , \vert f 6 \vert \qquad Condition 4$$

$$\vert f 5 \vert > \vert f 1 \vert , \vert f 2 \vert , \vert f 3 \vert , \vert f 4 \vert , \vert f 6 \vert \qquad Condition 5$$

$$\vert f 4 \vert , \vert f 5 \vert > \vert f 6 \vert > \vert f 1 \vert , \vert f 2 \vert , \vert f 3 \vert \qquad Condition 6$$

The composite focal length (f_G1) of the first lens group G1 can have a positive (+) sign. The first lens group G1 can have positive (+) composite refractive power. The composite focal length (f_G2) of the second lens group G2 can have a negative (−) sign. The second lens group G2 can have negative (−) composite refractive power. The composite focal length (f_G3) of the third lens group G3 can have a positive (+) sign. The third lens group G3 can have positive (+) composite refractive power. Through this, light incident from the object side can move away from the optical axis direction and then gather back on the optical axis direction, thereby forming a stable optical path.

When comparing the absolute values of the composite focal lengths of the first to third lens groups G1, G2, and G3, the composite focal length of the third lens group G3 may be the largest, and the composite focal length of the second lens group G2 may be the smallest. The relationship between the composite focal lengths of the first to third lens groups G1, G2, and G3 may satisfy |f_G3|>|f_G1|>f_G2.

The difference between the maximum and minimum thickness T1 of the first lens 501 may be 1.5 times or more, for example, in the range of 1.5 to 2 times, and its center thickness CT1 may be a maximum and its edge thickness ET1 may be a minimum. The maximum thickness T2 of the second lens 502 may be in the range of 1.8 to 2.3 times the minimum thickness. The second lens 402 may have a minimum center thickness CT2 and a maximum edge thickness ET2. The thickness T3 of the third lens 503 may be a maximum at the center and a minimum at the edge, with the maximum thickness being in the range of 2.5 to 3 times the minimum thickness. The thickness T4 of the fourth lens 504 may be a minimum at the center and a maximum at the edge, with the maximum thickness being in the range of 1 to 1.5 times the minimum thickness. The thickness T5 of the fifth lens 505 may be a maximum at the center and a minimum at the edge, with the maximum thickness being in the range of 1 to 1.5 times the minimum thickness. The thickness T6 of the sixth lens 406 may be a minimum at the center and a maximum at the edge, with the maximum thickness being in the range of 1.2 to 1.5 times the minimum thickness.

The thickness of each lens can satisfy any one among the conditions below.

$$1 < CT 1 / ET 1 < 1.5 , 0.5 < ET 1 / CT 1 < 1 \qquad Condition 1$$

$$0.3 < CT 2 / ET 2 < 0.5 , 1.9 < ET 2 / CT 2 < 2.2 \qquad Condition 2$$

$$2.5 < CT 3 / ET 3 < 3 , 0.1 < ET 3 / CT 3 < 0.5 \qquad Condition 3$$

$$0.5 < CT 4 / ET 4 < 1 , 1 < ET 4 / CT 4 < 1.2 \qquad Condition 4$$

$$1 < CT 5 / ET 5 < 1.2 , 0.5 < ET 5 / CT 5 < 1 \qquad Condition 5$$

$$0.5 < CT 6 / ET 6 < 1 , 1.2 < ET 6 / CT 6 < 1.5 \qquad Condition 6$$

$$1 < \sum CT / \sum ET < 1.5 , 0.5 < \sum ET / \sum CT < 1 \qquad Condition 7$$

Among the gaps G1 to G6 between the lenses, the gap G1 between the first and second lenses 501 and 502 may have a maximum in the center and a minimum in the edge. The gap G2 between the second and third lenses 502 and 503 may have a maximum in the edge and a minimum in the center. The gap G3 between the third and fourth lenses 503 and 504 may have a maximum in the edge and a minimum in the center. The gap G4 between the fourth and fifth lenses 504 and 505 may have a minimum in the edge and a maximum in the center. The fifth gap G5 between the fifth and sixth lenses 505 and 506 may have a minimum in the center and a maximum in the edge.

FIGS. 37, 39, and 41 are graphs showing the diffraction MTF (Modulation Transfer Function) at the wide-angle end (wide), intermediate end (mid), and telephoto end (tele) in the optical system of FIG. 35, and are graphs showing the luminance ratio (modulation) according to the spatial frequency. As shown in FIGS. FIGS. 37, 39, and 41, in the fifth embodiment of the invention, the deviation of the MTF with respect to the intermediate end (mid) at low or high temperature may be less than 10%, which is, 7% or less.

FIGS. 38, 40, and 42 are graphs showing aberration characteristics at the wide-angle end (wide), intermediate end (mid), and telephoto end (tele) in the optical systems of FIGS. 33 to 35. In the aberration graphs of FIGS. 38, 40, and 42, spherical aberration (longitudinal spherical aberration), astigmatic field curves, and distortion are measured from left to right. In FIGS. 38, 40, and 42, the X-axis may represent the focal length (mm) and distortion (%), and the Y-axis may represent the height of the image. In addition, the graphs for spherical aberration are graphs for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 38, 40, and 42, the closer the curves at the wide-angle end (wide), intermediate end (mid), and telephoto end (tele) are to the Y-axis, the better the aberration correction function can be interpreted. It can be seen that the optical system 1400 according to the fifth embodiment has measured values close to the Y-axis in almost all areas. That is, the optical system 1400 according to the fifth embodiment has improved resolution and can have good optical performance not only in the central portion of the field of view (FOV) but also in the peripheral portion.

An optical system according to the sixth embodiment of the invention will be described.

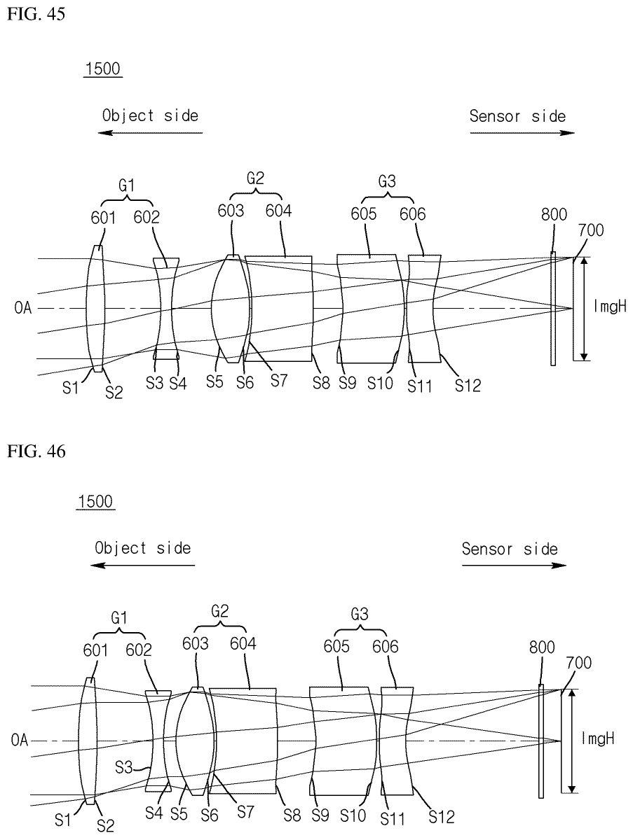

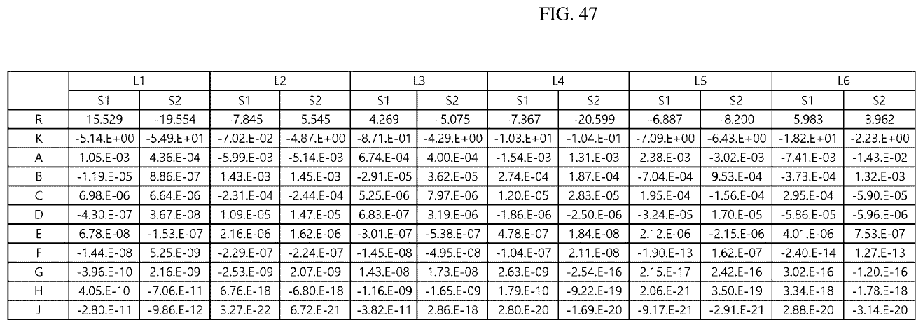

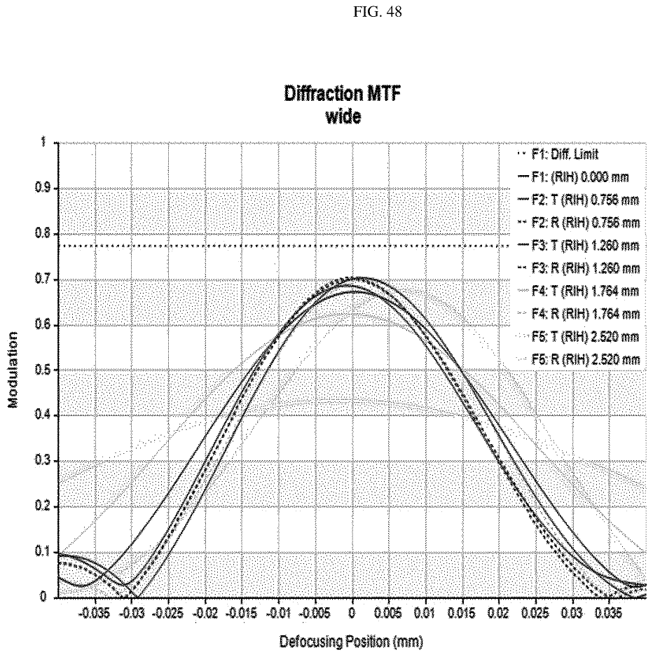

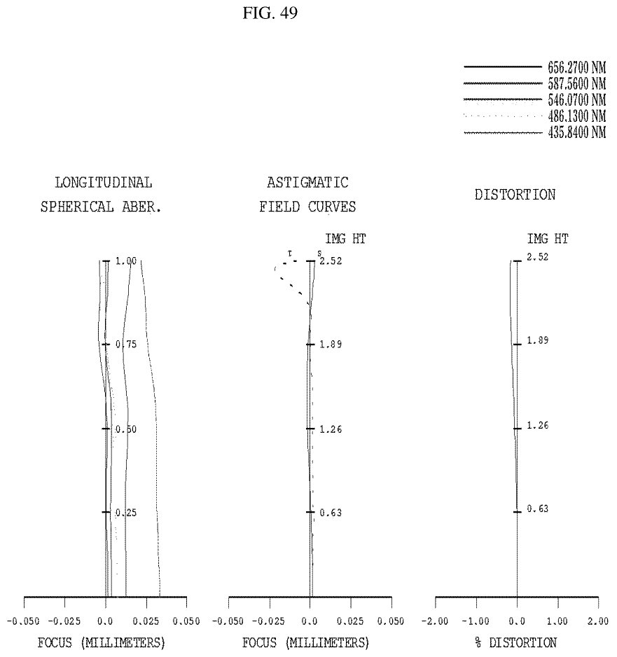

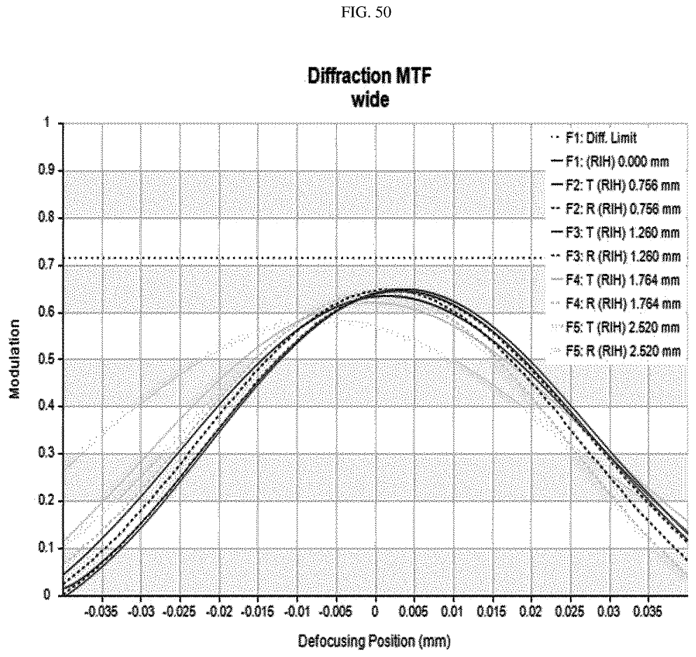

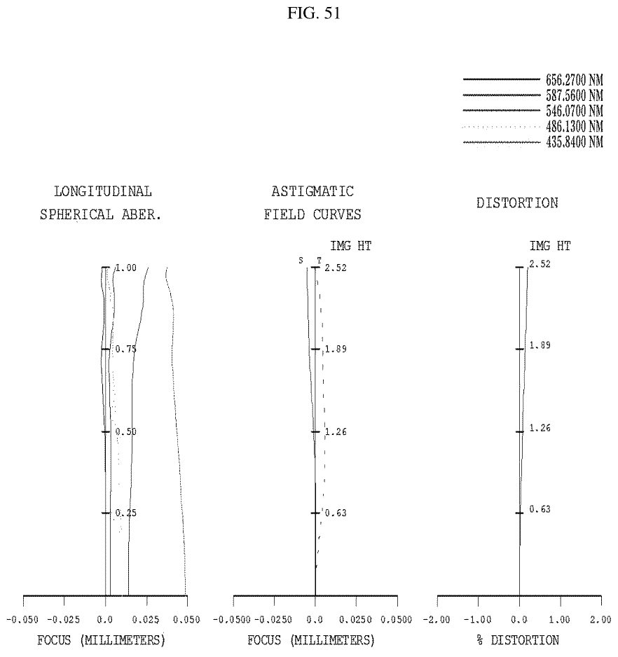

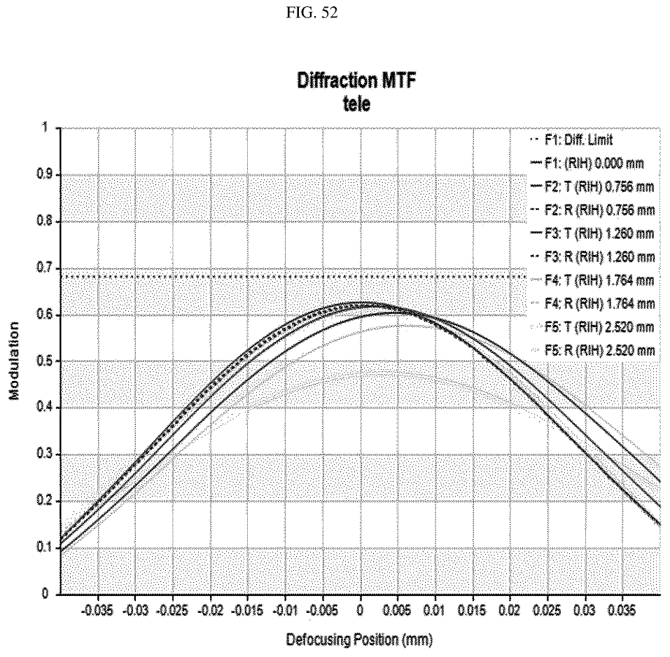

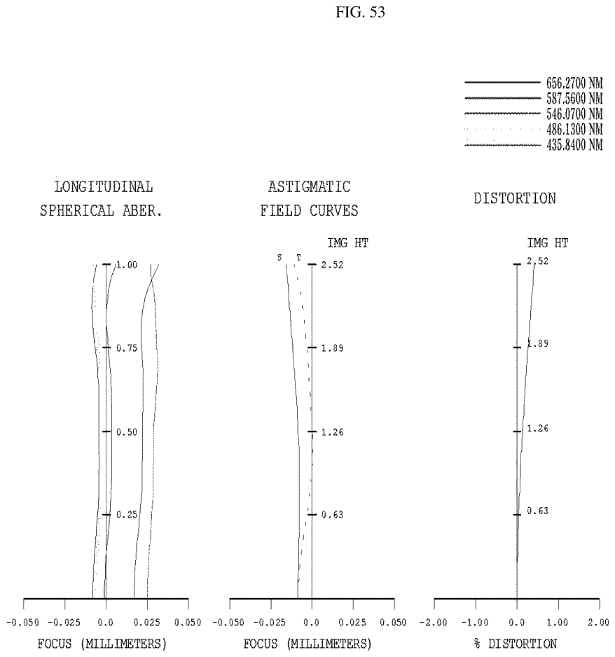

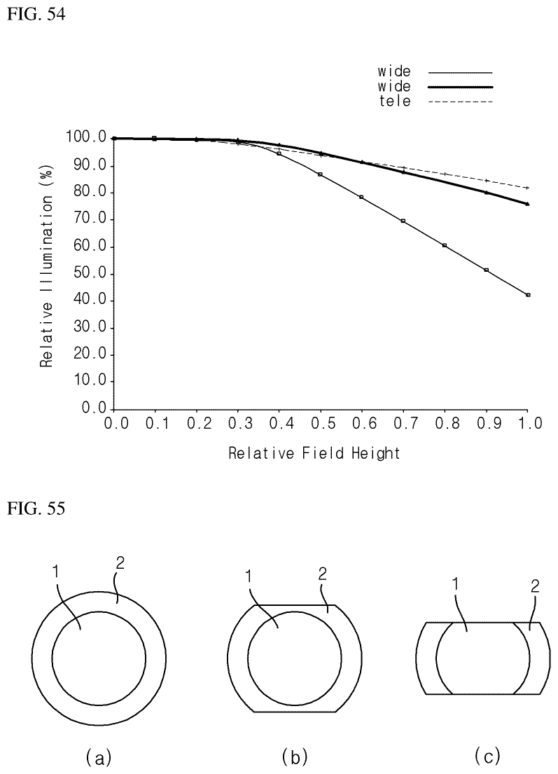

FIG. 44 is a diagram showing a configuration of an optical system according to a sixth embodiment operating in a first mode; FIG. 45 is a diagram showing a configuration of an optical system according to a sixth embodiment operating in a second mode; FIG. 46 is a diagram showing a configuration of an optical system according to a sixth embodiment operating in a third mode; FIG. 47 is a table showing aspherical coefficients of lenses in an optical system according to a sixth embodiment; FIG. 48 is a graph showing data on diffraction MTF (Modulation Transfer Function) at room temperature of an optical system according to a sixth embodiment operating in a first mode; FIG. 49 is a graph showing data on aberration characteristics of an optical system according to a sixth embodiment operating in a first mode; FIG. 50 is a graph showing data on diffraction MTF (Modulation Transfer Function) at room temperature of an optical system according to a sixth embodiment operating in the second mode; FIG. 51 is a graph showing data on aberration characteristics of an optical system according to a sixth embodiment operating in a second mode; FIG. 52 is a graph showing data on diffraction MTF (Modulation Transfer Function) at room temperature of an optical system according to a sixth embodiment operating in a third mode; FIG. 53 is a graph showing data on aberration characteristics of an optical system according to a sixth embodiment operating in a third mode; and FIG. 54 is a graph showing data on relative illumination versus relative field of an optical system according to a sixth embodiment.

Referring to FIGS. 44 to 25, the optical system 1500 includes a lens unit, and the lens unit may include a first lens 601 to a sixth lens 606. The first to sixth lenses 601 to 606 may be sequentially disposed along the optical axis OA of the optical system 1500. Light corresponding to information about an object may pass through the first to sixth lenses 601 to 606 and the filter 800 and be incident on the image sensor 700.

The first lens 601 may be disposed closest to the object side. The first lens 601 may be disposed furthest from the sensor side. The first lens 601 may have positive (+) refractive power on the optical axis OA. The first lens 601 may include a plastic material or a glass material, and may be, for example, a plastic material.

The object-side first surface S1 of the first lens 601 may be convex with respect to the optical axis, and the sensor-side second surface S2 may be convex. The first lens 601 may have a convex shape on both sides. The first lens 601 may be made of a plastic material and may have an aspherical surface. The aspherical coefficients of the first and second surfaces S1 and S2 may be provided as L1S1, L1S2 of FIG. 47.

The refractive index n1 of the first lens 601 can satisfy the condition of n1>1.5, preferably n1>1.55. If the refractive index (n1) of the first lens 601 is less than the condition, the lens surface must be formed sharply concave or convex in order to increase the refractive power of the first and second lenses 601 and 602. In this case, lens manufacturing is not easy, the lens defect rate increases, and it may cause a decrease in yield.

The second lens 602 may be disposed second from the object side. The second lens 602 may be disposed fifth from the sensor side. The second lens 602 may be disposed between the first lens 601 and the third lens 603. The second lens 602 may have negative (−) refractive power on the optical axis OA. The second lens 602 may have different refractive power from the first lens 601 on the optical axis OA. The second lens 602 may include a plastic or glass material. For example, the second lens 602 may be provided as a plastic material.

The object-side third surface S3 of the second lens 602 is concave with respect to the optical axis OA, and the fourth surface S4 on the sensor-side may be concave. The second lens 602 may have a concave shape on both sides. The second lens 602 is made of a plastic material and may have an aspherical surface. The aspherical coefficients of the third and fourth surfaces S3 and S4 may be provided as L2S1 and L2S2 of FIG. 47.

The third lens 603 may be disposed third from the object side. The third lens 603 may be disposed fourth from the sensor side. The third lens 603 may be disposed between the second lens 602 and the fourth lens 604. The third lens 603 may have positive (+) refractive power on the optical axis OA. The third lens 603 may include a plastic or glass material. For example, the third lens 603 may be provided as a plastic material.

The object-side fifth surface S5 of the third lens 603 may be convex with respect to the optical axis, and the sensor-side sixth surface S6 may be convex. The third lens 603 may have a shape in which both sides are convex with respect to the optical axis OA. The third lens 603 may be made of a plastic material and may have an aspherical surface. The aspherical coefficients of the fifth and sixth surfaces S5 and S6 may be provided as L3S1 and L3S2 of FIG. 47.

The aperture (STOP) may be disposed around the sensor-side sixth surface S6 of the third lens 603. The aperture (STOP) may be disposed around the object-side seventh surface S7 of the fourth lens 603. The aperture can reduce the TTL within the field of view range, enabling miniaturization of the optical system. Accordingly, a decrease in the yield by weight of the optical system can be prevented, and production efficiency can be improved. In addition, the optical system can be miniaturized by reducing the TTL within the horizontal field of view (FOV_H) of 20 to 35 degrees.

The fourth lens 604 may be disposed fourth from the object side. The fourth lens 604 may be disposed third from the sensor side. The fourth lens 604 may be disposed between the third lens 603 and the fifth lens 605. The fourth lens 604 may have negative (−) refractive power. The fourth lens 604 may include a plastic or glass material. For example, the fourth lens 604 may be provided as a plastic material.

The object-side seventh surface S7 of the fourth lens 604 may be concave with respect to the optical axis, and the sensor-side eighth surface S8 may be convex. The fourth lens 604 may have a meniscus shape with a convex sensor side. The fourth lens 604 may be made of a plastic material and may have an aspherical surface. The aspherical coefficients of the seventh and eighth surfaces S7 and S8 may be provided as L4S1 and L4S2 of FIG. 47.

The fifth lens 605 may be disposed as the fifth lens from the object side. The fifth lens 605 may be disposed as the second lens from the sensor side. The fifth lens 605 may be disposed between the fourth lens 604 and the sixth lens 606. The fifth lens 605 may have positive (+) or negative (−) refractive power on the optical axis OA. The fifth lens 605 may have positive (+) refractive power. The fifth lens 605 may include a plastic or glass material. For example, the fifth lens 605 may be provided as a plastic material.

With respect to the optical axis OA, the ninth surface S9 on the object side of the fifth lens 605 may be concave, and the tenth surface S10 on the sensor side may be convex. The fifth lens 605 may have a meniscus shape convex toward the sensor side. The fifth lens 605 may be made of a plastic material and may have an aspherical surface. The aspherical coefficients of the ninth and tenth surfaces S9 and S10 may be provided as L5S1 and L5S2 of FIG. 47.

The sixth lens 606 may be disposed closest to the sensor side. The sixth lens 606 may be disposed furthest from the object side. The sixth lens 606 may have negative (−) refractive power. The sixth lens 606 may include a plastic or glass material. For example, the sixth lens 606 may be provided as a plastic material.

With respect to the optical axis OA, the eleventh surface S11 on the object side of the sixth lens 606 may be convex, and the twelfth surface S12 on the sensor side may be concave. The sixth lens 606 may have a meniscus shape that is convex on the object side. At least one or both of the eleventh surface S11 and the twelfth surface S12 may be aspherical. The aspherical coefficients of the eleventh and twelfth surfaces S11 and S12 may be provided as L6S1 and L6S2 of FIG. 47.

TABLE 17

| | | | | | | Semi |
|---|---|---|---|---|---|---|
| Lens | Surface | Radius | Thickness | nd | vd | Aperture |
| 1 | S1 | 15.529 | 0.929 | 1.566 | 38.255 | 2.800 |
| | S2 | −19.554 | 2.769 | | | 2.740 |
| 2 | S3 | −7.845 | 0.500 | 1.537 | 55.709 | 2.606 |
| | S4 | 5.545 | Variable(D1) | | | 2.210 |
| 3 | S5 | 4.269 | 1.883 | 1.537 | 55.709 | 2.370 |
| | S6(STOP) | −5.075 | 0.125 | | | 2.362 |
| 4 | S7 | −7.367 | 3.000 | 1.666 | 20.551 | 2.311 |
| | S8 | −20.599 | Variable(D2) | | | 2.213 |
| 5 | S9 | −6.887 | 3.000 | 1.680 | 19.240 | 2.165 |
| | S10 | −8.200 | 0.127 | | | 2.389 |
| 6 | S11 | 5.983 | 1.313 | 1.537 | 55.708 | 2.356 |
| | S12 | 3.962 | Variable(D3) | | | 2.357 |
| Filter | | Infinity | 0.210 | | | |
| | | Infinity | 0.890 | | | |
| Image | | Infinity | | | | |

Table 17 shows the surface number (Surface), radius of curvature (Radius), center thickness of each lens or distance between lens surfaces (Thickness), refractive index (Index,nd), Abbe number (Abbe,vd), effective radius (Semi Aperture), and focal length (Focal length) of the lens according to a fifth embodiment of the present invention. At this time, the unit of the radius of curvature and thickness or distance may be mm.

TABLE 18

| | wide | middle | tele |
|---|---|---|---|
| D1 | 4.769 | 1.988 | 0.639 |
| D2 | 2.611 | 1.451 | 1.940 |
| D3 | 1.875 | 5.816 | 6.675 |

Table 18 shows the gaps D1, D2, and D3 between lenses that are variable when the optical system according to the sixth embodiment of the present invention operates in any one among the first to third modes. Here, the first mode may refer to the wide-angle end (wide), the second mode may refer to the intermediate end (middle), and the third mode may refer to the telephoto end (tele). The wide-angle end may be referred to as a wide angle, and the telephoto end may be referred to as a telephoto.

In the optical system according to the sixth embodiment of the present invention, the distance between adjacent lens groups may change during the process of changing the magnification from the first mode to the third mode. The first lens group G1 is fixed, and only the second and third lens groups G2 and G3 can move. The first lens group G1 may be a fixed group, and the second and third lens groups G2 and G3 may be movable groups.

When operating from the first mode to the second mode, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

When operating from the second mode to the third mode, the distance D1 between the first lens group G1 and the second lens group G2 may decrease the distance D2 between the second lens group G2 and the third lens group G3 may increase, and the distance D3 between the third lens group G3 and the filter 800 may increase.

When operating from the first mode to the third mode, the distance D1 between the first lens group G1 and the second lens group G2 may become smaller, the distance D2 between the second lens group G2 and the third lens group G3 may become smaller, and the distance D3 between the third lens group G3 and the filter 800 may become larger.

The stroke length of the second lens group G2 can satisfy 4 mm to 4.5 mm, and preferably can satisfy about 4.130 mm. The stroke length of the third lens group G3 can satisfy 4.5 mm to 5 mm, and preferably can satisfy about 4.8 mm. The stroke length of the second lens group G2 can be smaller than the stroke length of the third lens group G3. The second lens group G2 and the third lens group G3 can have different moving speeds. The moving speed of the third lens group G3 can be greater than the moving speed of the second lens group G2.

By moving the second lens group G2 and the third lens group G3, the magnification of the zoom optical system can be continuously adjusted from about 3 times to about 7 times. Here, the magnification may mean the ratio of the focal lengths of the reference optical system center thickness together with the optical system according to the embodiment in the mobile terminal. In the sixth embodiment, the magnifications of the wide-angle end and the telephoto end can satisfy a range of 1.5 times to 2 times, and can satisfy a magnification of about 1.8 times.

TABLE 19

| | | | |
|---|---|---|---|
| EFL(f)_wide | 10.247 | EFL(f)_tele | 19.130 |
| BFL_wide | 2.975 | BFL_tele | 7.775 |
| EPD_wide | 3.968 | EPD_tele | 5.606 |
| SD_wide | 13.0255 | SD_tele | 13.0255 |
| Fno_wide | 2.583 | Fno_tele | 3.606 |
| FOV_wide | 13.843 | FOV_tele | 7.469 |
| f1 | 15.445 | f_G1 | −14.92 |
| f2 | −5.971 | f_G2 | 6.27 |
| f3 | 4.644 | f_G3 | −23.27 |
| f4 | −18.929 | G2_stroke | 4.130 |
| f5 | −845.654 | G3_stroke | 4.800 |
| f6 | −28.241 | TTL | 24.000 |
| ET1 | 0.4875 | ImgH | 5.040 |
| ET2 | 1.4026 | CA_Max | 5.600 |
| ET3 | 0.7488 | CA_Min | 4.329 |
| ET4 | 3.2490 | CA_Aver | 4.746 |
| ET5 | 2.9356 | L_CT_max | 3.000 |
| ET6 | 1.5573 | L_CT_min | 0.500 |
| | | L_CT_aver | 1.771 |
| | | Air_max | 4.769 |

Table 19 shows the items of Mathematical expressions described above in the optical system 1500 of the fourth embodiment, and the effective focal length (F) (mm), BFL (Back Focal Length) (mm), EPD (mm), SD (mm), Fno, FOV (degree) which is the optical axis distance from the aperture (STOP) to the twelfth surface S12 at each of the wide-angle end (wide) and the telephoto end (tele) of the optical system 1500, and the focal lengths (f1 to f6) (mm), edge thicknesses (ET1 to ET6) of the first to sixth lenses 601 to 606, the focal lengths (f_G1, f_G2, and f_G3) (mm) of the first to third lens groups G1, G2, and G3, the stroke length (G2_stroke) of the second lens group G2, the stroke length (G3_stroke) of the third lens group G3, and the optical system 1500 This is for the total optical axis distance TTL (mm), ImgH (mm), maximum effective diameter (CA_Max), minimum effective diameter (CA_Min), average effective diameter (CA_Aver), maximum center thickness (L_CT_max), minimum center thickness (L_CT_min), average center thickness (L_CT_aver) among the first to sixth lenses 601 to 606, and maximum value among adjacent lens gaps (Air_max).

The center thicknesses of the first to sixth lenses 601 to 606 are represented by CT1 to CT6, the edge thicknesses at the ends of the effective areas of each lens are represented by ET1 to ET7, the center gap between two adjacent lenses is represented by CG1 to CG6, and the edge gaps between the edges of each lens are represented by EG1 to EG6. BFL (Back focal length) is the optical axis distance from the image sensor 700 to the center of the last lens. TTL is the optical axis distance from the center of the first surface S1 of the first lens 601 to the upper surface of the image sensor 700.

When comparing the absolute values of the curvature radius of each lens, the curvature radius of the second surface S2 of the first lens 601 on the optical axis OA may be the largest among the lenses, and the curvature radius of the twelfth surface S12 of the sixth lens 606 may be the smallest among the lenses. The difference between the maximum curvature radius and the minimum curvature radius may be 5 times or more, for example, 6 to 7 times. The absolute value of the curvature radius of the first surface S1 of the first lens 601 may be smaller than the absolute value of the curvature radius of the second surface S2. The absolute value of the curvature radius of the third surface S3 of the second lens 602 may be larger than the absolute value of the curvature radius of the fourth surface S4. The absolute value of the curvature radius of the fifth surface S5 of the third lens 603 may be smaller than the absolute value of the curvature radius of the sixth surface S6. The absolute value of the curvature radius of the seventh surface S7 of the fourth lens 604 may be smaller than the absolute value of the curvature radius of the eighth surface S8. The absolute value of the curvature radius of the ninth surface S9 of the fifth lens 605 may be smaller than the absolute value of the curvature radius of the tenth surface S10. The absolute value of the curvature radius of the eleventh surface S11 of the sixth lens 606 may be larger than the absolute value of the curvature radius of the twelfth surface S12.

The ratio of the radius of curvature of each lens can satisfy the following conditions.

$$0.5 < \vert L 1 R 1 / L 1 R 2 \vert < 1 \qquad Condition 1$$

$$1 < \vert L 2 R 1 / L 2 R 2 \vert < 1.5 \qquad Condition 2$$

$$0.5 < \vert L 3 R 1 / L 3 R 2 \vert < 1 \qquad Condition 3$$

$$0.1 < \vert L 4 R 1 / L 4 R 2 \vert < 0.5 \qquad Condition 4$$

$$0.5 < \vert L 5 R 1 / L 5 R 2 \vert < 1 \qquad Condition 5$$

$$1.3 < L 6 R 1 / L 6 R 2 < 1.7 \qquad Condition 6$$

When describing the central thickness of the lenses based on the optical axis, the central thickness CT4 of the fourth lens 604 or the central thickness CT5 of the fifth lens 605 is the largest among the lenses, and the central thickness CT2 of the second lens 602 is the smallest among the lenses. The difference between the maximum central thickness and the minimum central thickness among the lenses may be in the range of 2 mm or more and 3 mm or less.

The center thickness of each lens can satisfy any one among the conditions below.

$$CT 3 , CT 4 , CT 5 , CT 6 > CT 1 > CT 2 \qquad Condition 1$$

$$CT 1 , CT 3 , CT 4 , CT 5 , CT 6 > CT 2 \qquad Condition 2$$

$$CT 4 , CT 5 > CT 3 > CT 1 , CT 2 , CT 6 \qquad Condition 3$$

$$CT 4 = CT 5 > CT 1 , CT 2 , CT 3 , CT 6 \qquad Condition 4$$

$$CT 3 , CT 4 , CT 5 > CT 6 > CT 1 , CT 2 \qquad Condition 5$$

When zooming, the gap CG1 between the first lens 601 and the second lens 602, the gap CG3 between the third lens 603 and the fourth lens 604, and the gap CG5 between the fifth lens 605 and the sixth lens 606 do not change, while the gap CG2 between the second lens 602 and the third lens 603, and the gap CG4 between the fourth lens 604 and the fifth lens can change. Among the center gaps between the lenses that do not change, the center gap CG1 between the first lens 601 and the second lens 602 can be the maximum, and the center gap CG5 between the fourth and fifth lenses 604 and 605 can be the minimum. The difference between the maximum center gap and the minimum center gap among the spaced lens gaps can be 5.5 mm or more, for example, in the range of 5.8 mm to 6.5 mm.

The center gap between each lens may satisfy the following condition.

$$CG 1 > CG 3 > CG 5 \qquad Condition 1$$

Referring to FIG. 56, optical members 71 and 72 may be disposed on one surface of the first to sixth lenses 601 to 406. For example, since the gap between the first lens 601 and the second lens 602 on the optical axis direction is the largest, the first optical member 71 may be disposed in the ineffective area of one surface of the lens to prevent a flare phenomenon due to diffuse reflection. The first optical member 71 may be a light-shielding film. A second optical member 72 may be disposed to connect the first lens 601 and the second lens 602. The second optical member 72 may be an injection-molded part. A pattern may be formed on one surface of the second optical member 72 on the optical axis direction. The pattern formed on one surface of the second optical member 72 can prevent diffusely reflected light from entering the image sensor 700.

When explaining the effective diameter, the lens having the maximum effective diameter may be the first lens 601. Here, the effective diameter is the average of the effective diameters of the object-side surface and the sensor-side surface of each lens. The lens surface having the maximum effective diameter may be the first surface S1 of the first lens 601. The lens having the minimum effective diameter may be the second lens 602. The lens surface having the minimum effective diameter may be the third surface S3 of the second lens 602.

The effective diameter (CA_L1) of the first lens 601 may be larger than the diagonal length of the image sensor 700. The average effective diameter of the second to sixth lenses 602 to 606 may be smaller than the diagonal length of the image sensor 700. Accordingly, light incident through a plurality of lenses aligned along the optical axis can be guided to the image sensor 700.

The effective diameter of each lens can satisfy any one among the conditions below.

$$CA\_L1 > CA\_L2 , CA\_L3 , CA\_L4 , CA\_L5 , CA\_L6 \qquad Condition 1$$

$$CA\_L1 , CA\_L3 , CA\_L4 , CA\_L5 , CA\_L6 > CA\_L2 \qquad Condition 2$$

$$CA\_L1 > CA\_L3 > CA\_L2 , CA\_L4 , CA\_L5 , CA\_L6 \qquad Condition 3$$

$$CA\_L1 , CA\_L3 , CA\_L5 , CA\_L6 > CA\_L4 > CA\_L2 \qquad Condition 4$$

$$CA\_L1 , CA\_L3 , CA\_L6 > CA\_L5 > CA\_L2 , CA\_L4 \qquad Condition 5$$

$$CA\_L1 , CA\_L3 > CA\_L6 > CA\_L2 , CA\_L4 , CA\_L5 \qquad Condition 6$$

When explaining the refractive index, the refractive index of the fifth lens 605 may be the highest among the lenses and may be greater than 1.6, for example, greater than 1.65. One or all among the second lens 602, the third lens 603, and the sixth lens 606 may have the lowest refractive index among the lenses. For example, the refractive indices of the second lens 602, the third lens 603, and the sixth lens 606 may be the lowest among the lenses and may be less than 1.6, for example, less than 1.55. The difference between the maximum refractive index and the minimum refractive index may be 0.13 or more.

The refractive index of each lens can satisfy any one of the conditions below.

$$n 4 , n 5 > n 1 > n 2 , n 3 , n 6 \qquad Condition 1$$

$$n 1 , n 4 , n 5 > n 2 = n 3 = n 6 \qquad Condition 2$$

$$n 5 > n 4 > n 1 , n 2 , n 3 , n 6 \qquad Condition 3$$

$$n 5 > n 1 , n 2 , n 3 , n 4 , n 6 \qquad Condition 4$$

Comparing the Abbe numbers, the Abbe number of any one among the second lens 602, the third lens 603, and the sixth lens 606 is the largest among the lenses and may be 50 or more. The Abbe number of the fifth lens 605 is the smallest among the lenses and may be 25 or less. The difference between the maximum refractive index and the minimum Abbe number may be 30 or more.

The Abbe number of each lens can satisfy any one among the conditions below.

$$v 2 , v 3 , v 6 > v 1 > v 4 , v 5 \qquad Condition 1$$

$$v 2 = v 3 = v 6 > v 1 , v 4 , v 5 \qquad Condition 2$$

$$v 1 , v 2 , v 3 , v 6 > v 4 > v 5 \qquad Condition 3$$

$$v 1 , v 2 , v 3 , v 4 , v 6 > v 5 \qquad Condition 4$$

The focal lengths F1 and F3 of the first and third lenses 601 and 603 may have positive (+) signs. The first and third lenses 601 and 603 may have positive (+) refractive power. The focal lengths F2, F4, F5, and F6 of the second, fourth, fifth, and sixth lenses 602, 604, 605, and 606 may have negative (−) signs. The second, fourth, fifth, and sixth lenses 602, 604, 605, and 606 may have negative (−) refractive power.

When comparing the focal lengths in absolute values, the focal length of the fifth lens 605 is the largest among the lenses, and may be 800 or more and 850 or less. The focal length of the third lens 603 is the smallest among the lenses, and the absolute value of the focal length of the third lens 603 may be 3 or more and 5 or less.

The absolute value of the focal length of each lens can satisfy any one among the conditions below.

$$\vert f 4 \vert , \vert f 5 \vert , \vert f 6 \vert > \vert f 1 \vert > \vert f 2 \vert , \vert f 3 \vert \qquad Condition 1$$

$$\vert f 1 \vert , \vert f 4 \vert , \vert f 5 \vert , \vert f 6 \vert > \vert f 2 \vert > \vert f 3 \vert \qquad Condition 2$$

$$\vert f 1 \vert , \vert f 2 \vert , \vert f 4 \vert , \vert f 5 \vert , \vert f 6 \vert > \vert f 3 \vert \qquad Condition 3$$

$$\vert f 5 \vert , \vert f 6 \vert > \vert f 4 \vert > \vert f 1 \vert , \vert f 2 \vert , \vert f 3 \vert \qquad Condition 4$$

$$\vert f 5 \vert > \vert f 1 \vert , \vert f 2 \vert , \vert f 3 \vert , \vert f 4 \vert , \vert f 6 \vert \qquad Condition 5$$

$$\vert f 5 \vert > \vert f 6 \vert > \vert f 1 \vert , \vert f 2 \vert , \vert f 3 \vert , \vert f 4 \vert \qquad Condition 6$$

The composite focal length (f_G1) of the first lens group G1 can have a positive (+) sign. The first lens group G1 can have positive (+) composite refractive power. The composite focal length (f_G2) of the second lens group G2 can have a negative (−) sign. The second lens group G2 can have negative (−) composite refractive power. The composite focal length (f_G3) of the third lens group G3 can have a positive (+) sign. The third lens group G3 can have positive (+) composite refractive power. Through this, light incident from the object side can move away from the optical axis direction and then gather back on the optical axis direction, thereby forming a stable optical path.

When comparing the absolute values of the composite focal lengths of the first to third lens groups G1, G2, and G3, the composite focal length of the third lens group G3 may be the largest, and the composite focal length of the second lens group G2 may be the smallest. The relationship between the composite focal lengths of the first to third lens groups G1, G2, and G3 may satisfy |f_G3|>|f_G1|>f_G2.

The difference between the maximum and minimum thickness T1 of the first lens 601 may be 1.5 times or more, for example, in the range of 1.5 to 2 times, and its center thickness CT1 may be a maximum and its edge thickness ET1 may be a minimum. The maximum thickness T2 of the second lens 602 may be in the range of 1.8 to 2.3 times the minimum thickness. The second lens 602 may have a minimum center thickness CT2 and a maximum edge thickness ET2. The thickness T3 of the third lens 603 may be a maximum at the center and a minimum at the edge, with the maximum thickness being in the range of 2.5 to 3 times the minimum thickness. The thickness T4 of the fourth lens 604 may be a minimum at the center and a maximum at the edge, with the maximum thickness being in the range of 1 to 1.5 times the minimum thickness. The thickness T5 of the fifth lens 605 may be a maximum at the center and a minimum at the edge, with the maximum thickness being in the range of 1 to 1.5 times the minimum thickness. The thickness T6 of the sixth lens 606 may be a minimum at the center and a maximum at the edge, with the maximum thickness being in the range of 1 to 1.5 times the minimum thickness.

The thickness of each lens can satisfy any one among the conditions below.

$$1.5 < CT 1 / ET 1 < 2 , 0.2 < ET 1 / CT 1 < 0.7 \qquad Condition 1$$

$$0.1 < CT 2 / ET 2 < 0.5 , 2 < ET 2 / CT 2 < 2.3 \qquad Condition 2$$

$$2.3 < CT 3 / ET 3 < 2.5 , 0.1 < ET 3 / CT 3 < 0.5 \qquad Condition 3$$

$$0.5 < CT 4 / ET 4 < 1 , 1 < ET 4 / CT 4 < 1.2 \qquad Condition 4$$

$$1 < CT 5 / ET 5 < 1.2 , 0.5 < ET 5 / CT 5 < 1 \qquad Condition 5$$

$$0.5 < CT 6 / ET 6 < 1 , 1 < ET 6 / CT 6 < 1.5 \qquad Condition 6$$

$$1 < \sum CT / \sum ET < 1.5 , 0.5 < \sum ET / \sum CT < 1 \qquad Condition 7$$

Among the gaps G1 to G6 between the lenses, the gap G1 between the first and second lenses 601 and 602 may have a maximum in the center and a minimum in the edge. The gap G2 between the second and third lenses 602 and 603 may have a maximum in the edge and a minimum in the center. The gap G3 between the third and fourth lenses 603 and 604 may have a maximum in the edge and a minimum in the center. The gap G4 between the fourth and fifth lenses 604 and 605 may have a minimum in the edge and a maximum in the center. The fifth gap G5 between the fifth and sixth lenses 605 and 606 may have a minimum in the center and a maximum in the edge.

FIGS. 48, 50, and 52 are graphs showing the diffraction MTF (Modulation Transfer Function) at the wide-angle end (wide), intermediate end (mid), and telephoto end (tele) in the optical systems of FIGS. 44 to 46, and are graphs showing the luminance ratio (modulation) according to the spatial frequency. As shown in FIGS. 48, 50, and 52, in the sixth embodiment of the invention, the deviation of the MTF at low or high temperature based on the intermediate end (mid) may be less than 10%, that is, 7% or less.

FIGS. 49, 51, and 53 are graphs showing aberration characteristics at the wide-angle end (wide), intermediate end (mid), and telephoto end (tele) in the optical systems of FIGS. 44 to 46. In the aberration graphs of FIGS. 49, 51, and 53, spherical aberration (longitudinal spherical aberration), astigmatic field curves, and distortion are measured from left to right. In FIGS. 49, 51, and 53, the X-axis may represent the focal length (mm) and distortion (%), and the Y-axis may represent the height of the image. In addition, the graphs for spherical aberration are graphs for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 49, 51, and 53, the closer the curves at the wide-angle end (wide), intermediate end (mid), and telephoto end (tele) are to the Y-axis, the better the aberration correction function can be interpreted. It can be seen that the optical system 1500 according to the sixth embodiment has measured values close to the Y-axis in almost all areas. That is, the optical system 1500 according to the sixth embodiment has improved resolution and can have good optical performance not only in the central portion of the field of view (FOV) but also in the peripheral portion.

The optical systems 1300, 1400, and 1500 according to the fourth to sixth embodiment disclosed above can satisfy at least one or two or more of Mathematical expressions described below. Accordingly, the optical systems 1300, 1400, and 1500 according to the fourth to sixth embodiment can have improved optical characteristics. For example, when the optical systems 1300, 1400, and 1500 satisfy at least one Mathematical expression, the optical systems 1300, 1400, and 1500 can effectively control aberration characteristics such as chromatic aberration and distortion aberration, and can have good optical performance not only at the center of the field of view (FOV) but also at the peripheral portion. In addition, the optical systems 1300, 1400, and 1500 can have improved resolution. In addition, the thickness at the optical axis OA of the lens described in Mathematical expressions and the gap at the optical axis OA of adjacent lenses can refer to the fourth to sixth embodiments disclosed above.

$$1.5 < f\_tele / f\_wide < 2 \qquad [ Mathematical expression 31 ]$$

Mathematical expression 31 can set the relationship between the total focal length (f_tele) of the optical systems 1300, 1400, and 1500 in the third mode, the telephoto end (tele), and the total focal length (f_wide) of the optical systems 1300, 1400, and 1500 in the first mode, the wide-angle end (wide). f_tele/f_wide can be referred to as the magnification ratio or zoom ratio of the zoom lens optical system. Mathematical expression 31 is a condition for limiting the zoom optical performance.

If the upper limit of Mathematical expression 31 is exceeded, it is difficult to secure optical performance due to chromatic aberration at the telephoto end (tele), and the amount of movement of each lens group increases significantly during zooming, making mechanical miniaturization difficult. If the lower limit of Mathematical expression 31 is less than the lower limit of Mathematical expression 31, it is difficult to secure performance as a zoom optical system. A zoom optical system satisfying Mathematical expression 31 can secure practically useful optical performance. Mathematical expression 31 can preferably satisfy 1.7<f_tele/f_wide<1.9 in the fourth to sixth embodiments.

$$1.5 < \vert f\_G2 / f\_G1 \vert < 0.5 \qquad [ Mathematical expression 32 ]$$

Mathematical expression 32 can set the relationship between the focal length (f_G1) of the first lens group G1 and the focal length (f_G2) of the second lens group G2. Mathematical expression 32 is a condition for reducing aberration and improving optical performance.

The first lens group G1 and the second lens group G2 satisfying mathematical expression 32 can appropriately correct astigmatism and coma aberration. In addition, the zoom optical system has a zoom magnification of 3 to 7 times and can reduce the overall length of the optical system. Mathematical expression 32 can preferably satisfy 0.3<|f_G2/f_G1|<0.5 in the fourth to sixth embodiment.

$$1 < \vert f\_G1 / f\_wide \vert < 1.5 \qquad [ Mathematical expression 33 ]$$

Mathematical expression 33 can set the relationship between the focal length (f_G1) of the first lens group G1 and the overall focal length (f_wide) of the optical systems 1300, 1400, and 1500 in the wide-angle end (wide), which is the first mode. Mathematical expression 33 is a condition for limiting the size of the refractive power of the first lens group G1.

If the upper limit of Mathematical expression 33 is exceeded, the first lens group G1 has a weak refractive power, making it difficult to secure a back focal length and thus obtaining a clear image. If the lower limit of Mathematical expression 33 is less than the lower limit, the first lens group G1 has a strong refractive power, making it difficult to correct field curvature aberration at the wide-angle position, spherical aberration at the telephoto position, and coma aberration. Mathematical expression 33 can preferably satisfy 1.3<|f_G1/f_wide|<1.5 in the fourth to sixth embodiment.

$$0.5 < f\_G2 / f\_wide < 1 \qquad [ Mathematical expression 34 ]$$

In Mathematical expression 34, the relationship between the focal length (f_G2) of the second lens group G2 and the overall focal length (f_wide) of the optical systems 1300, 1400, and 1500 in the first mode, the wide-angle end (wide), can be established. Mathematical expression 34 is a condition for limiting the size of the refractive power of the second lens group G2.

If the upper limit of Mathematical expression 34 is exceeded, the movement amount of the second lens group G2 for zoom operation may be large. If the lower limit of Mathematical expression 34 is less than the lower limit, the second lens group G2 may be difficult to manufacture. Mathematical expression 34 may preferably satisfy 0.5<f_G2/f_wide<0.8 in the fourth to sixth embodiments.

$$2 < \vert f\_G3 / f\_wide \vert < 2.5 \qquad [ Mathematical expression 35 ]$$

In Mathematical expression 35, the relationship between the focal length (f_G3) of the third lens group G3 and the overall focal length (f_wide) of the optical systems 1300, 1400, and 1500 in the first mode, the wide-angle end (wide), can be established. Mathematical expression 35 is a condition for limiting the size of the refractive power of the third lens group G3.

If the upper limit of Mathematical expression 35 is exceeded, the stroke length of the third lens group G3 increases during focusing, making it difficult to miniaturize the zoom lens. If the lower limit of Mathematical expression 35 is less than the lower limit of Mathematical expression 35, the refractive power of the third lens group G3 becomes too strong, and the variation of aberration becomes large when performing image plane correction according to the object distance. Mathematical expression 35 can preferably satisfy 2<|f_G3/f_wide|<2.4 in the fourth to sixth embodiments.

$$0.5 < \vert f\_G1 / f\_tele \vert < 1 \qquad [ Mathematical expression 36 ]$$

Mathematical expression 36 can set the relationship between the focal length (f_G1) of the first lens group G1 and the overall focal length (f_tele) of the optical systems 1300, 1400, and 1500 in the third mode, the telephoto end (tele). Mathematical expression 36 is a condition for limiting the size of the refractive power of the first lens group G1.

If the upper limit of Mathematical expression 36 is exceeded, the first lens group G1 has a weak refractive power, making it difficult to secure a back focal length and thus obtaining a clear image. If the lower limit of Mathematical expression 36 is less than the lower limit of Mathematical expression 36, the first lens group G1 has a strong refractive power, making it difficult to correct field curvature aberration at the wide-angle position, spherical aberration at the telephoto position, and coma aberration. Mathematical expression 36 can preferably satisfy 0.5<|f_G1/f_tele|<0.8 in the fourth to sixth embodiments.

$$0.1 < f\_G2 / f\_tele < 0.5 \qquad [ Mathematical expression 37 ]$$

In Mathematical expression 37, the relationship between the focal length (f_G2) of the second lens group G2 and the overall focal length (f_tele) of the optical systems 1300, 1400, and 1500 in the third mode, the telephoto end (tele), can be established. Mathematical expression 37 is a condition for limiting the size of the refractive power of the second lens group G2.

If the upper limit of Mathematical expression 37 is exceeded, the movement amount of the second lens group G2 for zoom operation may be large. If the lower limit of Mathematical expression 37 is less than the lower limit, the second lens group G2 may be difficult to manufacture. Mathematical expression 37 may preferably satisfy 0.2<f_G2/f_tele<0.4 in the fourth to sixth embodiments.

$$1 < \vert f\_G3 / f\_tele \vert < 1.5 \qquad [ Mathematical expression 38 ]$$

In Mathematical expression 38, the relationship between the focal length (f_G3) of the third lens group G3 and the overall focal length (f_wide) of the optical systems 1300, 1400, and 1500 in the first mode, the wide-angle end (wide), can be established. Mathematical expression 38 is a condition for limiting the size of the refractive power of the third lens group G3.

If the upper limit of Mathematical expression 38 is exceeded, the stroke length of the third lens group G3 increases during focusing, making it difficult to miniaturize the zoom lens. If the lower limit of Mathematical expression 38 is less than the lower limit, the refractive power of the third lens group G3 becomes too strong, and the variation of aberration becomes large when performing image plane correction according to the object distance. Mathematical expression 38 can preferably satisfy 1.1<|f_G3/f_tele|<1.4 in the fourth to sixth embodiments.

$$4 < G2\_stroke < 4.5 \qquad [ Mathematical expression 39 ]$$

Mathematical expression 39 can set the range of the stroke length (G2_stroke) of the second lens group G2. If the upper limit of Mathematical expression 39 is exceeded, the stroke length of the second lens group G2 increases during focusing, making it difficult to miniaturize the zoom lens. If the lower limit of Mathematical expression 39 is less than the lower limit of Mathematical expression 39, the performance of the zoom optical system may deteriorate. Mathematical expression 39 can preferably satisfy 4<G2_stroke<4.3 in the fourth to sixth embodiments.

$$4.5 < G3\_stroke < 5 \qquad [ Mathematical expression 40 ]$$

Mathematical expression 40 can set the range of the stroke length (G3_stroke) of the third lens group G3. If the upper limit of Mathematical expression 40 is exceeded, the stroke length of the third lens group G3 increases during focusing, making it difficult to miniaturize the zoom lens. If the lower limit of Mathematical expression 40 is less than the lower limit of Mathematical expression 40, the performance of the zoom optical system may deteriorate. Mathematical expression 40 can preferably satisfy 4.7<G3_stroke<4.9 in the fourth to sixth embodiments.

$$20 < TTL < 30 \qquad [ Mathematical expression 41 ]$$

In Mathematical expression 41, TTL (Total track length) means the distance (mm) from the center of the first surface S1 of the first lenses 401, 501, and 601 to the upper surface of the image sensor 700 On the optical axis OA. By making TTL exceed 20 or 30 in Mathematical expression 41, an optical system for a vehicle can be provided. In the fourth to sixth embodiments, mathematical expression 41 can preferably satisfy 20<TTL<25.

$$4 < ImgH < 6 \qquad [ Mathematical expression 42 ]$$

Mathematical expression 42 indicates that ImgH represents the maximum diagonal length of the image sensor 700. Mathematical expression 42 can set the diagonal size (ImgH) of the image sensor 700 and provide an optical system having a vehicle sensor size. In the fourth to sixth embodiments, Mathematical expression 42 can preferably satisfy 4.5≤ImgH<5.5.

$$1 < BFL < 3.5 \qquad [ Mathematical expression 43 ]$$

In Mathematical expression 43, BFL is the optical axis distance from the image sensor 700 to the center of the sensor side of the last lens. When Mathematical expression 43 is satisfied, the installation space of the filter 800 and the cover glass 400 can be secured, the assemblability of the components can be improved through the gap between the image sensor 700 and the last lens, and the coupling reliability can be improved. In the fourth to sixth embodiments, Mathematical expression 43 can preferably satisfy 1<BFL<3.2. When BFL is less than the range of Mathematical expression 43, some of the light traveling to the image sensor may not be transmitted to the image sensor, which may cause a decrease in resolution. When BFL exceeds the range of Mathematical expression 43, stray light may be introduced, which may deteriorate the aberration characteristics of the optical system.

$$10 < FOV\_wide < 30 \qquad [ Mathematical expression 44 ]$$

In Mathematical expression 44, the range of the angle of view (FOV_wide) in the first mode, the wide-angle end (wide), can be set. In Mathematical expression 44, an angle of view suitable for a vehicle optical system can be provided. In the fourth to sixth embodiment, the FOV can preferably satisfy 12<FOV_wide<28.

$$5 < FOV\_tele < 20 \qquad [ Mathematical expression 45 ]$$

In mathematical expression 45, the range of the angle of view (FOV_tele) in the third mode, the telephoto end (tele), can be set. In Mathematical expression 44, an angle of view suitable for a vehicle optical system can be provided. In the fourth to sixth embodiment, the FOV can preferably satisfy 6<FOV_tele<17.

$$3 < TTL / CA\_max < 5 \qquad [ Mathematical expression 46 ]$$

In Mathematical expression 46, CA_max means the largest effective diameter (mm) among the object side surface and the sensor side surface of a plurality of lenses, and TTL (Total track length) means the distance (mm) from the vertex of the first surface S1 of the first lenses 401, 501, and 601 to the upper surface of the image sensor 700 on the optical axis OA. Mathematical expression 46 sets the relationship between the total optical axis length of the optical system and the maximum effective diameter, thereby providing an improved vehicle optical system. In the fourth to sixth embodiments, Mathematical expression 46 can preferably satisfy 4<TTL/CA_max<5.

$$3 < TTL / ImgH < 5 \qquad [ Mathematical expression 47 ]$$

Mathematical expression 47 indicates that TTL (Total track length) means the distance (mm) from the vertex of the first surface S1 of the first lens to the upper surface of the image sensor 700 on the optical axis OA, and ImgH means the maximum diagonal length of the image sensor 700. When Mathematical expression 47 is satisfied, the optical systems 1300, 1400, and 1500 can have TTL for application to the vehicle image sensor 700, thereby providing improved image quality. In the fourth to sixth embodiments, Mathematical expression 47 can preferably satisfy 4<TTL/ImgH<5.

$$1.5 < F\_wide / ImgH < 2.5 \qquad [ Mathematical expression 48 ]$$

Mathematical expression 48 is, F_wide is the total effective focal length of the optical systems 1300, 1400, and 1500 in the first mode, the wide-angle end (wide), and ImgH means the maximum diagonal length of the image sensor 700. Such optical systems 1300, 1400, and 1500 can have improved aberration characteristics in the size of the vehicle image sensor 700. In the fourth to sixth embodiments, Mathematical expression 48 can preferably satisfy 2<F_wide/ImgH<2.5.

$$3 < F\_tele / ImgH < 4 \qquad [ Mathematical expression 49 ]$$

Mathematical expression 49 is F_tele, the total effective focal length of the optical systems 1300, 1400, and 1500 in the third mode, the telephoto end (tele), and ImgH means the maximum diagonal length of the image sensor 700. Such optical systems 1300, 1400, and 1500 can have improved aberration characteristics in the size of the vehicle image sensor 700. In the fourth to sixth embodiment, Mathematical expression 49 can preferably satisfy 3.5<F_tele/ImgH<4.

$$0.1 < \sum CT / TTL < 1 \qquad [ Mathematical expression 50 ]$$

Mathematical expression 50 can set the relationship between the sum of the center thicknesses of the lenses (ΣCT) and the distance (TTL) from the vertex of the first surface S1 of the first lens to the upper surface of the image sensor 700 on the optical axis OA. If the upper limit of Mathematical expression 50 is exceeded, the number of lenses increases and the movement of the moving lens group in the zoom optical system may become disadvantageous. If the lower limit of Mathematical expression 50 is lower, the magnification performance of the zoom lens optical system may deteriorate. In the fourth to sixth embodiments, Mathematical expression 50 can preferably satisfy 0.3<ΣCT/TTL<0.5.

$$0.1 < \sum CG / TTL < 0.8 \qquad [ Mathematical expression 51 ]$$

Mathematical expression 51 can set the relationship between the sum of the gaps (ΣCG) between adjacent lenses and the distance (TTL) on the optical axis OA from the vertex of the first surface S1 of the first lens to the upper surface of the image sensor 700. If the upper limit of Mathematical expression 51 is exceeded, the moving distance of the moving lens group in the zoom lens optical system increases, which may increase current consumption during zooming operation. If the lower limit of Mathematical expression 51 is less than the lower limit of Mathematical expression 51, the magnification performance of the zoom lens optical system may deteriorate. In the fourth to sixth embodiments, Mathematical expression 51 can preferably satisfy 0.1<ΣCG/TTL<0.5.

$$1 < \sum CT / \sum CG < 2 \qquad [ Mathematical expression 52 ]$$

Mathematical expression 52 can set the relationship between the sum of the center thicknesses of the lenses (ΣCT) and the sum of the gaps between adjacent lenses (ΣCT). If the upper limit of Mathematical expression 52 is exceeded, the number of lenses increases and the movement of the moving lens group in the zoom optical system may become disadvantageous. If the lower limit of Mathematical expression 52 is less than the lower limit of Mathematical expression 52, the magnification performance of the zoom lens optical system may deteriorate. In the fourth to sixth embodiments, Mathematical expression 52 can preferably satisfy 1<ΣCT/ΣCG<1.8.

$$0.1 < CT 2 / ET 2 < 0.5 \qquad [ Mathematical expression 53 ]$$

Mathematical expression 53 can set the relationship between the center thickness (CT2) of the second lenses 402, 502, and 602 and the edge thickness (ET2) of the second lenses 402, 502, and 602. The second lenses 402, 502, and 602 are the lenses closest to the sensor side in the first lens group G1, and can have a concave shape on both sides, and can play a role in spreading light incident from the object side in the opposite direction of the optical axis.

If the upper limit of Mathematical expression 53 is exceeded, the center thickness of the second lenses 402, 502, and 602 may become thicker, which may deteriorate the light-diffusing performance. If the lower limit of Mathematical expression 53 is less than the lower limit of Mathematical expression 53, the edge of the second lenses 402, 502, and 602 may become excessively large, which may deteriorate the lens manufacturability. In the fourth to sixth embodiment, Mathematical expression 53 may preferably satisfy 0.3<CT2/ET2<0.5.

$$1 < CA\_max / CA\_min < 2 \qquad [ Mathematical expression 54 ]$$

Mathematical expression 54 indicates that CA_max represents the maximum effective diameter among the object side surfaces and the sensor side surfaces of the lenses, and CA_Min represents the minimum effective diameter among the object side surfaces and the sensor side surfaces of the lenses. When Mathematical expression 54 is satisfied, the optical system can set a size for a slim and compact structure while maintaining optical performance. In the fourth to sixth embodiments, Mathematical expression 54 can preferably satisfy 1<CA_max/CA_min<1.5.

$$1 < CA\_max / ImgH < 2 \qquad [ Mathematical expression 55 ]$$

Mathematical expression 55 indicates that CA_max represents the maximum effective diameter among the object side surfaces and the sensor side surfaces of the lenses, and Imgh represents the maximum diagonal length of the image sensor 700. When Mathematical expression 55 is satisfied, the optical system can maintain good optical performance and set a size for a slim and compact structure. In the fourth to sixth embodiments, Mathematical expression 55 can preferably satisfy 1<CA_max/ImgH<1.5.

$$0.1 < CA\_min / ImgH < 1 \qquad [ Mathematical expression 56 ]$$

Mathematical expression 56 is CA_Min, which represents the minimum effective diameter among the object side surfaces and the sensor side surfaces of the lenses, and Imgh represents the maximum diagonal length of the image sensor 700. When Mathematical expression 56 is satisfied, the optical system can maintain good optical performance and set a size for a slim and compact structure. In the fourth to sixth embodiments, Mathematical expression 56 can preferably satisfy 0.5<CA_min/ImgH<1.

$$G1\_LjR1 < 0 , G1\_LjR2 > 0 \\ G2\_LiR1 > 0 , G2\_LiR2 < 0 \qquad [ Mathematical expression 57 ]$$

Mathematical expression 57 can set the relationship between the sign of the radius of curvature of the lens (G1_Lj) closest to the sensor side among the lenses included in the first lens group G1 and the sign of the radius of curvature of the lens (G2_Li) closest to the object side among the lenses included in the second lens group G2. The first lens group G1 corresponds to a fixed group during zooming operation, and the lens in the first lens group G1 closest to the sensor side has a biconcave shape and has negative (−) refractive power, which can serve to spread light. The second lens group G2 corresponds to a moving group during zooming operation, and the lens in the second lens group G2 closest to the object side has a biconvex shape and has positive (+) refractive power, which can serve to gather light. That is, the second lenses 402, 502, and 602 and the third lenses 403, 503, and 603, which are disposed adjacent to each other, sequentially spread and gather light, thereby securing the magnification performance of the zoom optical system.

The optical systems 1300, 1400, and 1500 according to the fourth to sixth embodiments can satisfy at least one or two or more Mathematical expressions from Mathematical expression 31 to Mathematical expression 57. In this case, the optical systems 1300, 1400, and 1500 can have improved optical characteristics. In detail, when the optical systems 1300, 1400, and 1500 satisfies at least one or two or more Mathematical expressions from Mathematical expression 31 to Mathematical expression 57, the optical systems 1300, 1400, and 1500 can have improved resolution and improve aberration and distortion characteristics. In addition, the optical systems 1300, 1400, and 1500 can secure a BFL (Back focal length) for applying the image sensor 700, compensate for the deterioration of optical characteristics due to temperature change, and minimize the gap between the last lens and the image sensor 700, thereby providing good optical performance in the central and peripheral portions of the field of view (FOV).

TABLE 20

| | | Fourth | Fifth | Sixth |
|---|---|---|---|---|
| | | embodi- | embodi- | embodi- |
| Mathematical expression | | ment | ment | ment |
| 31 | 1.5 < f_tele/f_wide < 2 | 1.867 | 1.867 | 1.867 |
| 32 | 0.1 < \|f_G2/f_G1\| < 0.5 | 0.415 | 0.435 | 0.420 |
| 33 | 1 < \|f_G1/f_wide\| < 1.5 | 1.464 | 1.452 | 1.456 |
| 34 | 0.5 < f_G2/f_wide < 1 | 0.608 | 0.632 | 0.612 |
| 35 | 2 < \|f_G3/f_wide\| < 2.5 | 2.254 | 2.163 | 2.271 |
| 36 | 0.5 < \|f_G1/f_tele\| < 1 | 0.784 | 0.778 | 0.780 |
| 37 | 0.1 < f_G2/f_tele < 0.5 | 0.325 | 0.339 | 0.328 |
| 38 | 1 < \|f_G3/f_tele\| < 1.5 | 1.207 | 1.159 | 1.216 |
| 39 | 4 < G2_stroke < 4.5 | 4.045 | 4.116 | 4.130 |
| 40 | 4.5 < G3_stroke < 5 | 4.800 | 4.800 | 4.800 |
| 41 | 20 < TTL < 30 | 24.000 | 24.000 | 24.000 |
| 42 | 4 < ImgH < 6 | 5.040 | 5.040 | 5.040 |
| 43 | 1 < BFL < 3 | 1.100 | 3.045 | 2.975 |
| 44 | 10 < FOV_wide < 30 | 27.5342 | 13.9193 | 13.8427 |
| 45 | 5 < FOV_tele < 20 | 16.1288 | 7.4709 | 7.4693 |
| 46 | 3 < TTL/CA_max < 5 | 4.444 | 4.285 | 4.285 |
| 47 | 3 < TTL/ImgH < 5 | 4.762 | 4.762 | 4.762 |
| 48 | 1.5 < F_wide/ImgH < 2.5 | 2.033 | 2.033 | 2.033 |
| 49 | 3 < F_tele/ImgH < 4 | 3.795 | 3.795 | 3.795 |
| 50 | 0.1 < ΣCT/TTL < 1 | 0.426 | 0.482 | 0.443 |
| 51 | 0.1 < ΣCG/TTL < 0.8 | 0.249 | 0.391 | 0.433 |
| 52 | 1 < ΣCT/ΣCG < 2 | 1.714 | 1.232 | 1.021 |
| 53 | 0.1 < CT2/ET2 < 0.5 | 0.486 | 0.455 | 0.453 |
| 54 | 1 < CA_max/CA_min < 2 | 1.255 | 1.215 | 1.294 |
| 55 | 1 < CA_max/ImgH < 2 | 1.071 | 1.111 | 1.111 |
| 56 | 0.1 < CA_min/ImgH < 1 | 0.854 | 0.915 | 0.859 |
| 57 | G1_LjR1 < 0, G1_LjR2 > | Satisfy | Satisfy | Satisfy |
| | 0G2_LiR1 > 0, | | | |
| | G2_LiR2 < 0 | | | |

Table 20 shows the result values for Mathematical expression 31 to Mathematical expression 57 described above in the optical systems 1300, 1400, and 1500 of the embodiment. Referring to Table 20, it can be seen that the optical systems 1300, 1400, and 1500 satisfies at least one, two or more, or three or more of Mathematical expression 31 to Mathematical expression 57. In detail, it can be seen that the optical systems 1300, 1400, and 1500 according to the embodiment satisfies all of Mathematical expression 31 to Mathematical expression 57. Accordingly, the optical systems 1300, 1400, and 1500 can have good optical performance in the center and peripheral portions of the field of view (FOV) and can have excellent optical characteristics.

Hereinafter, a camera module according to an embodiment of the present invention is described with reference to the drawings.

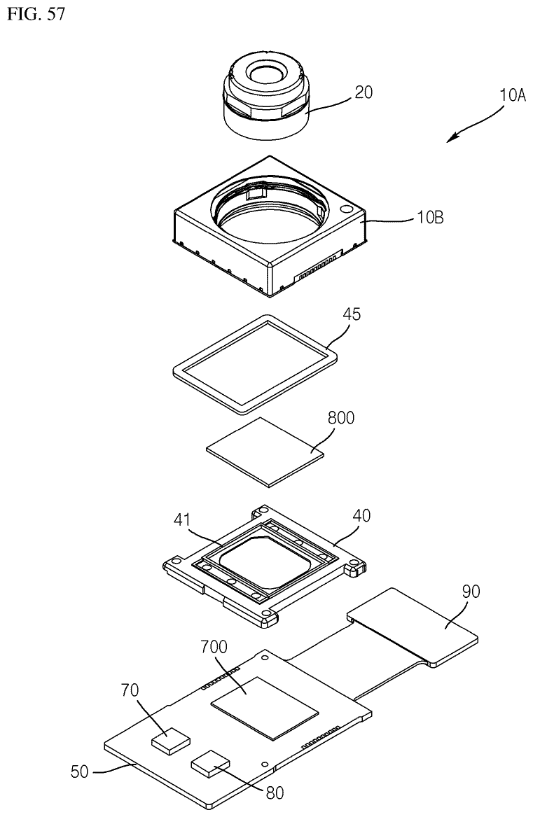

FIG. 57 is an exploded perspective view of a camera device according to an embodiment of the present invention.

The camera device 10A may include a camera module.

The camera device 10A may include a lens module 20. The lens module 20 may include at least one lens. The lens may be positioned corresponding to the image sensor 700. The lens module 20 may include a lens and a barrel. The lens module 20 may be coupled to a bobbin 210 of a lens driving device 10B. The lens module 20 may be coupled to the bobbin 210 by screw coupling and/or adhesive. The lens module 20 may move integrally with the bobbin 210.

The camera device 10A may include a filter 30. The filter 30 may block light of a specific frequency band from passing through the lens module 20 from being incident on the image sensor 700. The filter 30 may be disposed parallel to the x-y plane. The filter 30 may be disposed between the lens module 20 and the image sensor 700. The filter 30 may be disposed in the sensor base 40. In a modified embodiment, the filter 30 may be disposed on the base of the lens driving device 10B. The filter 30 may include an infrared filter. The infrared filter may block light in the infrared region from being incident on the image sensor 700.

The camera device 10A may include a sensor base 40. The sensor base 40 may be disposed between the lens driving device 10B and the printed circuit board 50. The sensor base 40 may include a protruded portion 41 on which a filter 30 is disposed. An opening may be formed in a portion of the sensor base 40 on which the filter 30 is disposed so that light passing through the filter 30 may be incident on the image sensor 700. The adhesive member 45 may couple or attach the base 410 of the lens driving device 10B to the sensor base 40. The adhesive member 45 may additionally serve to prevent foreign substances from entering the interior of the lens driving device 10B. The adhesive member 45 may include at least one among an epoxy, a thermosetting adhesive, and an ultraviolet-curable adhesive.

The camera device 10A may include a printed circuit board (PCB) 50. The printed circuit board 50 may be a substrate or a circuit board. A lens driving device 10B may be disposed in the printed circuit board 50. A sensor base 40 may be disposed between the printed circuit board 50 and the lens driving device 10B. The printed circuit board 50 may be electrically connected to the lens driving device 10B. An image sensor 700 may be disposed on the printed circuit board 50. Various circuits, components, control units, and the like may be provided in the printed circuit board 50 to convert an image being formed on the image sensor 700 into an electrical signal and transmit it to an external device.

The camera device 10A may include an image sensor 700. The image sensor 700 may be configured to form an image by receiving light that has passed through a lens and a filter 30. The image sensor 700 may be mounted on a printed circuit board 50. The image sensor 700 may be electrically connected to the printed circuit board 50. For example, the image sensor 700 may be coupled to the printed circuit board 50 using surface mounting technology (SMT). As another example, the image sensor 700 may be coupled to the printed circuit board 50 using flip chip technologies. The image sensor 700 may be disposed such that its optical axis is aligned with that of the lens. That is, the optical axis of the image sensor 700 and the optical axis of the lens may be aligned. The image sensor 700 can convert light irradiated onto the effective image area of the image sensor 700 into an electrical signal. The image sensor 700 can be any one among a CCD (charge coupled device), a MOS (metal oxide semi-conductor), a CPD, and a CID.

The camera device 10A may include a motion sensor 70. The motion sensor 70 may be mounted on a printed circuit board 50. The motion sensor 70 may be electrically connected to a control unit 80 through a circuit pattern provided on the printed circuit board 50. The motion sensor 70 may output rotational angular velocity information due to the movement of the camera device 10A. The motion sensor 70 may include a two-axis or three-axis gyro sensor or an angular velocity sensor.

The camera device 10A may include a control unit 80. The control unit 80 may be disposed on a printed circuit board 50. The control unit 80 may be electrically connected to the AF coil and the OIS coil of the lens driving device 10B. The control unit 80 may individually control the direction, intensity, amplitude, and the like of the current supplied to the AF coil and the OIS coil. The control unit 80 may control the lens driving device 10B to perform an autofocus function and/or an image stabilization function. Furthermore, the control unit 80 may perform autofocus feedback control and/or image stabilization feedback control for the lens driving device 10B.

The camera device 10A may include a connector 90. The connector 90 may be electrically connected to a printed circuit board 50. The connector 90 may include a port for electrically connecting to an external device.

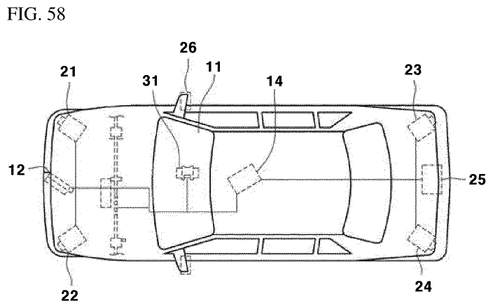

FIG. 58 is an example of a plan view of a vehicle to which a camera module or optical system according to an embodiment of the invention is applied. Referring to FIG. 58, a vehicle camera system according to an embodiment of the invention includes an image generation unit 11, a first information generation unit 12, a second information generation units 21, 22, 23, 24, 25, and 26, and a control unit 14. The image generation unit 11 may include at least one camera module 31 being disposed in the vehicle, and may capture images of the front of the vehicle and/or the driver to generate a front image or an interior image of the vehicle. The image generation unit 11 may capture images of the surroundings of the vehicle in one or more directions as well as the front of the vehicle using the camera module 31, to generate an image of the surroundings of the vehicle. Here, the front image and the surrounding images may be digital images, and may include color images, black and white images, infrared images, and the like. In addition, the front image and the surrounding images may include still images and moving images. The image generation unit 11 provides the driver image, the front image, and the surrounding image to the control unit 14. Next, the first information generation unit 12 may include at least one of radar and/or camera being disposed in the vehicle, and detects the front of the vehicle to generate first detection information. Specifically, the first information generation unit 12 is disposed in the vehicle, and detects the position and speed of vehicles located in front of the vehicle, the presence and position of pedestrians, and the like to generate first detection information.

By using the first detection information generated by the first information generation unit 12, the distance between the own vehicle and the vehicle in front can be controlled to be maintained at a constant level, and the stability of vehicle operation can be improved in specific preset cases, such as when the driver wants to change the driving lane of the own vehicle or when backing up. The first information generation unit 12 provides the first detection information to the control unit 14. The second information generation units 21, 22, 23, 24, 25, and 26 detects each side of the own vehicle based on the front image generated by the image generation unit 11 and the first detection information generated by the first information generation unit 12, and generates second detection information. Specifically, the second information generation units 21, 22, 23, 24, 25, and 26 may include at least one radar and/or camera being disposed in the own vehicle, and may detect the position and speed of vehicles located on the side of the own vehicle or capture images. Here, the second information generation units 21, 22, 23, 24, 25, and 26 can be disposed at the front two corners, side mirrors, and rear center and rear two corners of the vehicle, respectively.

At least one information generating unit of these vehicle camera systems may be equipped with an optical system and a camera module having the same as described in the embodiment disclosed above, and may provide or process information acquired through the front, rear, each side or corner area of the vehicle to a user to enable autonomous driving or to protect the vehicle and objects from surrounding safety.

The optical system of the camera module according to the embodiment of the invention can be installed in multiple units within a vehicle to enhance safety regulations, autonomous driving functions, and convenience. Furthermore, the optical system of the camera module is used inside the vehicle as a component for controlling systems such as the Lane Keeping Assistance System (LKAS), Lane Departure Warning System (LDWS), and Driver Monitoring System (DMS). These vehicle camera modules can achieve stable optical performance even under ambient temperature changes and offer competitive pricing, thereby ensuring the reliability of vehicle components.

The features, structures, effects, and the like described in the embodiments above are included in at least one embodiment and are not necessarily limited to only one embodiment. Furthermore, the features, structures, effects, and the like illustrated in each embodiment can be combined or modified and implemented in other embodiments by a person with ordinary knowledge in the field to which the embodiments belong. Therefore, contents related to such combinations and modifications should be interpreted as being included in the scope of the embodiments.

In addition, although the above has been described with reference to embodiments, these are merely examples and do not limit the present invention, and those with ordinary skill in the art to which the present invention pertains will recognize that various modifications and applications not exemplified above are possible without departing from the essential characteristics of the present invention. For example, each component specifically shown in the examples can be modified and implemented. And, the differences related to such modifications and applications should be interpreted as being included in the scope of the present invention defined in the appended claims.

1. An optical system comprising:
a first to third lens groups being disposed along an optical axis,
wherein the first lens group has negative (−) refractive power,
wherein the second lens group has positive (+) refractive power,
wherein the third lens group has negative (−) refractive power,
wherein an aperture is disposed between the first lens group and the second lens group, and
wherein at least one of the two lenses being disposed closest to the aperture is made of glass, and
wherein one of the two lenses being disposed closest to the aperture has the largest Abbe number.

2-10. (canceled)

11. The optical system according to claim 1,
wherein the signs of the refractive powers of the two lenses being disposed closest to the aperture are different.

12. The optical system according to claim 1,
wherein the absolute value of the difference in Abbe numbers of the two lenses being disposed closest to the aperture is 25 or more and 35 or less.

13. The optical system according to claim 1,
wherein the first lens group comprises first to third lenses,
wherein the second lens group comprises a fourth lens having positive (+) refractive power and a fifth lens having negative (−) refractive power, and
wherein the third lens group comprises a sixth lens having positive (+) refractive power and a seventh lens having negative (−) refractive power.

14. The optical system according to claim 1,
wherein the first lens group is a fixed group, and
wherein the second lens group and the third lens group are moving groups.

15. The optical system according to claim 1, satisfying:
$$a conditional expression \\ 15 < TTL < 20 ,$$
wherein TTL is the distance along the optical axis from the vertex of the object-side surface of the lens being disposed closest to the object side, to an upper surface of an image sensor.

16. The optical system according to claim 1, satisfying:
$$a conditional expression \\ 0.5 < f\_tele / f\_wide < 1 ,$$
wherein f_tele is the total focal length of the optical system at the end of telephoto, and f_wide is the total focal length of the optical system at the end of wide-angle.

17. The optical system according to claim 1,
wherein BFL_wide is the distance along the optical axis from the end of a light source to the center of the sensor side surface of the last lens at the image sensor.

18. The optical system according to claim 1, satisfying:
$$a conditional expression \\ 3 < TTL / ImgH < 5 ,$$
wherein TTL is the distance along the optical axis from the vertex of the object-side surface of the lens being disposed closest to the object side to the upper surface of the image sensor, and ImgH is the maximum diagonal length of the image sensor.

19. An optical system comprising:
a first to seventh lenses being disposed along an optical axis,
wherein the second lens has positive (+) refractive power,
wherein the third lens has negative (−) refractive power,
wherein the fourth lens has positive (+) refractive power,
wherein the fifth lens has negative (−) refractive power,
wherein the sixth lens has positive (+) refractive power, and the seventh lens has negative (−) refractive power,
wherein the first to third lenses are a first lens group having negative (−) refractive power,
wherein the fourth and fifth lenses are a second lens group having positive (+) refractive power,
wherein the sixth and seventh lenses are a third lens group having negative (−) refractive power,
wherein an aperture is disposed between the first lens group and the second lens group, and
wherein at least one of the two lenses being disposed closest to the aperture is made of glass.

20. The optical system according to claim 19,
wherein the first lens group is a fixed group, and the second lens group and the third lens group is moving groups.

21. The optical system according to claim 19,
wherein one of the two lenses being disposed closest to the aperture has the largest Abbe number.

22. The optical system according to claim 19,
wherein the signs of the refractive powers of the two lenses being disposed closest to the aperture above is different.

23. The optical system according to claim 19, satisfying:
$$a conditional expression \\ 3 < TTL / ImgH < 5 ,$$
wherein TTL is the optical axis distance from the vertex of the object-side surface of the lens being disposed closest to the object side to the upper surface of the image sensor, and ImgH is the maximum diagonal length of the image sensor.

24. An optical system comprising:
a first to third lens groups being disposed along an optical axis,
wherein the first lens group has negative (−) refractive power,
wherein the second lens group has positive (+) refractive power,
wherein the third lens group has negative (−) refractive power,
wherein in the first lens group, the lens being disposed closest to the sensor side has a concave shape on both sides, and
wherein in the second lens group, the lens being disposed closest to the object side has a convex shape on both sides.

25. The optical system according to claim 24,
wherein the first lens group is a fixed group, and the second lens group and the third lens group is moving groups.

26. The optical system according to claim 24,
wherein when zooming from the wide-angle end to the telephoto end, the distance between the first lens group and the second lens group on the optical axis decreases, and the distance between the second lens group and the third lens group on the optical axis is decreased.

27. The optical system according to claim 24,
wherein at the wide-angle end, the distance between the first lens group and the second lens group on the optical axis is greater than the distance between the second lens group and the third lens group, and
wherein at the telephoto end, the distance between the first lens group and the second lens group on the optical axis is smaller than the distance between the second lens group and the third lens group.

28. The optical system according to claim 24,
wherein the first lens group comprises a first lens having positive (+) refractive power and a second lens having negative (−) refractive power,
wherein the second lens group comprises a third lens having positive (+) refractive power and a fourth lens having negative (−) refractive power, and
wherein the third lens group comprises a sixth lens having negative (−) refractive power and a second lens having negative (−) refractive power.

29. The optical system according to claim 24,
wherein among the distances between adjacent lenses of the first to sixth lenses on the optical axis, the distance between the first lens and the second lens is the largest.
